(19) United States
(12) Patent Application Publication
(10) Pub. No.: US 2011/0218864 A1
(43) Pub. Date: Sep. 8, 2011

(54) System and methods for searching based on a response to a plurality of both stimuli source types, and initiating stimuli types, without the need for a keyboard

(76) Inventors: Mary Ellen Pentz, Destin, FL (US); Jack Robert Pentz, Destin, FL (US); Teresa Skipper, Dothan, AL (US)

(21) Appl. No.: 12/386,645

(22) Filed: Apr. 21, 2009

Related U.S. Application Data
(63) Continuation-in-part of application No. 11/460,604, filed on Jul. 27, 2006, now abandoned.
(60) Provisional application No. 61/125,196, filed on Apr. 23, 2008.
(60) Provisional application No. 60/702,818, filed on Jul. 28, 2005.
(60) Provisional application No. 61/125,196, filed on Apr. 23, 2008.

(51) Int. Cl. G06Q 30/00; G06F 17/30

(52) U.S. Cl. 705/14.71; 705/14.4; 707/758; 707/E17.014

(57) ABSTRACT

A stimuli which is responsible for the initiation of a user request is utilized to identify and provide search results without the need for the user to enter a keyword or phrase. The initiating stimuli may be multidimensional: therefore, a stimulus which is not traditionally utilized as advertising or product placement can be commercialized.

### CROSS REFERENCE TO RELATED APPLICATIONS

This is a continuation of provisional patent application Ser. No. 61/125,196 filed Apr. 23, 2008 entitled METHOD AND SYSTEM FOR SEARCHING BASED ON A RESPONSE TO MULTIDEMENSIONAL STIMULI, WITHOUT THE NEED FOR A KEYWORD: a continuation-in-part of patent application Ser. No. 11/460,604 filed Jul. 27, 2006 entitled SYSTEM AND METHOD FOR THE SELECTION AND PURCHASE OF BROADCAST AUDIO AND VIDEO TRANSMISSIONS; which was a continuation of provisional patent application Ser. No. 60/702,818 filed Jul. 28, 2005 entitled SYSTEM AND METHOD FOR THE SELECTION AND PURCHASE OF BROADCAST AUDIO AND VIDEO TRANSMISSIONS; the contents of which are incorporate hereinto by reference.

### BACKGROUND OF INVENTION

This invention relates generally to search words and phrases commonly called keywords utilized in connection with database and internet searches; and more particularly, to searching methods and systems generally referred to as search engines used in connection with data location, data retrieval, and search advertising.

### DESCRIPTION OF RELATED ART

Search keywords and phrases are traditionally input manually by the user into a search engine in an attempt to locate and retrieve information or data; however, the accuracy and relevancy of the search results has been very poor overall. There have been many attempts to improve the accuracy and relevancy of Search Systems which have been met with only limited success.

There have been attempts to increase accuracy by using 2 keywords such as a “restaurant” and a “GPS location” in search systems which utilize GPS location as search component. These systems first store the location coordinates of the attractions such as restaurants and shops, then; allows the user to search and retrieve information related to the users present location and interest. These systems, however, require the point of interest location to be fixed excluding searches for mobile points of interest, while still requiring manual input of a keyword and limiting the search to a fixed database of results. There are also system will send e-mail information to a user based on their GPS location; however, this information is considered much the same as “spam” e-mail as it is not usually in response to a request by the user.

There is known in the ART systems which utilize RFID (Radio Frequency Identification) chips to search and retrieve data on mobile items of interest such as inventory control systems used for pharmaceuticals and to identify vehicles as they pass readers in express lanes. These require both an RFID tag and a reader. This need for a specialized reader device is not much of an improvement over the traditional bar codes and scanner systems used at retail store checkout counters and by companies like Federal Express in tracking overnight packages. The applications are limited by the need of a specialized device to read the tags as well as the high cost of the active RFID tags. The range of the passive RFID can also be prohibitive.

Products and services are routinely advertized through various methods including commercials inserted into broadcast, product placement embedded in video content, pop-up ads on websites, internet search advertising, as well as pre-roll and post-roll advertisements on recorded media such as DVD's and video downloads. However, the ability to effectively search and return relevant results is limited.

Video and audio content is expanding rapidly due to the expansion of devices on which the content can be played, however, companies are still seeking a way to capitalize on the phenomenon. Current advertizing methods are found to be annoying by many consumers who are being drawn toward video recorders like Tivo and DVR's (digital video recorders) so they can skip past the advertisements. Likewise, pre-roll post-roll, pop-up and banner ads are also found to be annoying to consumers.

The most popular search methods are search advertising such as Google and Yahoo, which are highly utilized, yet provide a very high number of irrelevant results. These traditional search engines receive a request in the form of a keyword or phrase and then identify and return results to the user. The request is often initiated by user exposure to a stimuli, followed by the user attempting to translate this stimuli into a keyword or phrase which the search engine then attempts to identify. Often times, the user has difficulty expressing or describing the request properly, and the search engines have difficulty interpreting the user request accurately enough to consistently return specific, accurate results.

There is known in the art technology which allows users to “click” on a website object to receive more information or to be transferred to another website via hyperlink; however, these are limited to internet content such as websites and video tours which are static and require programming of each object separately.

There are also systems known in the Art that attempt to facilitate the search and identification of contents such as broadcast music without the use of a keyword as described in U.S. patent Ser. No. 06/001,0120. Still other methods attempt to facilitate the purchase of products advertised via broadcast as disclosed in U.S. patent Ser. No. 02/014,3645 and U.S. patent Ser. No. 06/002,6640 where additional information is provided with the broadcast to support an advertisement or a piece of individual content. However, these systems have met with only limited success as they are one dimensional in that the search and purchase is limited to the exact content broadcast or the commodity advertised. They do not isolate, identify, and utilize, the initiating stimuli responsible for a request in an attempt to provide accurate and relevant search results. Current systems do not address the difficult issues of stimuli registration, result registration, and stimuli/result linking, which needs to be accomplished on a large scale for an effective search system. Furthermore, current systems do not take into account the fact that the initiating stimuli is multi-dimensional. The initiating stimuli is often only a single component of a larger broadcast, a component of a non-broadcast stimuli source; or perhaps, the initiating stimuli is a free association response to an initiating stimuli.

Various methods and systems related to search, selection, and retrieval of data are known in the Art and discussed above. However, a method and system to facilitate an accurate search by first identifying the stimuli responsible for the search request, thus greatly increasing the accuracy of the request interpretation, is not known in the Art. Likewise, such a method and system which accomplishes such an objective while delivering effective search originating from a plurality stimuli source types is not available or known in the Art. Furthermore, a method and system which allows search and selection based on direct, free association and automated responses resulting from a plurality of complex initiating stimuli, is not available or known in the Art. Also, as discussed above, the many attempts to improve search accuracy and relevance have met with only limited success.

### OBJECTS AND SUMMARY OF THE INVENTION

Therefore, an object of the present invention is to provide a selection method and system, a search method and system, a stimuli coordinate assignment method and system, a request coordinate identification method and system, a distribution method and system, a marketing method and system, and an advertising method and system, that allows the user to search based on a response to a plurality of stimuli sources types, stimuli sources, and initiating stimuli, without the need to know an accurate keyword and without the need for specialized advertising. Another object of the present invention is a searching system and method which is based on identifying the stimuli which initiated the user request to provide a more relevant result.

These and other objects are achieved by means of a searching system that provides accurate and relevant search results without the use of a keyword or phrase by identifying the stimuli which caused the initiation of a search request, hereafter referred to as the initiating stimuli. The searching system having; a result registration method, a stimuli source registration method, an initiating stimuli registration method, a stimuli coordinated assignment method, a stimuli/result linking method, a distribution method, a advertiser invitation method, terminal unit, a search method, a request coordinate identification method, a search refinement method, a selection method, and a display-method for displaying the search results returned by the searching unit.

According to the present invention, there is provided a result registration method for the registration and storage of search result comprising the steps: (1) Advertiser registers including such information as advertiser name, e-mail address, billing information, and the like 2) advertiser enters information representing products such as product name, product type, product gender, and the like. 3) advertiser enters information representing product bid which is the amount an advertiser is willing to pay for a particular product exposure; 4) advertiser enters information representing results such as a website link, price, retail locations, and the like, and 5) information representing advertisers' products and services are stored correlatively with the advertisers unique I.D., bid information, and request results thereof; this storage means is hereafter referred to as the Request Result Warehouses; which is one source of search results when a request is initiated. Search results may include, but not be limited to: uniform resource locator (URL) address links, and web sites; specific results such as advertisements, product specifications, product descriptions, and alternative products; audio and video digital files; dating profiles, social networking, and business information, about people; purchase options, and purchase orders for products; search strings utilized for traditional searches, and additional search results utilizing existing search engines such as Google or Yahoo; selection menus, selection filters, and digital images, utilized for selection refining; and the like.

In order to obtain the above object according to the present invention, there is provided a stimuli source registration method consisting of the steps: 1) information representing a plurality of stimuli sources are stored correlatively with at least a unique identifier (referred to hereafter as a stimuli source I.D.; 2) information representing stimuli source coordinates are assigned by proper means (stimuli coordinate assignment method discussed later), 3) stimuli source coordinates are stored correlatively with the stimuli source warehouse, and can store information representing a plurality of stimuli source types including; recorded medium, broadcast medium, live medium, streaming medium, printed medium, internet medium, and location specific medium, mobile medium, and image specific medium.

Further, according to the present invention, there is provided a initiating stimuli registration method for the registration and storage of initiating stimuli consisting of the steps; (1) query stimuli source warehouse for available stimuli sources; (2) input information representing initiating stimuli by proper means (3) identify and assign initiating stimuli coordinates to the corresponding initiating stimuli using proper means (stimuli coordinate assignment method discussed later), (4) store information representing initiating stimuli correlatively with information representing the initiating stimuli coordinates thereof; hereafter referred to as the initiating stimuli warehouse. The initiating stimuli may originate from a plurality of stimuli source types including, but not limited to; recorded medium, broadcast medium, live medium, streaming medium, printed medium, internet medium, and location specific medium, mobile medium, and image specific medium and the like. Initiating stimuli may include, but not be limited to; television movies, websites, streaming video, downloaded video, DVD movie, YouTube video, digital photographs Face Book Pages, MySpace, Flickr, live music concerts, ring tones, satellite radio music, talk shows, artwork, live people, billboards, store window displays, newspaper articles, real estate, and the like.

Further, according to the present invention, there is provided a embedded initiating stimuli registration method for the registration and storage of embedded initiating stimuli consisting of the steps: (1) query initiating stimuli warehouse for available initiating stimuli; (2) inputting of information representing embedded initiating stimuli by proper means (3) identify and assign initiating stimuli coordinates to the embedded initiating stimuli using proper means (stimuli coordinate assignment method discussed later). (4) store information representing embedded initiating stimuli correlatively with information representing the embedded initiating stimuli coordinates and the corresponding initiating stimuli thereof; the aforementioned storage means hereafter referred to as the initiating stimuli warehouse. Embedded initiating stimuli may include for example; individual items inside a store window display, the dress worn by a News Anchor, the shoes worn by an actor in a movie, and a song played in the background of a recorded movie.

The initiating stimuli may include; static, embedded, split, and stacked stimuli types. The registration of static and embedded stimuli is discussed above, while the registration of split and stacked stimuli is accomplished by using the embedded initiating stimuli registration method in conjunction with database relationships; thus storing split and stacked stimuli correlatively with the corresponding initiating stimuli, stimuli source, and stimuli coordinates thereof.

In yet another aspect of the invention, is to provide a stimuli coordinate assignment method and system for use in the stimuli source registration method, and the initiating registration methods, as described above comprising; 1) a record medium is provided for recording a control program, which assist in performing the steps of; 2) identify the stimuli source type by proper means, (3) identify stimuli source coordinates by proper means. (4) storing stimuli source coordinates correlatively with stimuli source thereof, (5) identify initiating stimuli type by proper means, (6) identifying initiating stimuli type coordinates by proper means, 7) storing initiating stimuli correlatively with the stimuli coordinates thereof. Stimuli coordinates are identifying properties of the stimuli sources and initiating stimuli utilized as search conditions. The stimuli source coordinates may including, but not be limited to; perception area, perception time, relative location, location, channel, call letter information, streaming copy of record stimuli, digital image, digital copy, content I.D., stimuli source I.D., stimuli name, and the like. The initiating stimuli coordinates may include, but not be limited to; content name, content I.D., frame I.D., pixel location, pixel relative location, digital address, digital copy, digital marker, URL, run time, video scene, video object, action location, user location, digital counter, relative position, image pixel configuration, audio fingerprint, image recognition, perception time, change time, marker content I.D., perception radii, digital image, initiating stimuli I.D., content name, location, digital photograph perception time, digital marker, user delineated area, and the like. Which stimuli coordinates, or combination of coordinates, are actually utilized depends upon the particular initiating stimuli source type, the stimuli source, the initiating stimuli, the user device capabilities, and the search method utilized to identify the initiating stimuli. Stimuli source coordinates may originate from a plurality of sources including but not limited to; website links, live date feeds, wireless device transmitting by short range technology, optical scanner RFID chip, manual input, calculation, downloads, automated perception area upload method, automatic control program, integrated reader/decoder (IRD) that is a digital broadcast receiver, and the like. Initiating stimuli coordinate any originate from a plurality of sources including, but not limited to; website links, live data feeds, data links, manual inputs, calculation, downloads, automatic control program, perception area upload method, digital reader/decoder, and optical scanner, RFID chip, a wireless device transmitting an ID by short range communication technology, and the like.

Another aspect of the current invention is a stimuli/result linking method comprising the steps: 1) facilitator/content producer accesses the data server by proper means; 2) facilitator/content producer searches the initiating stimuli warehouse for appropriate initiating stimuli; 3) facilitator/content producer searches results warehouse for appropriate product; and 4) facilitator/content producer links information representing the initiating stimuli with information representing selected product by proper means. 5) Information representing the initiating stimuli is store correlatively with information representing the selected product in a way that allows the product, and corresponding results, to be identified.

Another aspect of the current invention is an advertiser invitation method and activation method, allowing unregistered products and services to be linked with initiating stimuli, and the advertiser to be notified for approval of the link for registration and link activation. The advertiser invitation method comprises the steps; 1) information representing unregistered advertisers is stored correlatively with the products and services thereof hereafter refer to as unregister product warehouse, (2) Facilitator/content producer searches initiating stimuli warehouse to identify appropriate stimuli; 3) facilitator/content producer search unregistered product warehouse to identify or add unregistered products, services, and advertisers; 4) initiating stimuli and product are linked using proper means; 5) information representing the selected initiating stimuli is stored correlatively with the information representing the unregistered product and the facilitator/content producer I.D. The advertiser registration method comprises the steps; 1) unregistered advertiser is notified via proper communication means that their product is linked, 2) advertiser approves the link and registers; 3) initiating stimuli/product link is activated; becoming available for a user to search.

In order to obtain the above objects according to the present invention, there is provided a terminal unit consisting of at least a recording medium for storing a control program, a display component for displaying the results identified by the searching method (discussed later), a CPU, a bi-direction communication means, and an inputting means. This terminal unit is hereafter referred to as a user device. The user device may include, but is not limited to devices such as; a cell phone, a computer, a remote control device, a PDA (personal digital assistant), a MP3 player, a TV top boxes an internet tv, and I-TV, a television, a stereo system, a DVR, a specialized device, and the like. In order to maximize the effectiveness of the present invention, it is preferred that a combination device be utilized as the user device (as later described).

Still further, according to the present invention there is provided a search method in which initiating stimuli and stimuli sources are identified comprising the steps of 1) a plurality of stimuli sources and initiating stimuli are stored correlatively with the stimuli coordinate thereof, 2) a request is initiated by a response to a stimuli, 3) the request coordinates are identified by proper means (request coordinate identification is discussed later), 4) the request coordinates are transmitted to the data server by proper means, 5) the request coordinates are utilized as search conditions to search the data server; the data server correlatively storing information representing the initiating stimuli, stimuli sources and the stimuli coordinates thereof, 6) information is output representing the initiating stimuli or stimuli source; thus identifying the initiating stimuli or stimuli source which initiated the user response. The search method may also utilize; a perception area method, perception time method, relative position method, a pixel location method, and a stimuli comparison method, to assist in identifying the initiating stimuli and stimuli source.

Further, according to the present invention there is provided a perception area search component which utilizes the search method above comprising the steps; 1) stimuli is stored correlatively with the perception area (PA) thereof, 2) user request contains at least user location, 3) user location is transmitted to the data server by proper means, 4) user location is utilized as a search condition to identify the corresponding perception area stored at 1); and thus identifying the initiating stimuli or stimuli source.

Further, according to the present invention there is provided a perception time search component which utilizes the search method above comprising the steps; 1) stimuli is stored correlatively with the perception time (PT) thereof, 2) user request contains at least the adjusted time of selection (ATOS), 3) ATOS is utilized as a search condition to identify the corresponding (PT) stored at 1); and thus identifying the corresponding initiating stimuli or stimuli source.

Further, according to the present invention there is provided a relative position search component which utilizes the search method above comprising the steps; 1) stimuli is stored correlatively with the real time current location thereof, 2) user request contains at least a users real time current perception area, 3) the user current perception area is utilized as a search condition to identify the corresponding stimuli location stored at 1); and thus identifying the corresponding initiating stimuli or stimuli source. The user real time current perception area is a user defined distance that encircles a mobile user and is often used to trigger a pre-determined automated request. Both stimuli location and user location are updated in such a manner as to keep them current; alternatively the stimuli location may be stationary.

Further, according to the present invention there is provided a pixel location search component which utilizes the search method above comprising the steps; 1) stimuli is stored correlatively with the pixel location or configuration thereof, 2) user request contains at least a single pixel location, 3) pixel location is utilized as a search condition to identify the corresponding pixel location stored at 1); thus identifying the corresponding initiating stimuli or stimuli source.

Still further, there is provided an alternative search method that is utilized to identify stimuli sources and initiating stimuli comprising; 1) provide a record medium for recording a control program that causes the initiating stimuli or stimuli source to be identified comprising the steps; 2) store a digital copy of the initiating stimuli or stimuli source correlatively with information representing at least an unique identification corresponding to the initiating stimuli or stimuli source thereof; 3) user request includes at least a digital copy of initiating stimuli, 4) user request is transmitted to data server by proper means 5) recognition software utilizes digital copy as a search condition to identify the corresponding digital copy stored at 1); thus identifying the corresponding initiating stimuli or stimuli source. The digital copy may be an exact replica of the initiating stimuli or a partial replica, and may be an audio file, a video file, or both combined. The recognition software may utilize image recognition, audio (voice recognition), pixel configuration recognition, and the like.

Still further, according to the present invention, there is provided an information distribution methods comprising the steps; 1) utilize the identified initiating stimuli as a search condition to search the data server; the data server storing a plurality of initiating stimuli correlatively with search results thereof; 2) information representing search results is output; 3) transmit information representing search results to the user device, or other location designation by the user, by proper means.

In yet another aspect of the invention, is to provide a request coordinate identification method and system for use by the searching system or method as described above comprising a record medium for recording a control program that causes the user device to identify and store request coordinates comprising the steps; 1) identifying the stimuli source type by proper means, 2) identify initiating stimuli type by proper means, 3) identify request type by proper means, 4) identify user device capabilities by proper means, 5) obtain relevant request coordinates by proper means 6) store request coordinates correlatively with additional request information thereof. Request coordinates are search conditions generated by the user and user device which are utilized as search conditions to identify the corresponding stimuli source and initiating stimuli coordinates, stored correlatively with the corresponding information representing the unique identification of the stimuli source and initiating stimuli thereof. Request coordinates my include, user location, ATOS, pixel location, stimuli location, relative position, content name, frame I.D. digital image, run time, URL, digital address, and the like. These request coordinates may originate from a plurality of source including the user device features such as a clock function, GPS Feature, an IRD, a digital recorder, and the like. The request coordinates may also originate from manual input, menu selection, data links, calculation, transmission from a wireless device, and the like.

For example; the request coordinate identification method determines that the stimuli source type is “location specific”; such as, a store window display, a billboard, user defined area, or alternatively a mixed stimuli type, such as a movie theater, or a live concert. The control program would identify the user GPS location from the user device and store for inclusion in the user request. The user location is then utilized by the perception area method (as discussed above) as a search condition to search the data server for a corresponding perception area; information representing a corresponding perception area is stored correlatively with information representing a corresponding perception area is stored correlatively with information representing a particular billboard; and thus the billboard is identified as the initiating stimuli. Alternatively, if the system determined the stimuli source type is “broadcast,: then the ATOS (adjusted time of selection) is identified by proper means, and stored for inclusion in the user request. The ATOS is then utilized by the perception time method (as discussed above) as a search condition to search the data server and identify a corresponding perception time; a perception time stored correlatively with a movie scene; thus identifying the movie scene as the initiating stimuli. Perception time is the time in which a user my perceive a particular stimuli. Perception time is the time in which a user my perceive a particular initiating stimuli such as a broadcast scene from a movie. A plurality of request coordinates can be identified by proper means as discussed above and utilized alone and in concert as search conditions to identify both stimuli sources and initiating stimuli.

As yet another aspect of the invention, is a selection system and method which utilizes the request coordinate identification method; allowing request based on a response to stimuli comprising the steps; 1) selection icons provided to user by proper means, 2) user selects proper stimuli type, 3) user initiates a request 4) proper request coordinates are included in the user request by automated control program. A response may include, but is not limited to; a) a direct response as a desire to purchase viewed content or a commodity directly advertised in a televised commercial or live performance; b) embedded response as a desire to purchase an item of clothing or jewelry worn by an actor or actress in a movie or other broadcasted program; or to acquire more information on an automobile or other product appearing in the background of a movie or other broadcasted program and c) free association response as a desire, for example, to acquire information about Colorado homes for sale, or travel information about skiing, after viewing a movie, or other broadcast such as a beer advertisement with mountains seen in the background, and d) an automated response such as a request for; dating information, business information, or a MySpace page, when a person enters a user defined perception area (relative position method discussed above) and a response is initiated automatically based on pre-designated search parameters.

The user request may be initiated by a plurality of means including, but not limited to, a mouse click, a menu selection, a touch screen, a button operation, a curser location, image selection, area delineation, predetermined parameters for an automatic search initiated by a control program, and the like. The user request may be in response to a plurality of initiating stimuli types including; static, embedded, split and stacked. Request results may include for example; products, product information, retail locations, services, services information, advertising, price information, location information, related product information, purchase orders, purchase options, and additional request to refine the search or search parameters. These specific request may relate to a plurality of items such as clothing, automobiles, jewelry, travel information, travel services, product location, people, social networking, price information, commercial advertisements, digital content, real estate information, manufacturing information, event souvenirs, information regarding related products and service, and the like. A user may also request all registered stimuli within said user designated perception area.

In yet another aspect, a selection refinement method is provided to produce increasingly accurate search results comprising; 1) providing a digital image in response to a request, for example a movie scene; 2) selecting more specific stimuli coordinates by proper means; 3) transmitting the additional request coordinates to the data server by proper communication means. This method allow the user to select more specific stimuli such as a ring worn by an actress in a movie scene or a Ford F-150 driven in the same scene.

Additionally, a selection expansion method is provided in which a series of ever more general menus are provided to refine the user selection and search. The first menu may include all the exact initiating stimuli included in the movie scene such as the exact “Ford F-150.” Then the second menu may contain other Ford trucks, cars, Vans, SUVs, Vans, dealers, truck accessories and so forth until; within the scope of the selected stimuli, the user has reached their definitive selection/request. The user is also given the option of refining their initial search by selecting filters including; manufacturer, price, retail location, product types, and the like. These filters are utilized to both improve the relevancy of the search results and to prioritize the results returned to the user.

Still further according to the present invention, a display method is provided for information identified by the searching system and distribution method above comprised of a communication means for receiving said search results identified above and displaying at least said search results on the user device or other location as designated by the user.

Another aspect of the current invention is a product identification method comprising the steps; 1) a digital copy of information representing a product is stored in the result warehouse during the advertiser registration process, (or added to the unregistered advertiser warehouse), in a manner that allows it to be searched; 2) a digital copy the information representing a desired product is obtained by accessing the results warehouse (or unregistered advertiser warehouse) by proper means; 3) the digital copy is utilized to search selected stimuli for matching, products, product types, scene themes, image collections, image types, and the like; utilizing recognition software which may be audio recognition software, video recognition software, or a combination of both. 4) stimuli/product matches are output.

Another aspect of the current invention is an advertising method comprising the steps; 1) advertisers register product placement bids by proper means, 2) facilitator/content producer searches data server for payment bids and products; the data server correlatively storing information representing payment bids, products, and the corresponding advertising information thereof; 3) information representing products available for product placement is output; 4) content producer creates content which contain the selected products; 5) facilitators link content and information representing corresponding products in a way that allow them to be searched; information representing content (initiating stimuli) is stored correlatively with the information representing corresponding products, and additional search results, thereof.

Still further, according to the present invention, there is provided an advertising system which utilizes the search system, advertising method, or distribution method, as described above.

As yet another aspect of the invention, an perception area identification method is provided comprising a record medium for recording a control program the causes the user device to identify, store and transmit information representing perception area and corresponding stimuli thereof, comprising the steps; 1) utilize the user device to define the perception area utilizing GPS coordinates by proper means; 2) store perception area correlatively with information representing the stimuli source or initiating stimuli thereof; 3) transmit stored information by proper means to the data server; for utilization in the above described search system and stimuli registration methods.

In yet another aspect of the invention, a method of transmitting at least the request coordinates from the user device to a data server and for transmitting information representing search results from a data server to the user device is provide. The data server may be an internal unit or an external unit. The bi-directional transmitting means to an external unit may be wireless or non-wireless and include, but not limited to; e-mail, text message, Wi-Fi, digital side band, internet, Wi-Max, instant messaging, ZigBee, Infared light, FM radio wave, Bluetooth, ISM band radio, Ultra wind band (UWB), Near Field Communication (NFC), Wireless USB chips, Radio Frequency Identification (RFID), cable connection, HDMI cable, USB connector and the like.

In accordance with still further aspects of the invention, the transaction component includes a monetary transfer component configured to perform a monetary transfer with a bank system over a network connection based on user information, user request and request provider agreements.

Another aspect of the invention, is an advertising payment method comprising the steps; (1) a user access information linked to initiating stimuli by proper means; (2) advertiser account is debited for user access of linked information; (3) facilitator/content producer account is credited for user access of linked information.

Another aspect is a user payment method comprising; 1) request result is a user purchase, 2) user account is debited for transaction, 3) advertiser account is credited for transaction by proper means.

A marketing method is provide comprising; 1) user registers to utilize the search system including demographic information; 2) user is exposed to stimuli; 3) a request is initiated as a response to the stimuli; 4) initiating stimuli is identified by proper means; 5) information representing the user is stored correlatively with the information representing the initiating stimuli and request thereof, for management action. Additional user demographic information may be stored correlatively with user I.D. and request history, thereof.

Another aspect of the current invention is an exposure tracking method and system, utilizing the search system and distribution system comprising the steps: 1) search results are returned to the user by proper means, 2) information representing selected results is identified, thus identifying each qualifying product exposure; 3) the corresponding advertiser, advertiser bid information, and facilitator/content producer, corresponding to the product exposure is identified, 4) product exposure frequency and cost data is calculated, 5) information representing the advertiser is stored correlatively with the corresponding exposure frequency, advertising cost data, facilitator/content producer I.D. and the like. Each qualifying exposure my comprise for example; a product's inclusion in the search results returned to the user device, user selection of a particular search result, user purchase of a product, user viewing of a website, and the like.

Another aspect of the current invention is a marketing system which utilizes the advertising system, marketing method, exposure tracking system, or the advertiser payment method, (discussed above); in which marketing data identified and stored above, are provided to the advertiser or facilitator/content producer by proper communication means.

Another aspect is a search string translation method and system which utilize the search method and distribution method above comprising; 1) initiating stimuli stored correlatively with the search strings, keywords, and phrases thereof, 2) user request for a traditional search is initiated by exposure to stimuli, 3) initiating stimuli is identified by proper means; 4) corresponding search strings and keywords are output as search results, 5) search strings are utilized as search conditions to search outside engines and databases. 6) search results are output and returned to user device or other destination as directed by the user.

Another aspect is a search result priority system which utilizes the search system and distribution method comprising the steps; 1) determine user present location by proper means, 2) request is initiated by proper means, 3) user location is included with request coordinates 4) results are identified by proper means, 5) results are prioritized by distance to the users present location by proper means, the results stored correlatively with the location information thereof. The user may also designate other factors to determine result priority such as price, time to delivery and the like. It is preferred that the user location be identified by the GPS function of the user device, however, other methods may be utilized such as; manual input signal reader, cell phone tower triangulation, and the like.

There is also provided a linking system which utilizes the linking method, advertiser approval method, link activation method, and product identification method, described above; providing a record medium for recording a control program that causes the utilization of the above methods to identify and store information representing stimuli correlatively with appropriate search results comprising the steps; 1) facilitator/content producer accesses the data server by proper means, 2) product and stimuli matches are identified by proper means; 3) stimuli/product matches are linked correlatively with appropriate results; storing information representing the initiating stimuli correlatively with appropriate products and the corresponding search results thereof; 4) links are transmitted by proper communication means to advertiser for approval; 5) links are activated once approval is complete; 6) facilitator/content producer is notified of link activation by proper communication means.

Still further, according to the present invention, there is a distribution system, which utilizes the search system, payment methods, distribution method, and search result priority system, as described above, wherein products, services and information are distributed directly to the end user by providing interactive product placement which allows the user to initiate request and obtain information, and purchase products outside the regular distribution channels; comprising the steps; request results are identified by proper means; 2) results are prioritized by proper means; 3) results are filtered by proper means; 4) results are returned to user by proper means; 5) monetary payments are debited and credited as needed by proper means. The delivery of request results; such as information and digital content, may be delivered by communication means such as the internet and the like. Other types of request results; such as for non-digital products, may be delivered by express mail overnight delivery, U.S. postal service, will call window, and the like.

According to the present invention, a request is identified by first identifying the initiating stimuli responsible for the search request, then the request is returned to the user thus delivering an effective search system initiated by a plurality of stimuli sources including; recorded medium, broadcast medium, location specific medium, live medium, streaming medium, and online medium; while improving search accuracy and relevance.

### BRIEF DESCRIPTION OF DRAWINGS

FIG. 1 is a schematic illustrating an outline structure of a searching system according to the present invention.

FIG. 2 shows an outline structure of an advertising searching system according to a first embodiment of the present invention.

FIG. 2A is an outline structure of the advertising search system providing certain additional details of a first embodiment discussed above at FIG. 2.

FIG. 3 is a flowchart demonstrating generally the process steps of the user registration method according to a first the embodiment.

FIGS. 4 and 4A is an illustration representing a sample of selection icons and selection menus further clarifying the stimuli source selection method.

FIG. 4B is a flowchart demonstrating generally the process steps of a multi-dimensional selection system and method involving initiating stimuli selection, request type selection, and the interaction thereof; according to a first embodiment.

FIG. 4C is a flowchart outlining the general process steps of a selection menu method.

FIG. 4D is a flowchart outlining the general process steps of a selection expansion method.

FIG. 4E is a flowchart outlining the general process steps of a selection refinement method.

FIG. 4F is an illustration representing a screen shot or scene of a movie identified as an initiating stimuli; further clarifying a selection system and selection methods described in FIGS. 4 through FIG. 4E above.

FIG. 5 is a flowchart outlining the general process steps in the result registration method comprising advertiser and product registration.

FIG. 5A is a flowchart continuation of FIG. 5 illustrating generally the process steps for bid and result registration according to a first embodiment.

FIG. 6 is a flowchart outlining the process steps included in the stimuli source registration method.

FIGS. 6A and 6B are flowcharts outlining the process steps involved in the initiating stimuli registration method.

FIG. 6C is a flowchart outlining the process steps involved in the stimuli coordinate assignment method according to the present invention.

FIG. 7 is s flowchart illustrating generally a stimuli/result linking method and system according to the present invention.

FIGS. 7A and 7B are a continuation of FIG. 7 illustrating certain additional details including; an advertiser invitation method, and a link approval method.

FIG. 7C is a flowchart outlining the general process steps of an automated stimuli/result linking method according to the present invention.

FIG. 8-8B show examples of partial database tables storing broadcast stimuli correlatively with the stimuli source coordinates and search results thereof.

FIG. 9 is a schematic drawing demonstrating the components and functions of a converged device which maximizes the effectiveness of the present invention.

FIG. 9A illustrates additional detail from FIG. 9 including select device functions and components; as well as, the stimuli coordinates initiated by each component and utilized in the request coordinate identification method.

FIG. 10 is a schematic diagram illustrating a search method in which initiating stimuli is identified according to the present invention.

FIG. 10A is a flowchart illustrating the general process steps involved in a request coordinate identification method, according to the present invention.

FIG. 10B is a flowchart illustrating a result distribution method and system, according to the present invention.

FIG. 10C is a continuation of FIG. 10 illustrating certain additional details, including a search string translation method, and a result filter method, utilized in the search system according to the present invention.

FIG. 10D is a continuation of FIG. 10 illustrating a location priority method, and a result filter method, utilized in the search system according to the present invention.

FIG. 11 are schematic diagrams illustrating additional details of a search system which identifies initiating stimuli utilizing a; relative position method, perception area method, pixel location method, perception time method, and a digital comparison method.

FIG. 11A is presented as further clarification of FIG. 11 and helps illustrate addition detail of the perception area and perception time methods; whereas: a plurality of stimuli sources are identified based on perception area and user location; as well as, the synchronization of time zones associated with the location of the user, the data server, and the stimuli source.

FIG. 11B is a flowchart demonstrating the general process steps of the perception area registration method according to the present invention.

FIG. 12 illustrates the general process of a request coordinate identification method in which a synchronized stimuli is available and is utilized by the searching method and system to identify initiating stimuli. Also, the image and pixel location methods utilized for the identification of the initiating stimuli is illustrated, according to the present invention.

FIG. 12A is a continuation of FIG. 12 illustrating an alternative construction of a request coordinate identification method and system in which a synchronized stimuli is not available.

FIG. 13 is a schematic diagram illustrating a digital comparison search method for identifying initiating stimuli and stimuli sources.

13A is a schematic diagram illustrating an alternative construction of a search method in which request coordinates are transmitted to the data server from an external source.

FIG. 14 is a flowchart outlining the request coordinate identification system which utilizes the search methods, distribution method, and the request coordinate identification methods.

FIG. 15 flowchart outlining the general process steps involved in the advertising method and system, according to the present invention.

FIG. 15A-15C-1 are schematic drawing outlining the money transfer methods and payment components of the present invention.

FIG. 16 is a flowchart outlining generally the process steps of a marketing system and method according to the first embodiment of the present invention.

FIG. 16A is a continuation of FIG. 16 describing certain additional details of the marketing system involving the exposure tracking method, according to the first embodiment of the present invention.

FIG. 17 is a schematic drawing outlining a social network searching system according to the second embodiment of the present invention.

FIG. 18 is a flow chart outlining the general process steps involved in a social network searching system and method, according to the second embodiment of the present invention.

FIG. 18A is a continuation of FIG. 18 explaining additional details relating to perception area calculation, location monitor methods, and search methods, according to the second embodiment of the present invention.

FIG. 19 is a schematic drawing clarifying certain additional details of the social network search system regarding perception areas, according to the second embodiment.

FIG. 19A is a continuation of FIG. 19 illustrating the automated request method initiated by the relative position of the users, according to the second embodiment of the present invention.

FIG. 20 illustrates an alternative construction of a relative position method in which the relative position of the users is determined without communication between the user device and the data server.

FIG. 20A is a schematic drawing illustrating an alternative construction method for the social networking search system in which search results are stored on the user device 4, according to the second embodiment of the present invention.

FIG. 21 is a schematic diagram illustrating the social facilitator override method, according to the second embodiment of the present invention.

FIG. 22 is a drawing illustrating a general overview of a search system for location specific stimuli sources (LSSS) in which products are searched, identified, sold and delivered; according to a third embodiment of the present invention.

FIG. 23 is a schematic drawing illustrating the identification of a request based on a constant output LSSS (Location Specific Stimuli Source) such as a billboard and a store window display; and a variable output LSSS such as a live concert, and a person.

FIG. 24 is a flowchart illustrating the general process steps of a registration method for constant and variable output LSSS according to the third embodiment of the present invention.

FIG. 25 is a flowchart illustrating the general process steps of a registration, search, and purchase, method; according to the third embodiment of the present invention.

FIG. 26 is a flowchart illustrating the general process steps of a multimedia search and marketing system which utilizes the search distribution, and purchase methods of the present invention; according to the fourth embodiment.

FIGS. 27 and 27A and is a drawing illustrating the general components and features of a converged device which maximizes the effectiveness of the fourth embodiment of the present invention.

FIG. 28 is a flowchart illustrating the general process steps an alternative multimedia search and marketing system which utilizes the result registration, search, and purchase, methods of the present invention; according to a fifth embodiment.

FIG. 29 is a flowchart illustrating certain additional detail of a search and marketing system in which multimedia content is utilized for communication; according to the fifth embodiment of the present invention.

Deleted

Deleted

While the invention is susceptible to various modifications and alternative constructions, certain embodiments have been shown in the drawing and will be described below in detail. It should be understood however, that there is no intention to limit the invention to the specific forms disclosed, but to the contrary, the invention is to cover all modifications, alternative constructions and equivalents falling within the spirit and scope of the invention.

### DETAILED DESCRIPTION OF THE INVENTION

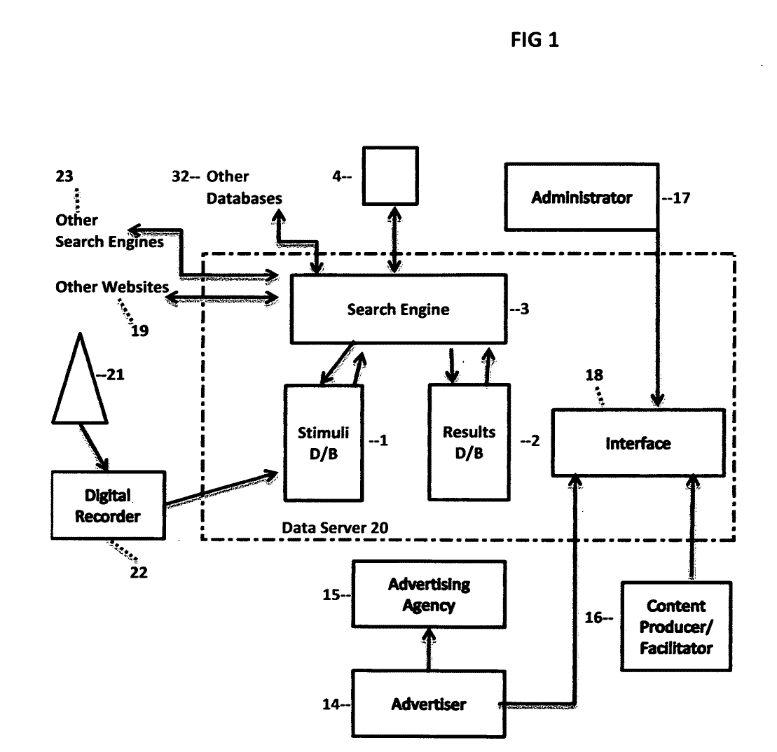

Next, the present invention will be described in detail. First of all, an outline of the present invention will be described. FIG. 1 shows an outline structure of a searching system. The database 1, the database 2, and the search engine 3, compose a Data Server 20. The user interface 18 allows access to the Data Server 20 by; advertiser 14, advertisement agencies 15, Facilitators/Content producers 16, the system administrator 17, and a user (not shown).

The data server 20 is connected to another website 19 (not shown) through a communication means such as the internet.

A website is a place from which information is published to the network. The data server 20 is one web site for example, the data server 20 is connected to a database (not shown) such as another website 19. The location of the website is represented with address information referred to as URL (Uniform Resource Locator). The data server 20 may also be connected by proper means to other databases 32 which are not published to the network.

The stimuli source 21 is, for example, a television broadcast station. The television station broadcast (either wirelessly or non-wirelessly) for example initiating stimuli such as movies, sit-coms, dramatic series, commercials, sporting events, music videos, and the like; (hereafter referred to as multi-media content), corresponding to a pre-created play list. The play list may be created after the multi-media content is broadcast by utilizing a digital reader/decoder 22, that may be a digital receiver, to provide information on the broadcast, by manual input, or by link to the broadcast station website which is publishing real time information about the multi-media content that is being broadcast. Additional information such as commercials and background music may also be broadcast, identified, stored and utilized by proper means.

Stimuli Source 21 may also be a radio station, a cable television station (CATV), an internet television broadcast, a live concert, a movie theater, a digital billboard, a streaming video, a HD radio, a satellite radio, and the like. The stimuli source 21 and the data server 20 are connected through a communication line such as the internet. Alternatively, the stimuli source sends a signal to a digital integrated receiver decoder (IRD) 22 that is connected to the data server by a communicating means such as the internet, USB (Universal Serial Bus) and the like. Information representing initiating stimuli, and identifying information, (hereafter referred to as stimuli coordinates), are transmitted from the stimuli source 21 to the data server 20 where the data is classified and stored into corresponding records using an automated software process utilizing a plurality of methods to populate the data server with information representing the initiating stimuli stored correlatively with stimuli coordinates thereof.

The broadcast type stimuli coordinates stored in database 1 are not always transmitted from a stimuli source 21, the corresponding website 19 or a digital decoder 22. In other words, the data server may be populated by a plurality of methods and sources, including but not limited to manual input, data links, calculation, and downloads. The data may be stored to the database 1 through a predetermined storage medium; or, the information may be created on another system other than a broadcasting station (stimuli source) and transmitted to the data server 20. A plurality of methods may be used alone or in combination to determine the stimuli coordinates of each stimuli source and initiating stimuli.

Stimuli Source 21 may also be a non-broadcast stimuli source type such as a billboard, a window display, a magazine, a piece of real estate, and the like, In this example, the stimuli source 21 and the data server 20 are not connected through a communication line such as the internet.

The non-broadcast type stimuli coordinates stored in database 1 may be stored to the data server 20 by a plurality of methods and sources, including but not limited to; manual input, data links, calculation, and downloads. The data may be stored to the database 1 through a predetermined storage medium; or, the information may be created on another system, or created on a device such as the user device 4 (discussed later) utilizing the perception area registration method, (discussed below), and transmitted to the data server 20. A plurality of methods may be used alone or in combination to determine the stimuli coordinates of each non-broadcast type stimuli source and initiating stimuli. The user may also be prompted for additional information.

### Preferred Embodiments

### First Embodiment

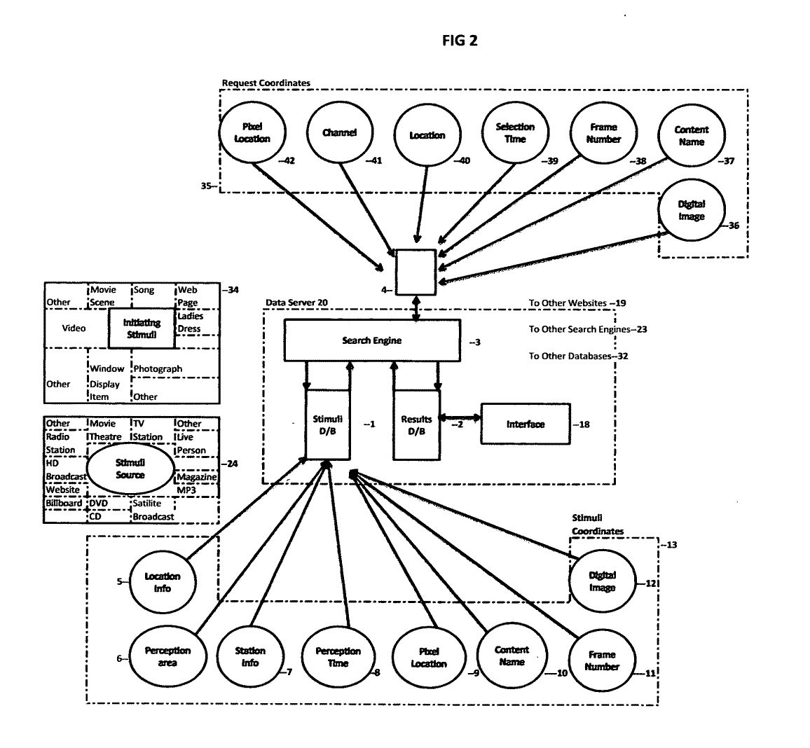

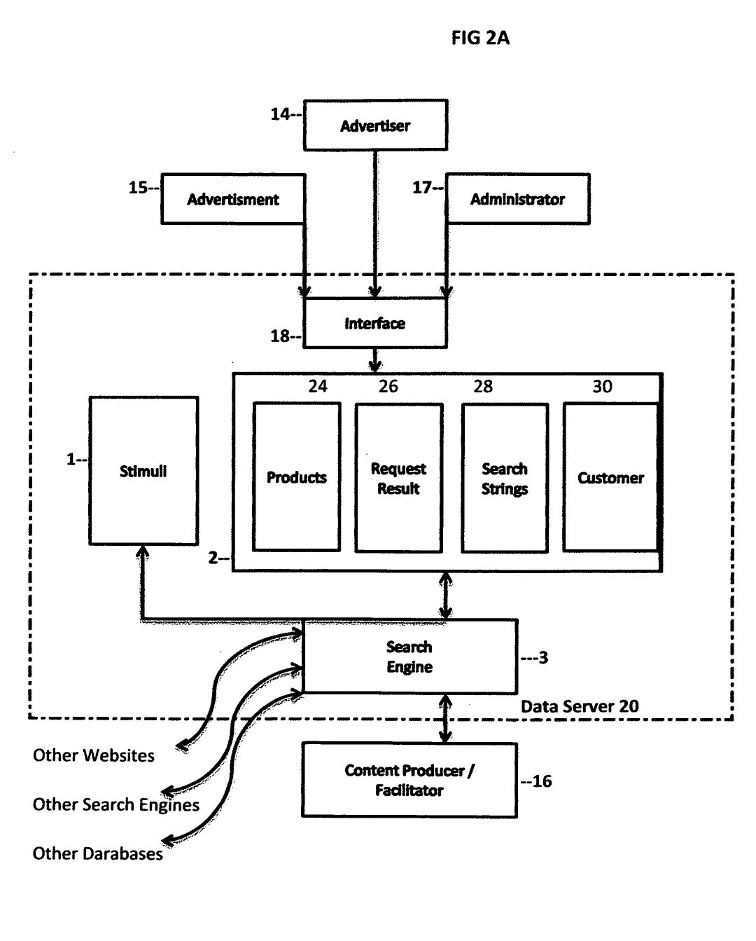

One embodiment of the present invention provides a system and method for effective search advertising that allows a user to search and make requests based on direct, free association, and automated responses to a plurality of stimuli source types and initiating stimuli types; most not traditionally utilized as advertising; and to receive relevant search result. In FIGS. 2 and 2A, similar portions to those in FIG. 1 are denoted by similar reference numerals and their description is omitted.

Next, a first embodiment of the present invention will be described. FIG. 2 shows and outline structure of an advertising searching system. Referring to FIG. 2, the advertising search system comprises two primary data bases 1, and 2, search engine 3 and user device 4. The search engine 3 searches the data bases 1 and 2. The user device 4 comprising both a communication means and a recording means for recording a control program, to assist the user in identifying search conditions, hereafter referred to as request coordinates (R/C). (discussed later)

Data base 1 stores information representing stimuli sources and initiating stimuli correlatively with the corresponding stimuli source coordinates and initiating stimuli coordinates (hereafter collectively referred to as stimuli coordinates S/C) thereof. More precisely, the data base 1 may correlatively store stimuli source names, stimuli source coordinates, the initiating stimuli names, initiating stimuli coordinates, and additional information there about. The additional information about each stimuli may include: live data links for current stimuli coordinates; a digital representation of the stimuli itself; a digital copy of the stimuli; payment instructions for payment of advertisement fees; digital files such as songs, ring tones, videos, and movies; and the like. The additional information may also be stored to another database that can be searched form the search engine 3. The stimuli coordinates 13 may include, but are not limited to; location 5, perception area 6, station information 7, perception start time 8, pixel location 9, content name 10, frame number 11, digital image 12; as well as, perception adjustment variable (PAV), marker content I.D. synchronized perception start times (SPST), and the like (as discussed more fully in related provisional patent application Ser. No. 60/702,818 and patent application Ser. No. 11/460,604.

Each stimuli source 21 (television broadcast, recorded HDVD movie, live concert, billboard, magazine, and the like) may be stored correlatively with a plurality of stimuli coordinates 13. The stimuli source may then be identified by utilizing a plurality of non-unique combinations of the request coordinates 35 as search conditions to identify the assigned S/C 13. For example; the assigned stimuli source coordinates 13 for a radio station may include: a perception area 6, and channel 7; yet location 40 may be the only request coordinate utilized to identify the radio station if the perception area 6 does not overlap that of other radio stations.

Each initiating stimuli 34 (movie, song, window display, and the like) may also be stored correlatively with plurality of S/C 13. The initiating stimuli 34 may then be identified by utilizing a plurality of non-unique combinations of R/C as search conditions. For example, the stimuli coordinates 13 stored correlatively with an embedded initiating stimuli (an image of an automobile driven in a broadcast movie scene) may include: perception time 8, content name 10, frame number 11, a pixel location 9, and a digital image 12; while the initiating stimuli coordinates of a song played at a live concert may consist of; the concert perception area 6, and perception time 8. However, the request coordinates utilized to identify the automobile may comprise as little as the digital image 34; or alternatively, the movie title 37, and the frame number 38, in which the automobile appeared; or as much data as, user location 40 from which the broadcast could be perceived; a channel 41 from which the movie was broadcast; perception time 39 corresponding to the time in which the movie frame could be viewed; and, the pixel location 42 corresponding to the location of the automobile within the movie frame.

The data base 1 may store information about a plurality of stimuli sources correlatively with a diverse combination of initiating stimuli and the corresponding initiating stimuli coordinates thereof. According to the present invention, which of the R/C 35 (or combination thereof) are utilized to identify said stimuli depends on the stimuli source type, initiating stimuli type, the particular stimuli source, the particular initiating stimuli, the particular user device capacity, and the amount of user input.

Initiating stimuli 34 may originate from a plurality of diverse stimuli source types such as; a DVD streaming video, television stations, radio stations, live concert, a billboard, a magazine, and the like. Initiating stimuli 34, which is the stimuli responsible for initiating a user response may include; a YouTube video, a real person, a movie scene viewed on a HDVD movie, an item inside a window display, a song played at a live concert, a set of predetermined conditions, and the like.

The database 2 stores information representing advertisers correlatively with information representing products and corresponding search result in which the advertisers wish to link to the initiating stimuli stored in the database 1. For example; when the product is an automobile; the request results corresponding to the product may include; a product name, performance information, nearest dealership, colors, price, URL address, web links, a search string, communication options, and the like. These search results may then be linked with the initiating stimuli; such as an image of an automobile embedded in a particular scene of a DVD movie, in such a way that they may be identified and returned to the user (stimuli/result linking method discussed later).

The database 2 can also store user information. The database 2 stores customer I.D. information unique to each user and to each user device 4 (discussed later) as well as other information about each user such as; demographic information, device capabilities, purchase preferences, social network links, personality profile information, photographs, product delivery instructions, GPS location, and the like. Information representing each facilitator/content producer may also be stored such as Facilitator I.D., e-mail address, link credits, payment information, and the like.

The search engine 3 searches information from the database 1 corresponding to a search condition (hereafter referred to as request coordinates) designated by the user or user device 4 in order to identify the initiating stimuli. In this example, the search engine represents a structure of a block that provides the user with a particular function. The search engine 3 provides the user with a particular searching function. The R/C 35 may be for example; user GPS location, adjusted time of selection (ATOS), channel, pixel location, frame I.D. content I.D., digital representation of the initiating stimuli, URL, movie name, song name, and the like.

The search engine 3 may also search; other websites 19, search engines 23, and other databases 32 not published to the web. This is accomplished by utilizing; the search stings, search phrase, and keywords, stored correlatively with the initiating stimuli 34, as search conditions. The search result are output without the user needing to enter a keyword. The search output of the traditional searches, such as Google, Yahoo, Facebook, Monster.com, and MySpace, can be supplied to the user. The results may be supplied “as is” or they may be filtered and prioritized, before being supplied to the user.

In this example, it is assumed that the stimuli source is a broadcast television station, and that the initiating stimuli provided by the stimuli source is an automobile, embedded in a particular movie scene.

When the user is interested in a particular automobile that appeared in a broadcast movie scene, if he or she knows the perceptions area, television broadcasting station, the broadcast time, and the pixel location he or she may designate perception area 5, broadcast station information 7, perception time information 8, and pixel location information 9 (or alternatively, pixel location 9, movie title 10, and frame number 11) as search conditions to the search engine 3. The search engine 3 searches the database 1 corresponding to the designated search conditions and output for example a movie frame as a search result. In addition, the search engine 3 searches the database 1 utilizing the movie frame I.D. and the pixel location 9 as search conditions and outputs the initiating stimuli, the automobile which was responsible for initiating the user request. Then utilizing the initiating stimuli as a search condition, the search engine 3 searches database 2 and returns corresponding results information; for example, automobile name, photo's, web links, dealers, specifications, and so forth of the initiating stimuli. Search results of the database 2 are supplied to the user device or alternative location designated by the user.

On the other hand, when the user wants to search a desired automobile that was embedded in a movie scene and broadcast from a television station, he or she may not know the information 5,7,8, and 9. However, according to the present invention, the user has the user device 4 that can obtain R/C 35 which corresponds to; perception area 5, broadcast station information 7, perception time information 8, and pixel location information 9, (discussed later) or alternatively; the user device can obtain R/C which correspond to pixel location 9, movie name 10, and frame number 11.

In other words, when the user is interested in a initiating stimuli (in this case an automobile) that was broadcast as part of a movie, he or she operates the user device 4 so as to store the proper request coordinates which corresponds to, 5, 7, 8, and 9, (or alternatively 9, 10, 11,) depending on the particular stimuli and the user device capacity. The search engine 3 searches the database 1 with R/C 35 corresponding to the perception area 5, broadcast station information 7, perception time information 8, and pixel location information 9, (or alternatively movie title 10, frame number 11, and pixel location 9), and outputs the results; for example, a movie frame. The search engine 3 then searches the database 1 using the movie frame 38 and the pixel location 42 to identify and output the embedded initiating stimuli (the automobile); and then searches database 2 for associated search results. The search results are then supplied to the user. Alternatively, the output may also include results relating to all initiating stimuli contained in the chosen movie frame. For example, the results may include automobile information relating to the auto, clothing information relating to the actress' dress and shoes, skiing and vacation information relating to the mountains as see in the background of the movie frame, the actual movie frame itself, and the like.

According to the present invention, when a user becomes interested in an initiating stimuli like an automobile that appears in a broadcast movie scene, he or she can obtain desired information by causing the user device 4 to store the request coordinate 35 which corresponds to S/C 13 information such as; 5, 6, 7, 8, (and 9, 10, 11, and 12). Further according to the present invention, when a user is interested in an I/S 34 which may originate from a plurality of stimuli sources; the user can obtain desired information by causing the user device 4 to store appropriate R/C 35 (or group of R/C) based on each particular stimuli source, particular stimuli, particular request type, and the particular user device 4 capabilities/features. Therefore, according to the present invention, the user is able to conduct data searches based on a plurality of stimuli source types 21 and I/S 34; while also utilizing traditional search engines 23 and web pages 19; such as Google, Yahoo, Facebook, MySpace, Match.com, Monster.com, FaceBook, and YouTube, without the use of keyword or phrase.

FIG. 2 discussed primarily stimuli source type “broadcast”, however, the data server 20 can store a plurality of stimuli source types (such as broadcast, recorded, live, streaming, print, internet, location specific, mobile and image specific) correlatively with related initiating stimuli and the corresponding initiating stimuli coordinates and search results thereof, in such a manner that they may be identified.

Next, the present embodiment of the invention will be described in additional detail. FIG. 2A is a continuation of FIG. 2 illustrating certain additional details, according to the present invention. Referring to FIG. 2A, the data server is comprised of two primary data bases 1 and 2, a search engine 3, and an interface 18 for use in populating and updating information in the data server 20, and an user device 4 assisting the user to obtain search conditions or request coordinates. The data base 2 is comprised of at least four data tables (at 24, 26, 28 and 30).

Referring to FIG. 2A, the advertisers 14 register to participate in the information searching system and are given a unique identification number to be used in billing and for accessing the interface 18 that will allow them to populate and update information in the data server 20.

The interface 18 can be structured with a database management filter that prohibits the database from being accessed by an unauthorized user. The interface 18 is preferably provided with a GUI (Graphical User Interface) that allows an external authorized advertiser to easily update the contents of the product warehouse data table 24, the request result warehouse data table 26, and the search string warehouse data table 28. Additionally a user may utilize the interface 18 to register for the service and to populate and update data stored in the customer data table 30.

The advertiser may also utilize an advertising agency 15 or other third party to populate and update information in the data server 20 by granting them authorization. The information may include products, product descriptions, product advertisements, product search strings, content production tools, and the like.

The product warehouse 24 stores information representing advertisers and their corresponding products (such as Ford Motor Company and its F-150 truck) correlatively with information representing; product classification, advertisement bids available to content producers/facilitators, as well as content production tools and resources.

The content production tools and resources are comprised of product photographs, videos, website links, audio files, specialized software and other items that may be helpful to content producers who are interested in including the advertiser's product in their content. This material may be stored in the product warehouse database 24, or in an outside website 19, or database 32, accessed through the search engine 3.

The search engine 3 is utilized; in conjunction with the product warehouse data table 24 and outside databases 19, by content producers and facilitators 16 who wish to locate, filter and utilize products available for inclusion in their content in exchange for advertising fees. Content producers/facilitators may also search for tools and other materials which would be helpful in producing their content and for inclusion in their content.

The request result warehouse 26 stores information representing products correlatively with information and products that the advertiser wishes to provide to a user in response to a request or inquiry. This information may include product specifications, product photographs, product advertisements, URL/website addresses, hyperlinks, digital files, and the like. The request results warehouse 26 may also store information on price, retail locations, retail information, as well as a real time purchase options and communication options. This material may be stored in the request result warehouse data table 26, or in an outside location 19 (or 32) accessed through the search engine 3.

The search string warehouse data table 28 correlatively stores information representing products and the search keywords or phrases relative thereto. Since the present invention allows a user to make a selection and request in response to an initiating stimuli without the need to know a keyword or search phrase, a method to translate a request into a keyword or search string is utilized to facilitate traditional searches. This method allows a user to search outside websites 19, traditional search engines 23, and other databases 32; without knowing or entering a search keyword or phrase.

The source of the search strings stored in the search string warehouse 28 can be advertisers 14, or their advertising agency 15. Search strings may be utilized as a form of paid search with intention of enhancing a product or advertiser search position in a plurality of search engines and outside databases. Alternatively, the search string warehouse data table 28 can be populated by the Database Administrator 17 in order to facilitate a specific result or the most relevant search result.

According to the present invention, the user may receive a plurality of search result types available from search of the data server 20, as well as additional results received by searches of alternative websites 19, search engines 23, and other databases 32.

For example, a content producer 16 conducts a product search 24 and decides to include a Ford F-150 truck in his YouTube video; a user is exposed to the video and becomes interested in the Ford F-150 truck (the initiating stimuli); then the user may select the truck (selection method discussed later) and then a search is conducted returning information about the Ford F-150 truck.

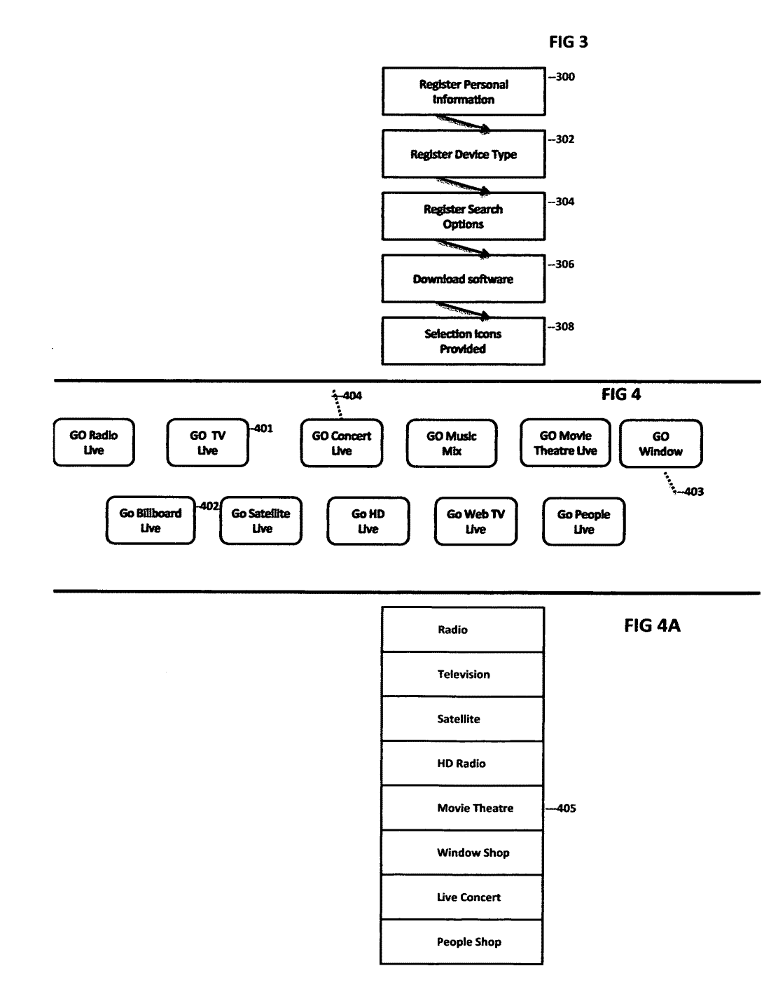

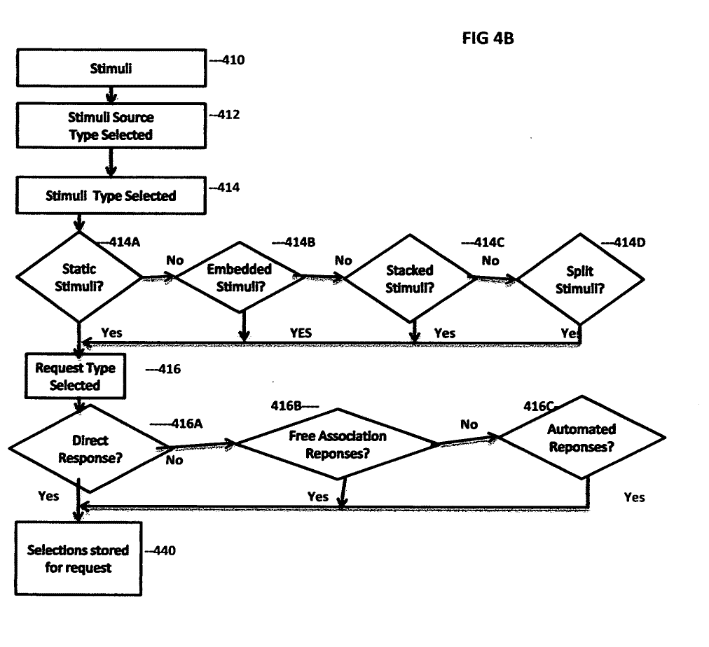

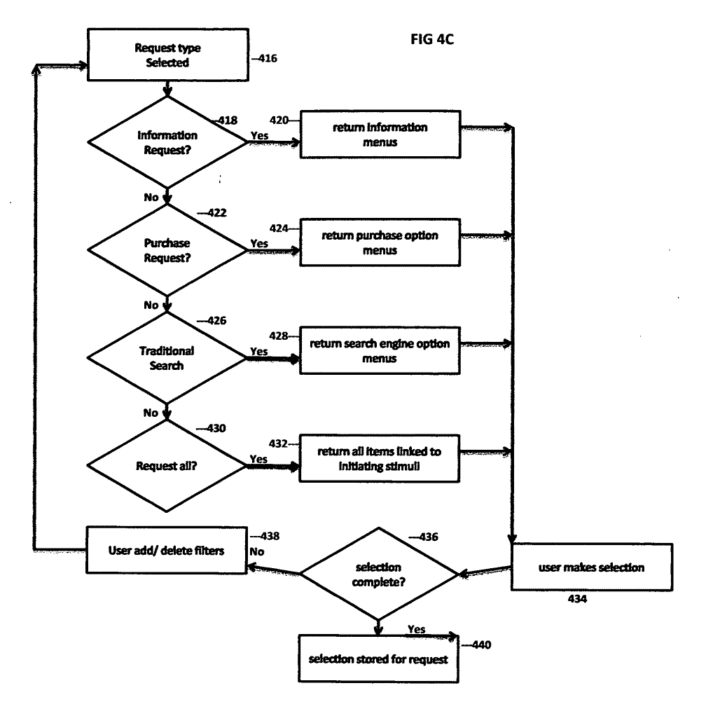

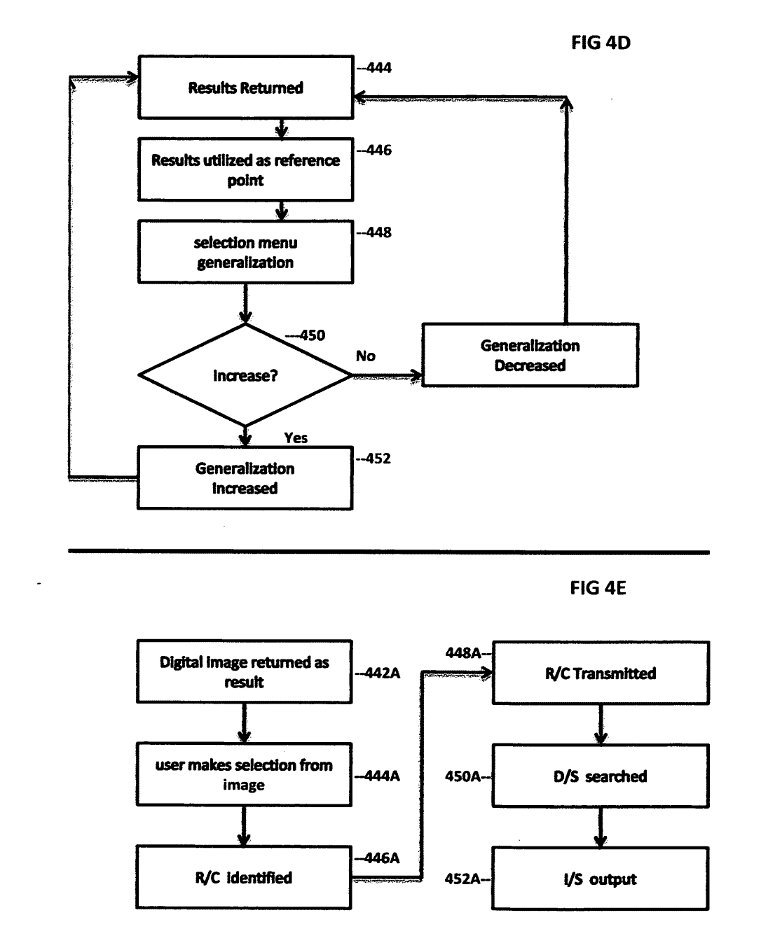

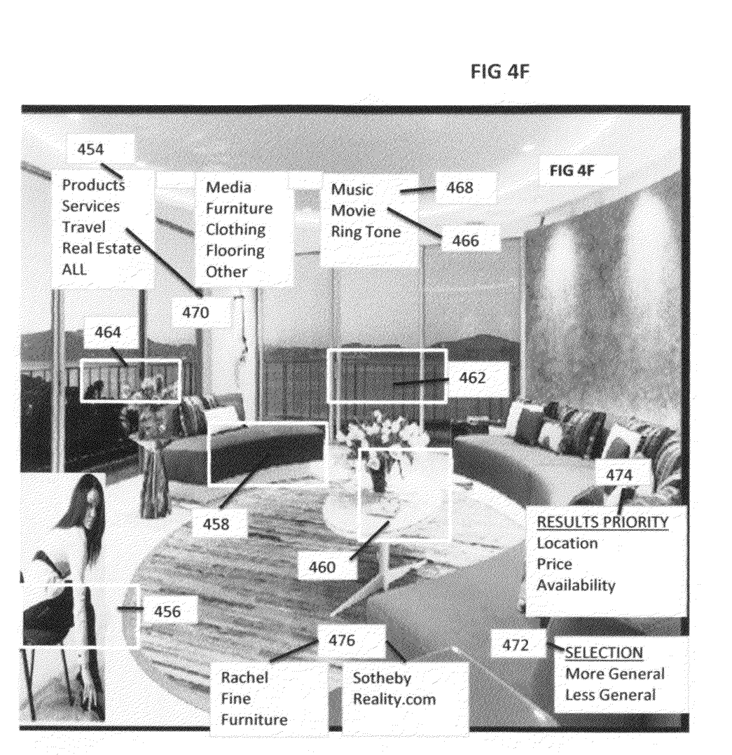

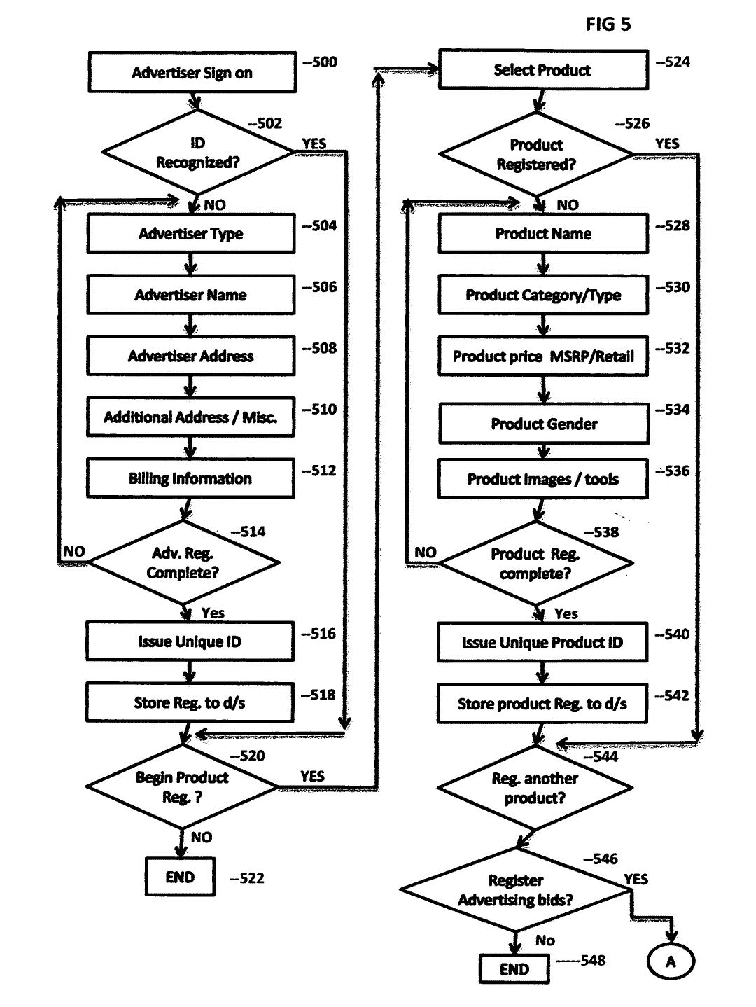

FIG. 3 is flowchart illustrating generally the process step of the registration and according to the present invention. The user would first register for the service (at 300) with personal and billing information and then proceed to registering the device types used (at 302), (as device capacities differ), and search option preferences (at 304). These opinions may include preferred search filters, alternative search engines and the like. Once the registration information is complete, the user downloads the software onto the device which they intend to utilize (at 306), and (at 308) the proper selection menus and icons (see FIG. 4A for examples) are provided to facilitate the user selections.

Once the registration information is complete, the user downloads the software onto the device which they intend to utilize and the proper selection menus and icons are provided to facilitate the user selections. Referring to FIG. 4 as an example, the user is provided with a plurality of stimuli source selection choices and may select icons for; a television broadcast (at 401), a billboard (at 402), a window display (at 403), a live concert (a 404), and the like. This may also be the source of the stimuli source type information utilized in the request coordinate identification method or the searching method and system.

FIG. 4A is an illustration of an alternative stimuli source selection options in the form of menus instead of icons; such as the selection of a movie theater (at 405), and the like. The user selection may be initiated by: icon selection, menu selection, touch screen, highlighting, button operation, curser location, image selection, predetermined parameters for an automatic search initiated by a control.

FIG. 4B is a flowchart helping to illustrate the general process steps involved in the multi-dimensional selection method. Once the user and user device are registered and selection icons are provided as discussed above, the user is then exposed (at 410) to an initiating stimuli that initiates a response from the user in the form of a stimuli source selection (at 412); the stimuli source types may include: recorded, broadcast, live, print, internet, streaming, location specific, and image specific, stimuli sources. The user may now make a selection by proper means of multi-dimensional initiating stimuli including: 1) static initiating stimuli (at 414 A); such as a music video, a billboard advertisement for a vacation destination, and a commercial for an automobile; 2) embedded initiating stimuli (at 414 B), such as dress worn by an actress in a music video, or a song played in the background of an automobile commercial; 3) stacked stimuli (at 414 C), such as a CD based on the song played in the automobile commercial, or 4) split stimuli (at 414 D) such as a ring tone based on the song, dress material from which the dress was made, or custom paint shown on a car seen in the music video. Next, the user request type is selected (at 416) by proper means and may be applied to any initiating stimuli type (414 A-414 D). The request may be: 1) a direct response (at 416 A), such as a request for automobile information after viewing an automobile commercial or a request for a music video after watching the music video; 2) free association response (at 416 B), such as a request for beach front real estate information after viewing the vacation billboard; or 3) an automated response (at 416 C) to the stimuli that initiates selection such as, the relative location of a person with a matching personality profile, or a specific product price within the users self defined perception area. Finally the selections are stored (at 440) by proper means. Therefore, as discussed above: the stimuli source type, the initiating stimuli type, and the request type are identified.

FIG. 4C is a flowchart illustrating generally the process steps of the selection system; in which a series of menus are returned to the user as a response to the user selections. For example, the user may select “information request” (at 418) and be returned (at 420) information menus relating to all items linked to the selected initiating stimuli. The user may alternatively select “purchase request” at (422) and be returned (at 424) a purchase option menus for all items linked to the selected initiating stimuli; or the user may then select “traditional search request” (at 426) and be returned (at 428) a search engine option menu for all items link to the initiating stimuli; or the user may alternatively select “request all” (at 430) and be returned (at 432) a menu of all items linked to the selected initiating stimuli; or all items located within said users perception area. Once the user has determined their desired menu, a selection is made (at 434). If the selection is complete (at 436) then the selection information is stored (at 440), for inclusion in the user request. If the selection is not complete, then the user may add or delete filters (at 438) and the selection process continues (at 416).

FIG. 4D helps illustrate a selection expansion method and system which utilizes the search method and system (discussed later) in which increasingly general menus and search results are provided to the user beginning with very specific information to be more generalized, yet related information. The selection expansion method and system comprising the steps: the initiating stimuli is identified and specific search results are returned to user by proper means (at 444); then (at 446) the selected and identified initiating stimuli is utilized as a reference point; from which point (at 448) the user is provided with an increasingly general series of menus, or results for user selection. The user may (at 450) determine to increase the generality of means and results after each selection; which is then increased (at 452); or alternatively may decide to decrease the generality of menus and results (at 450); which is then decreased in relation to the original initiating stimuli (at 454).

FIG. 4E helps illustrate a selection refinement method comprising the steps; a digital image or representation of the initiating stimuli is provided to the user by proper means (at 442A) user selects by proper means the portion of the image in which they are interested (at 444A): new request coordinates are identified (at 446A) by proper means: and at least the new request coordinates are transmitted to the data server by proper communication means (at 448A); the data server is then searched utilizing new stimuli coordinates (at 450A); and more specific search results are output (at 452A); the data server storing information representing corresponding stimuli coordinates correlatively with the information representing initiating stimuli and additional information thereof. The request coordinates (and corresponding stimuli coordinates) in this example may be pixel location which may include a vertical and horizontal component such as “line number” and a “column number”, which corresponds to the image location selected by the user, for example.

FIG. 4F is one example of a complex stimuli to help further illustrate certain aspects of the multi-dimensional selection system and methods discussed above. For this example, the illustration represents a screen shot or a single frame from a broadcast movie which was identified as the users' initiating stimuli and initial selection. The frame was identified (search method discussed later) and was returned to the user device as a search result, to be utilized for selection refinement.

Referring to FIG. 4F, a user may select initiating stimuli by selecting areas of the image such as the chair (at 458), as outlined in the selection refinement method discussed above (at FIG. 4E); or alternatively, by utilizing the menus provided (at 454) as outlined in the selection menu method discussed above (at FIG. 4C).

An example of a direct response to a static stimuli may be selecting the movie itself (at 466). An example of direct response to an embedded stimuli would be the selection of the blouse worn by the woman (at 456) or the chair (at 458), or alternatively the selection of a song playing in the background chosen by menu selection (at 468).

An example of a free association response may be the selection of a plant service initiated by viewing the plant (at 460); or California vacations initiated by the ocean and mountains viewed and selected (at 462 and 464); or alternatively, selected by utilizing the menu (at 470).

Selection expansion options are also illustrated (at 472) which allow the user the ability to expand (or contract) menus and results; (selection expansion method discussed at FIG. 4 D) in relation to the selected initiating stimuli.

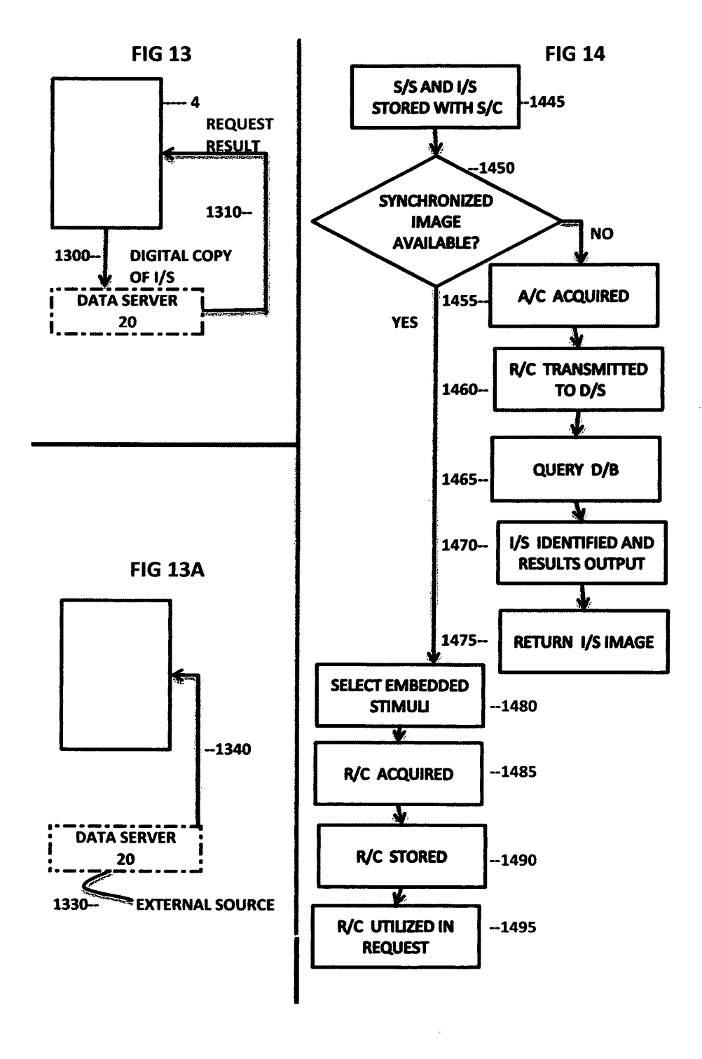

Other selection refining menus such as a search result priority menu are also illustrated (at 474); (search result priority system discussed below at FIG. 13 B), in which the user may choose to filter and prioritize the search results by location, price, product availability, and the like.

It is also contemplated that specific advertisements may be placed in the margins (at 476) relating to the selected initiating stimuli. These advertisements may also be selected and results returned to the user by proper means.

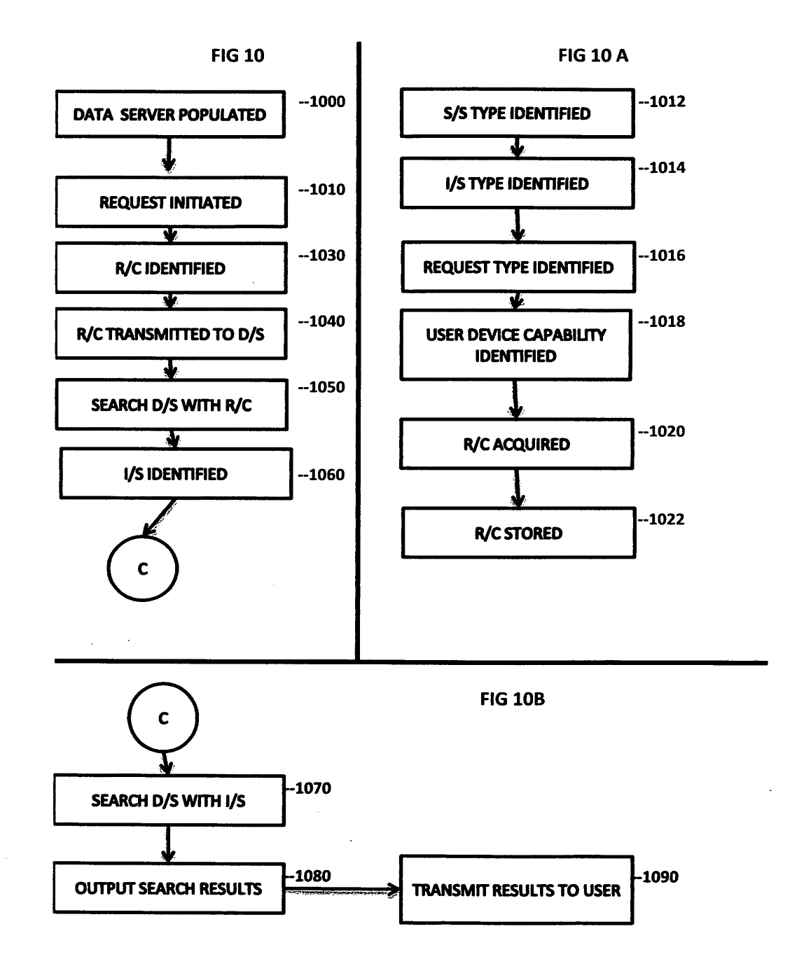

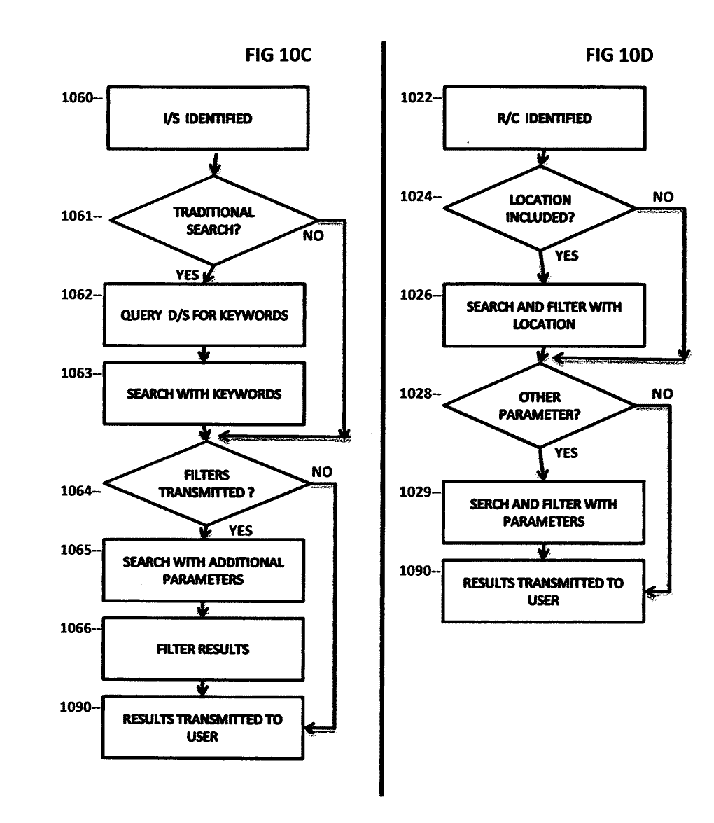

Further according to the present invention, there is also provided a selection system comprising multiple selection methods as discussed above including: a stimuli source selection method (at FIG. 4-4A): a multi-dimensional selection method involving initiating stimuli selection, and request type selection (at 4 B); a selection menu method (at FIG. 4 C); a selection expansion method (at FIG. 4 D); and a selection refinement method (at FIG. 4 E); as well as a result priority system (at FIG. 10 D); as summarized generally (at 4 F). The multi-dimensional selection system and methods, discussed above, provide selection options which organize and present multi-dimensional stimuli (found in a particular movie frame for example) in such a way as to assist the user in selection.

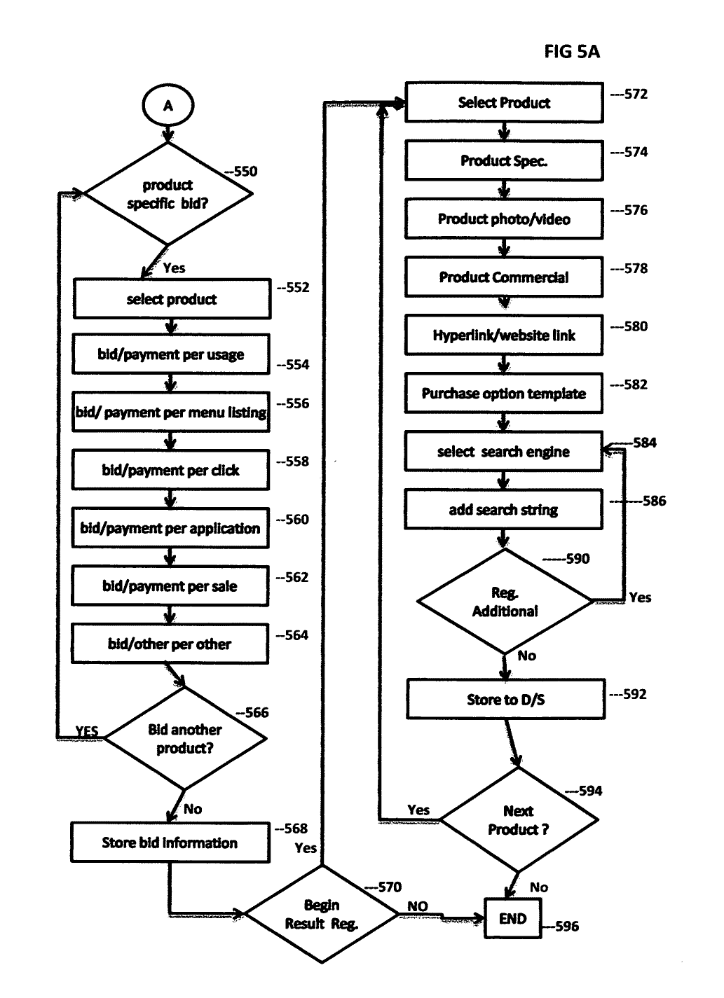

FIG. 5 is a Flowchart generally illustrating certain additional details of the search system outlined in FIGS. 2 and 2A; comprising a result registration method; illustrating the registration of the advertiser with the corresponding products, services, and information.

Beginning (at 500), an advertiser signs on to the system and if their unique identification is recognized (at 502), they may proceed to register products (at 518). On the other hand, if the advertiser is not recognized (at 502), they must register starting (at 504) where they indicate, by selection, the type of advertiser. This may include manufacturers, retailers, advertising agencies, wholesalers and the like. The advertiser then enters additional information such as advertiser name (at 506), advertiser address (at 508), additional location addresses (at 510), and the like. Next (at 512), the advertiser enters billing information that may include credit cards, PayPal checking account, debit account, corporate accounts, debit cards, and the like. If the registration is not complete (at 514), the user is returned to complete the registration until the registration process is complete (at 514).

Once the Advertiser registration is complete, the advertiser is then issued a unique Advertiser Identification Number allows the registered advertiser (RA) to access the information searching system in order to add and update information such as products, advertisements, product information, search strings and advertisement payment bids.

Next, the RA may begin to register individual products (at 520), or may choose to end the process (at 522). If the RA choose to proceed (at 520), a product is entered (at 524) and the system confirms the product has not yet been registered (at 526).

The RA may then proceed to register the product. In this example, the RA would begin by entering the product name (at 528), the product category and type information (at 530), product pricing information (at 532), product gender information (at 534), and product images may be entered (at 536) to help facilitate a method for automated product registration of existing content (to be discussed later). The RA may also enter (at 536 A) specialized content images and software to be utilized by content developers in producing content containing product placement.

The product categories and types (at 530) may classify products broadly as with “SIC codes”, “consumer goods”, and “services”, as well as the smaller categories such as “clothing”, “automobile”, “furniture”, and “digital content”; or smaller yet, such as, “dresses”, “trucks”, “chairs”, and “music”.

These types of product qualifiers allow content producers/facilitators to search the product database for specific product placement needs. For example, a video producer may be planning to film a scene in a living room and would thus, need to search for “living room furniture” or “living room accessories”. If the scene required an elegant living room in an expensive home, or alternatively, a low budget living room in an inexpensive home, the producer may want to add a “price range” qualifier to the search in order to receive the most relevant products to meet the needs of the scene.

As another example, the video producer may be planning to film a party in this living room scene and thus, needs to search for the hostess attire. The product database may be searched for “clothing”, “female”, “evening wear” and “price range” in order to receive the most relevant registered products in which to dress the actor while receiving product placement fees from the RA.

Proceeding forward, the system next checks to see if the product registration is complete (at 538). If it is not complete, the user is asked to complete the registration. If the product registration is complete (at 538), the product is assigned a unique product identification number (at 540) and the product registration information is stored (at 542), completing the product registration.

The RA is then given an option to register additional products (at 544). If additional products are to be registered, the RA proceeds with each additional product as described above. If the RA choose not to register additional products (at 544), they are given the option to begin registering advertising bids (at 546); or alternatively, of ending the process (at 548) where the RA may exit the system.

FIG. 5A is a continuation of the flowchart shown in FIG. 5, generally illustrating certain additional details of a result registration method utilized by the search system outlined in FIG. 2; comprising the bid and result components.

Once the registration of the advertiser and products has been completed as discussed above; the RA is given a choice to enter a product specific bid or, alternatively, a bid that will be universal for all the products of that advertiser (at 550). If the RA chooses to enter a unique bid (at 550), a specific product is selected (at 552) and the RA enters advertising/bid information beginning (at 554), the advertiser may enter a bid for product placement usage, a bid per menu listing (at 556), a bid to be paid per click (at 558), a bid per application (at 560), a bid per sale (at 562) or a custom bid option (at 564).

The product usage bid (at 552) represents the amount at RA is willing to pay to have their product included in content commonly called a product placement fee. For example, Ford Motor Company may bid or offer a fee in exchange for a Ford F-150 truck being used in a major motion picture, a YouTube video, a MySpace page, or a beer commercial. This bid may be a flat fee, a fee/bid for each content type, a bid for a particular content type only, or a bid for a particular content producer who may be pre-approved by the advertiser. This usage bid may also be based on the number of people exposed to the product in the content. This may be a fee based upon the numbers of tickets sold, the number of DVD's sold, per live concert attendee, per unique television viewer, per YouTube video viewer, per DVD Viewer, and the like (exposure calculation method to be discussed later).

The bid for a menu listing (at 556) represents the amount an advertiser is willing to pay to appear in a request search result. As an example, the user may select a Ford F0150 truck displayed in a video and request retailers based on location, as a request result, the retail Ford truck locations may choose to pay a fee for preferential menu listing or search results, often referred to as paid search.

The bid for a per/click fee (at 558) represents the fee a RA is willing to pay for a “click through” or for a user accessing additional information about their product. This may be a user selecting a particular advertisers' product from a menu, a request to receive product specifications, a transfer to a website, or the return to the user particular information stored in the results database. As an example, after viewing a list or menu of Ford F-150 truck retailers, the user selects a single retailer in order to click on current inventory or perhaps to get location map. This may be considered a “click through.” Thus, the bid/click fee would be due to the content producer/facilitator.

The bid for a per application fee (at 560) represents a fee that a RA is willing to pay for a user to complete some type of application. This may be an application for financing, credit cards, or memberships. This may also include surveys, questionnaires, registrations and the like.

The bid for a sale (at 562) represents the amount a RA is willing to pay as a commission for the sale of an item initiated by the producer's content.

The bid labeled “other per other” (at 564) allows the RA to make custom bids which offer special incentives to content producers such as one time bonus payments for the sale of a particular product over a specific time window, or an across the board increase in bids by a percentage paid for a specific period of time.

Advertisers may choose to bid on some activities and not on others. Advertisers may also choose to bid all activities or upon none at all. The object of the bidding system is to five content producers/facilitators, incentives to include particular products in their content while providing advertisers specific cost/benefit data upon which they can rely to help in making advertising decisions.

Once the RA completes the bidding process, they are given a choice (at 566) to register bids on additional products. If additional bids are to be registered, the new product is selected (at 552) and then the user proceeds as described above.

Once the RA has completed the bidding process (at 566), the bid information is stored (at 568) and the RA is given the choice to register request results (at 570) or to exit the system (at 596).

When the RA begins to register request results which they wish to have provided to a customer in response to a request (at 570), the RA begins by selecting a registered product (as discussed above at 572). The RA then enters information such as product specification (at 574), product photographs and videos (at 576), product commercials (at 578) hyperlinks, websites, and URL addresses (at 580), and purchase option templates (at 582). Registered results may also include digital content such as; movies, film clips, music, music videos, ring tones, snippets, and the like.

The RA is next given the opportunity to register unique search strings to be used in a plurality of search engines and databases such as Yahoo, Google, AOL, EBay, Monster.com and the like. To accomplish this the RA first selects a desired search engine or database (at 584) and then enters a search string (at 586) that they would like used when a customer is searching their product by utilizing that particular search engine or database. The RA is then given the option (at 588) to register the unique search strings with additional search engine or database, they are returned (at 584) and the process continues as described above. When the RA decides to proceed, the data is then stored (at 592) and the RA is given the choice to repeat the process with each of their products (at 592) or to end the registration process (at 596) and exit the system.

FIG. 5 is a flow chart illustrating one embodiment of the process steps involved in the stimuli source registration method, allowing the registration system which is comprised of a stimuli source registration method, an initiating stimuli registration method, and stimuli coordinate assignment method.

According to the present invention, a plurality of stimuli source types may be registered and utilized including; (1) “broadcast” stimuli sources (at 610 A) such as television transmission, radio, satellite and cable television transmission (both wireless and non-wireless transmissions); (2) “recorded” stimuli sources (at 610 B) such as DVD, HDVD, BlueRay, Compact Disc (CD), a MP3, or other storage medium; (3) “internet” stimuli sources (at 610 C) such as websites and online videos; (4) “streaming stimuli sources (at 610 C) such as a webcast, simo-cast, and podcast; (5) “location specific” stimuli sources (at 610D) such as billboards, shop windows, and movie theaters; (7) “live” stimuli sources, (at 610 E) such as music concerts and plays; (8) “print” stimuli sources (at 610 F) would include newspapers, and magazines; (9) “image specific” stimuli sources at (610 F) which are things that may be seen with the naked eye, such as a table in a restaurant; (10) “signal enabled” stimuli source, (not shown) such as a RFID enabled billboard or product which may be utilized for identification, or device identified with radio (or light) signal; and the like.

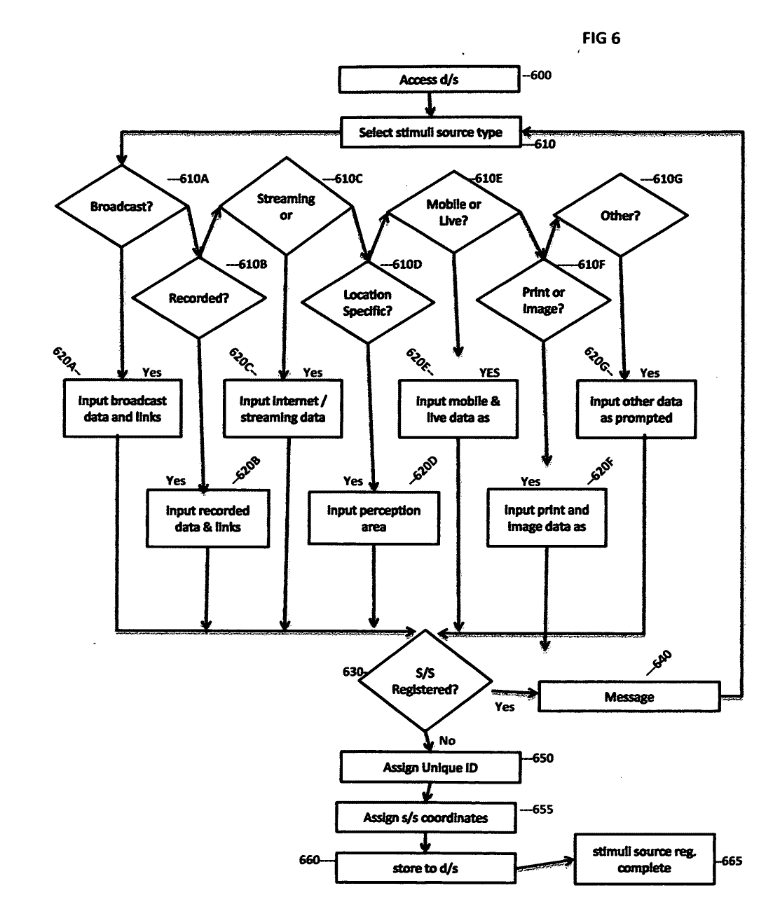

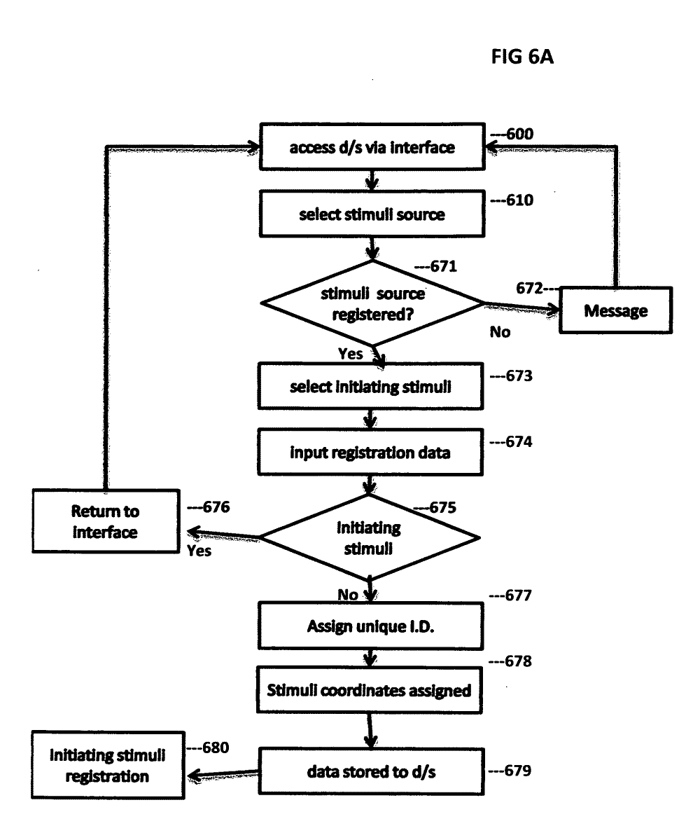

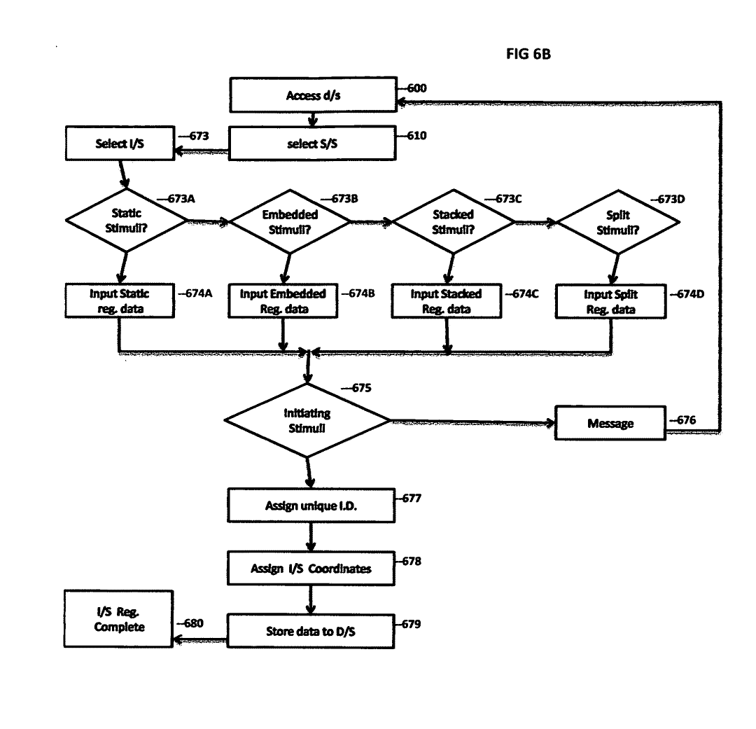

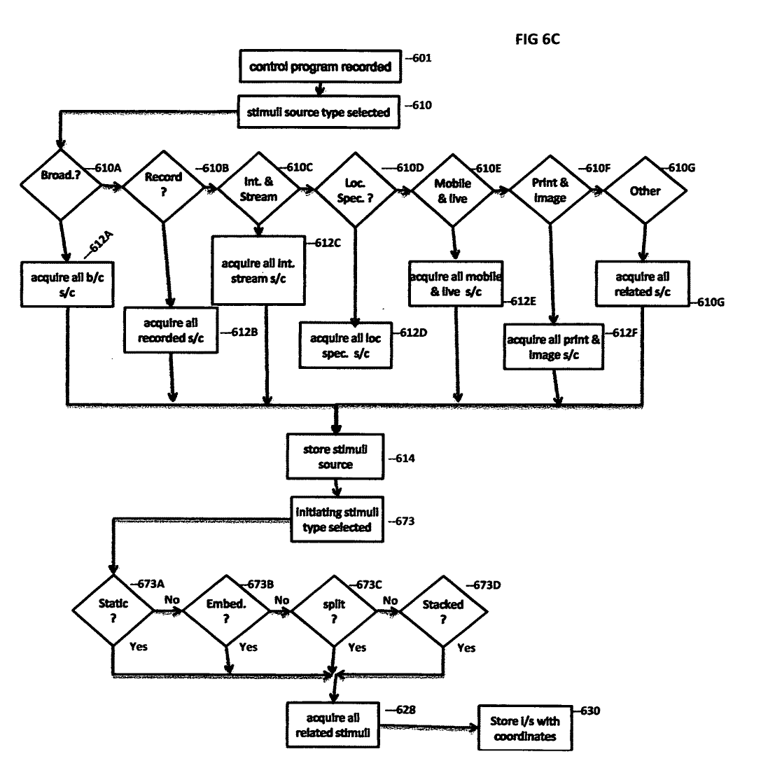

Referring to FIG. 6, the user may wish to register a broadcast station as a stimuli source. The user will first (at 600) access the data server (not shown) through the interface (not shown) and select a stimuli source type (at 610). In this example, the “Broadcast” (at 610A) is the stimuli source type. The user is prompted by an automated computer program to enter related registration information (at 620A); which may include; the station call letters, network, station name, website link address, signal decoding information, broadcast perception area, and the like. The system then (at 630) checks to determine if the channel has already been registered as a stimuli source. If the broadcast channel is already registered as a stimuli source (at 630), the user receives a message (at 640) and is returned to the user interface (at 600) where the user may begin to register initiating stimuli, or alternatively, may proceed to register other stimuli sources. However, if the channel has not been registered (at 630), then the channel will be assigned a unique stimuli source ID (650) and assigned stimuli source coordinates (at 655) by proper means; (stimuli coordinate assignment method discussed later). Finally, the stimuli source coordinates are stored correlatively with information representing the broadcast channel which may include, channel name, an unique ID, location, broadcast perception area, and the like (at 660); then the registration of the particular broadcast channel is complete (at 665). Digital content corresponding to stimuli sources may be stored in the data server or alternatively, in outside databases and accessed through the search engine as discussed above.

It is contemplated that most major broadcast stimuli sources will be pre-registered according to the present embodiment by the data server administrator; however, a user may want to add more obscure broadcast channels; such as HD radio channels, satellite radio channels, HD television, internet channels, obscure cable broadcast channels, podcast, streaming audio and video, and the like.

FIG. 6 also illustrates the registration of a plurality of non-broadcast stimuli source types with may include; “Recorded” stimuli source type (at 610 B); an “internet” and “streaming” stimuli sources (at 610 C); “mobile” and “live” (at 610 E) a “print” and “image specific” stimuli source types (at 610 F) or “other” stimuli source types (at 610 G) such as a signal enabled stimuli sources. Referring to FIG. 6, the user will first (at 600) access the data server (not shown) through the interface (not show) and select a stimuli source type (at 610). Next, based on the particular stimuli source type chosen, the user is prompted by an automated computer program to enter registration information (at 620B-620F) as appropriate. Registration information may include for example: DVD name, run time, link address, magazine title, volume number, URL address, cell number, self defined perception area, radio frequency, data links, digital images, and the like. Also a digital copy of the stimuli source itself is stored (where appropriate) to the data server or to an outside site established so that the stimuli source may be accessed through the search engine and a communication means as discussed above. The system then (at 530), checks to determine if the stimuli source has already been registered; if so, the user may begin to register initiating stimuli; or alternatively, may proceed to register other stimuli sources. However, if the stimuli source has not been registered (at 630) then a unique ID is assigned to the stimuli source (at 650) and the individual stimuli source coordinates are assigned by proper means (at 655); the database correlatively storing the stimuli source name and unique ID with the stimuli coordinates thereof (at 660). The registration of the stimuli source is complete (at 665).

If the stimuli source type chosen to register is “location specific” such as; a live concert, a store window display, a billboard, and the like, (at 610 D); the user is prompted by an automated computer program to enter registration information which also includes the perception areas of the stimuli source (at 620 D); which is acquired by proper means. Perception area is the area in which a particular stimuli may be perceived by a user and may be entered manually or through the use of a specialized software in conjunction with the user device (to be discussed later). Once the perception area and other registration information is entered, the system then (at 630) checks to determine if registered (at 630), the user receives a message (at 640) and is returned to the user interface (at 600) where the user may begin to register initiating stimuli, or alternatively, may proceed to register other stimuli sources. However, if the stimuli source has not been registered (at 630), the stimuli source is assigned a unique ID (at 650) and then at (655) the stimuli source coordinates are assigned by proper means, and are stored to the data server (at 660). The stimuli source registration is complete (at 655).

many stimuli source types are actually mixed types. For example, digital billboards and music concerts are actually mixed types in that they may have both “location specific” and “broadcast” components.

FIG. 6A is a flow chart illustrating one embodiment of the process steps involved in the initiating stimuli registration method, allowing the registration of a plurality of initiating stimuli types; and utilized in a stimuli registration system.

The registration of initiating stimuli begins by first (at 600) accessing the data server 20 (not shown) through the interface 18 (not shown) and selecting the stimuli source (at 610) from which the initiating stimuli is originating as applicable. The system then determines if the stimuli source has been registered (at 671); if not, the user is given a message to register the stimuli source (at 672) and is returned to the interface for that purpose (at 600). If the stimuli source is registered (at 671), then an initiating stimuli type is then indicated (at 673). The user is then prompted to input registration data (at 674) relevant to the initiating stimuli being registered. The system (at 675) checks to determine if the initiating stimuli has already been registered. If so, the user receives a message (at 676) and is returned to the user interface (at 600) where the user may begin to register other initiating stimuli, or alternatively, may proceed to register embedded, split, and stacked, stimuli related to registered static initiating stimuli, However, if the initiating stimuli has not been registered (at 675), then an unique ID is assigned (at 677), and initiating stimuli coordinates are assigned (at 678) by proper means. Identification and assignment of initiating stimuli coordinates may involve a combination of methods as discussed below, as well as; manual input, DDE links, recording, downloads; calculations which are controlled and implemented by the use of an automated computer program, and the like. Finally, the stimuli coordinates are stored (at 679) correlatively with information representing the initiating stimuli and stimuli source thereof. The initiating stimuli registration is complete (at 680).

FIG. 6B is a continuation of FIG. 6A, helping to clarify certain additional details of the initiating stimuli registration method relating to the registration of a plurality of initiating stimuli types including: “static” initiating stimuli (673 A), “embedded” initiating stimuli (673 B), “split” initiating stimuli (673 C), “stacked” initiating stimuli (673 D); and the like. Each initiating stimuli type may originate from each stimuli source type as discussed above.

First the registration of static stimuli will be discussed in additional detail. Registration of a particular static type initiating stimuli, (for example a broadcast movie), will begin by first (at 600) accessing the data server 20 (not shown) through the interface 18 (not shown) and selecting the corresponding stimuli source (at 610) as applicable. In this example, the user wishes to register the broadcast itself so the initiating stimuli type (at 673 A). Unlike the registration of a recorded movie, the registration of a broadcast movie includes the entire broadcast comprising all commercial breaks, hose commentary, and the like. Next, the user is prompted by an automated computer program to enter related registration information by proper means (at 674 A); such as, movie name, network, station name, website link address, signal decoding information, perception start time (PST), and the like. A digital copy of the initiating stimuli source may be accessed through the search engine and a communication means as discussed below. A copy of the digital broadcast may be obtained prior to broadcast or after the broadcast itself by recording means. The system then (at 675) checks to determine if the broadcast movie has already been registered as a initiating stimuli. If so, the user receives a message (at 674) and is returned to the user interface (at 600) where the user may begin to register embedded stimuli, split stimuli, and stacked stimuli, related to the registered static stimuli (broadcast movie). However, if the movie has not been registered (at 675), then the movie will be assigned an unique ID (at 677) and assigned stimuli coordinates (at 678) by proper means. Identification and assignment of initiating stimuli coordinates may involve a combination of methods as discussed below and may also include; manual input, DDE links, recording, downloads; uploads, calculations which are controlled and implemented by the use of an automated computer program, and the like. Finally, the stimuli coordinates are stored (at 679) correlatively with information representing the broadcast and the stimuli source thereof. Stored stimuli coordinates may include, movie name, perception start time (PST), perception end time (PET), an unique ID, location, digital image, digital copy, digital markers, and the like. Finally the registration of the particular broadcast movie is complete at (680). Digital content (and copies) corresponding to the registered broadcast may be stored at the data server, or alternatively, in outside databases and accessed through the search engine and proper communication means as discussed above.

The registration of a static initiating stimuli is not confined to broadcast type stimuli sources only, but may originate from a plurality of stimuli source types; some of which will be now discussed. If the user wishes to registered static initiating stimuli originating from a particular non-broadcast stimuli source, the registration of the static initiating stimuli begins by first (at 600) accessing the data server 20 (not shown) though the interface 18 (not shown) and selecting the stimuli source (at 610) corresponding to the initiating stimuli from which it originated, as applicable For example: a recorded stimuli source type may be indicated in which: a DVD corresponds to a movie, a CD corresponds to recorded music, and a MP3 corresponds to a song. Alternatively an “internet” stimuli source may be indicated, in which a streaming video corresponds to a YouTube video, and so forth. Once the stimuli source type (at 610) and initiating stimuli type (at 673) are chosen, then the user is prompted by an automated computer program to enter registration information (at 674 A) related to the particular static initiating stimuli chosen; such as, a movie title, song title, run time, digital time, and the like. A digital copy of the initiating stimuli itself is stored to the data server or to an outside site established so the initiating stimuli may be accessed through the search engine and a communication means as discussed above. If the initiating stimuli has not yet been registered (at 675); then a unique ID is assigned to the initiating stimuli (at 677) and the individual initiating stimuli coordinates are assigned by proper means (at 678); the database correlatively storing the information representing the stimuli coordinates with information representing the initiating stimuli and stimuli source thereof (at 679). The registration of the initiating stimuli is complete (at 680).

FIG. 6B illustrates the registration of non-static initiating stimuli types including: embedded, stacked, and split, initiating stimuli types. After selecting the stimuli source (at 610) and static initiating stimuli (at 673), the user is prompted based on the particular initiating stimuli type (673 B-D), by an automated computer program to enter related registration information (at 674 B-D) such as; stimuli name, digital image, volume number, cell phone number, pixel location, menu label, and the like. If not already registered (at 675), then each initiating stimuli is assigned a unique ID (at 677) and assigned stimuli coordinates by proper means appropriate initiating stimuli type, particular initiating stimuli coordinates are stored correlatively with information representing the particular initiating stimuli, stimuli source, and related initiating stimuli, thereof (at 679). The registration of the embedded, split, and stacked initiating stimuli is complete (at 680).

Next, the process steps involved in the registration of an embedded initiating stimuli will be discussed in detail. For this example, the static initiating stimuli is a movie titled “Pretty Woman,” and the embedded initiating stimuli is a silk dress worn by an actress during a particular scene.

Referring to FIG. 6B, the user desiring to register the dress as an embedded initiating stimuli will first (at 600) accesses the data server through the interface 18 (not shown); and then select the desired stimuli source (at 610); and the corresponding static initiating stimuli (at 673) by proper means. Proper means may include an automated computer program stored on the user device 4 (not shown) or another device such as a computer or laptop. The user then indicates the desire to register an embedded stimuli (at 673 B) and the user is prompted by an automated computer program to enter related registration information (at 674 B). This information may include; name, category, description, pixel locations, digital markers, perception start times, perception end times, digital image, and the like. Then (at 675) the system determines if the dress is already registered as an embedded initiating stimuli, if so, the user is given a message (at 676) and returned to the user interface (at 600). If the dress has not registered (at 675), then a unique I.D. (at 677), and embedded initiating stimuli coordinates (at 678), are assigned to the dress by proper means. Stimuli coordinates may including; pixel location corresponding to the image of the dress, digital markers, a digital image, a frame number, and the like. The initiating stimuli coordinates are then stored correlatively with information representing the dress, the movie, and the stimuli source (at 679). The dress registration as an embedded initiating stimuli is complete (at 680).

FIG. 6B also illustrates the registration of “split” initiating stimuli (at 673 C) based on related initiating stimuli such as: 1) film clips corresponding to the static move; 2) silk fabric from which the dress was made, corresponding to the embedded dress; and the like. Once registration is complete, the information representing split stimuli coordinates are stored (at 679) correlatively with information representing the split stimuli, stimuli source, an related initiating stimuli, thereof.

Further, the user may also register “stacked” stimuli (at 673 D) based on the related initiating stimuli such as: 1) a film series like “Pretty Woman 2,” based on the static movie; 2) a matching jacket, based on the embedded silk dress; 3) a pair of silk pants based on the split type of initiating stimuli silk fabric; and the like. Once registration is complete, the information representing stacked stimuli coordinates are stored (at 679) correlatively with information representing the stacked stimuli, stimuli source, and related initiating stimuli, thereof.

FIG. 6C is a flowchart outlining one embodiment of the general steps of the stimuli coordinate assignment method and system according to the present invention comprising; 1) a recording medium is provided (at 601) to record a control program which assist in the following steps; 2) the stimuli sources type selected at (610), is identified (at 610 A-G); 3) all corresponding stimuli source coordinates are acquired by proper means (at 612 A-G); 4) information representing stimuli source coordinates is stored correlatively with information representing the stimuli source thereof (at 614); 5) the initiating stimuli type selected (at 673), is identified (at 673 A-D); 6) all corresponding initiating stimuli coordinates are acquired by proper means (at 628); and 7) information representing initiating stimuli coordinates are stored correlatively with information representing the initiating stimuli, thereof (at 630).

Next the stimuli coordinate assignment method and system will be discussed in more detail, more specifically as it relates to the assignment of stimuli coordinates to stimuli sources.

Referring to FIG. 6C, whereas the stimuli source type is “Broadcast” at (610A), then all available broadcast stimuli coordinates are acquired (at 612A). The stimuli coordinates which are acquired may include; stimuli source name, title, a unique I.D., a perception time, location, broadcast perception area, a frame address, a broadcast channel, a RAV (Request Adjustment Variable), URL link address, and the like. The actual stimuli coordinates acquired and then stored (at 614) depends on the particular stimuli source, user device capacity, information source availability, as well as other factors.

When the stimuli source type is “Recorded” (at 610 B), the stimuli coordinates which are acquired (at 612 B) may include but not limited to; a stimuli source name, title, and unique source I.D., copy of the stimuli, digital flags run time, stimuli streaming copy, and the like. The actual stimuli coordinates acquired and then stored (at 614) depends on the particular stimuli source, user device capacity, information source availability, as well as other factors.

When the stimuli source type is “Internet” or “Steaming” (at 610 C). Then stimuli coordinates acquired at (612 C) may include; stimuli source I.D. a stimuli source name, source title, copy of the stimuli source, digital flags, run time, streaming copy, run time, pixel location, digital flags, URL address, DDE links, object location, and the like. The actual stimuli coordinates acquired and then stored (at 614) depends on the particular stimuli source, user device capacity, information source availability, as well as other factors.

When the stimuli source type is “location specific” (at 610 D). The stimuli coordinate acquired (at 612 D) may include; perception area, relative location, unique I.D., unique source I.D., source name, and the like. The actual stimuli coordinates acquired and then stored (at 614) depends on the particular stimuli source, user device capacity, information source availability, as well as other factors.

When the stimuli source type is “live” or “mobile” (at 610E), the stimuli coordinates acquired (at 612 E) may include; perception area, relative position, RFID (radio frequency identification), signal signature, unique I.D., unique source I.D., source title, cell phone number, device I.D. and the like. The actual stimuli coordinates acquired and then stored (at 614) depends on the particular stimuli source, user device capacity, information source availability, as well as other factors.

When the stimuli source type is “Print” or “image specific” (at 610 F), the stimuli coordinates acquired (at 612 F) may include but not limited to: a digital image of the stimuli source, an unique source I.D., a source title, a publication date, and the like. The actual stimuli coordinates acquired and then stored (at 614) depends on the particular stimuli source, user device capacity, information source availability, as well as other factors.

The stimuli source type may also include “other” stimuli types (at 610 C), such as “signal enabled” source and the like. The stimuli coordinates acquired (at 612 G) would correspond to the particular stimuli source and may include; perception area, relative position, RFID (radio frequency identification signal), signal signature, unique I.D., unique source I.D., source title, cell phone number, device I.D., device signal, and the like. The actual stimuli source, user device capacity, information source availability, as well as other factors.

The identification and assignment of the stimuli source coordinates (612 A-G) as discussed above, may involve a combination of methods as well as; manual input, DDE links, downloads, uploads, calculations, recordings, user query, menu selection, automated methods which are controlled and implemented by the use of an automated computer programs, and the like. It is understood that the above discussed list of stimuli coordinates is not exhaustive or exclusive to a particular stimuli source or stimuli source type.

Next, the assignment of stimuli coordinates to initiating stimuli will be discussed in detail.

Referring to FIG. 6C and beginning (at 673), initiating stimuli are assigned stimuli coordinates based on the initiating stimuli type indicated; which may include at least; static, embedded, split, and staked, initiating stimuli coordinates are stored correlatively with information representing the initiating stimuli types (at 673 A-D).

Whereas when the initiating stimuli is “static” (at 673 A) then all available static stimuli coordinates are acquired (at 628) corresponding to the appropriate initiating stimuli type; and the initiating stimuli coordinates are stored correlatively with information representing the initiating stimuli thereof (at 630).

If the initiating stimuli is “embedded” (at 673 B), then all initiating stimuli coordinates will be acquired corresponding to the appropriate stimuli type. Stimuli type (at 628) and the initiating stimuli coordinates are stored correlatively with information representing the initiating stimuli thereof (at 630).

If the initiating stimuli is “split” (at 673 C) then all initiating stimuli coordinates will be acquired corresponding to the appropriate stimuli type. Stimuli type (at 628) and the initiating stimuli coordinates are stored correlatively with information representing the initiating stimuli thereof (at 630).

If the initiating stimuli is “stacked” (at 673 D) then all initiating stimuli coordinates will be acquired corresponding to the appropriate stimuli type (at 628) and the initiating stimuli coordinates are stored correlatively with information representing the initiating stimuli thereof (at 630).

It is understood that the list of initiating stimuli coordinates discussed above is not exhaustive or exclusive to a particular initiating stimuli or initiating stimuli type. The stimuli coordinates may be acquired by a combination of methods as well as; data links, downloads, uploads, and manual input, user query, menu selection, calculation, recording, and automated methods which are controlled and implemented by the use of an automated computer programs, and the like.

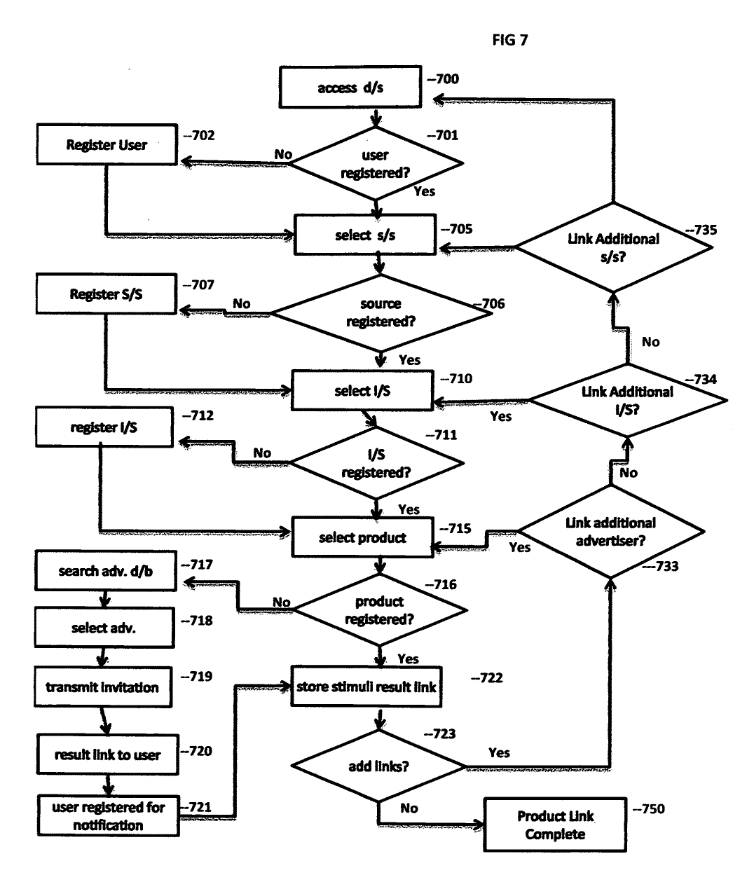

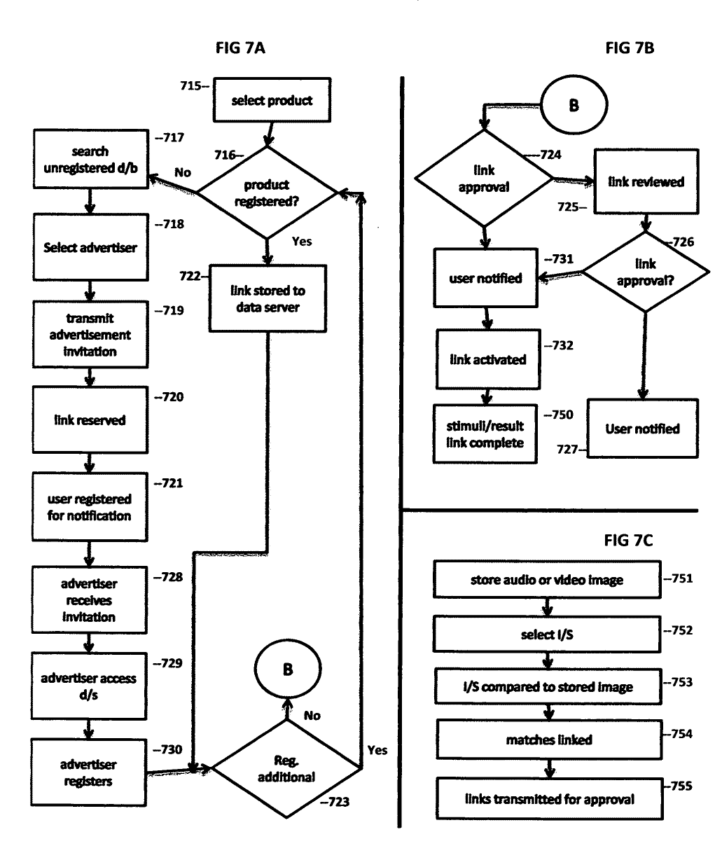

FIG. 7 is a flowchart outlining the process steps involved in the stimuli/result linking method; in which an initiating stimuli is linked with search results, in a manner which allows the search results to be identified; according to the first embodiment of the present invention.

For this example, the stimuli source is a DVD, the initiating stimuli is a movie, and a truck driven by an actor in particular scene of the movie is an embedded initiating stimuli. The user for this example may be a link facilitator (facilitator); a person whom may utilize a plurality of existing initiating stimuli such as; movies, television shows, window displays; and the like, to link advertisements and products to the existing stimuli. Alternatively, the user of the stimuli/result linking method could also be a content producer (producer) who is creating new content ranging form a major motion picture, to a YouTube video, or window display and wishes to include multi-dimensional product placement.

Referring to FIG. 7, the user desiring to link an advertisement to the image of the truck would first access the data server though the interface 18 (not shown), if the user is a registered facilitator/producer (at 700). If the user is not registered (at 701), then user proceeds to register a facilitator or producer (at 702) and is assigned a unique I.D. (at 703) which is stored (at 704) to the data server (D/S). If the system recognizes the user I.D. (at 701) as a registered user, then the facilitator/producer may proceed to select a stimuli source (a DVD movie) (at 705). The system confirms the DVD is registered (at 706). If not registered, the facilitator must register the DVD movie as the stimuli source (at 707). (Stimuli source registration method discussed at FIG. 6).

Once the DVD movie is selected, the facilitator may proceed (at 710) to select the image of a Ford truck as an embedded initiating stimuli. If the truck image is not already registered as an initiating stimuli (at 711), the facilitator registers the truck image (at 712). (Initiating stimuli registration method discussed in FIGS. 6A and 6B).

If the truck image is registered (at 712) as an initiating stimuli, the facilitator may select an advertiser to link to the image of the Ford truck by searching the D/S for the desired product or advertiser (at 715). Once the desired product is selected (at 715), then the selected product is linked to the selected initiating stimuli (at 722); the information representing the initiating stimuli is stored correlatively with information representing the selected search results.

If the desired product or advertiser is not registered (at 716), the user may search the data server for unregistered products and advertisers who may benefit from the stimuli/result (at 717); and select an advertiser who may benefit from the stimuli/result link (at 718). An invitation to link their product to the image of the truck (initiating stimuli) is transmitted to the advertiser (at 719) by proper means and the proposed link is then reserved for the user (at 720). By linking unregistered products and initiating stimuli, the facilitator will remain in control of the link and benefit when the advertiser authorizes the link activation. (advertiser invitation and link activation methods discussed below). Once the link is reserved (at 720), the facilitator is automatically registered (at 721) to receive notification by proper means when the link is authorized by the advertiser and activated by the system. The stimuli/request link is then stored (at 722) to the data server.

Finally, if the registration is not complete (at 723), then the facilitator is given an option to link additional advertisers from both registered and unregistered advertisers (at 733). The facilitator would proceed, for example, to choose to link the initiating stimuli (the Ford truck) with; advertiser Ford Motor Company (at 715), a custom wheel shop, Ford dealerships based on geographic location, and even alternative manufacturers of similar trucks such as Chevrolet. As discussed above in the result registration method, a plurality of results, an results types, may be utilized.

Alternatively, the facilitator could proceed to (734) where they were given the option to choose a different initiating stimuli from the same movie (static initiating stimuli): an finally (at 735) the facilitator is given an option to select a different initiating stimuli such as a new movie, television show, YouTube Video and the like. If the facilitator does not want to add additional advertisers or links (at 723), then the stimuli/result linking process is complete (at 750).

FIG. 7A is a flowchart setting out certain additional detail process steps disclosed in FIG. 7, including an advertiser invitation method.

Beginning (at 715) the user selects a product and if that product is already registered (at 716) the link is stored (at 722). However, (at 723) the user is given the option to register additional results comprising of, advertisers, products, information, and the like. If the user chooses to link unregistered advertisers to a particular stimuli, then they can search the D/B for unregistered advertisers, (or add advertisers to the data base) (at 717), and select an advertiser (at 718). Then (at 719) the advertiser is sent a request to register their product and a sample of the proposed stimuli/result link. This link is then reserved for the user (at 720) in that no other user may link that particular product to that particular initiating stimuli. The user is then automatically registered to receive notification when the product/advertisers are registered (at 721). Next, the advertiser receives the request to register their product (at 728) and may access the D/S via the advertiser interface (at 729), and register their products (at 730) (as discussed above in result registration method).

FIG. 7B is a continuation of FIG. 7, illustrating an advertiser link approval method, according to the present invention.

The advertiser is then given an opportunity to approve the advertising/product link (at 725). This review allows advertisers to insure that the stimuli to which their product is attached to both appropriate and relevant. It is also contemplated that the D/B administrator may also exercise link pre-approval (at 724) to maintain appropriate and relevant search results. If link approval is not required (at 724), then the user is notified (at 731) of the successful link. The link is activated (at 732), and the product link is complete (at 750). However, if approval is required (at 724), then the stimuli/result link is reviewed by the advertiser (and/or the D/B administrator) (at 725). If the link is not approved (at 726) then the user is notified of the approval (at 731), and the stimuli/result link is activated at 732. The product link is complete (at 750).

FIG. 7C is a flow chart illustrating one embodiment of the process steps involved in the automated linking registration method. It is also contemplated that the linking of initiating stimuli and results, such as advertisers products, may be accomplished by an automatic computer program that utilizes the desired parameters and image recognition technology to automate the process; comprising the steps of 1) store result image or sound byte (at 751); 2) designate initiating stimuli (at 752) by proper means; 3) compare stored result image to initiating stimuli by automated computer program (at 753) 4) link matches (at 754) and 5) transmit stimuli/result link information for approval by proper means (at 755). The designated initiating stimuli to which results are compared may take many forms including; a digital image, an audio file, word configurations an phrases, pixel configurations, similar image comparison, search patterns, search parameters, and the like.

According to the present invention and as discussed above (at FIG. 6-FIG. 7 C) a plurality of; stimuli sources, initiating stimuli, stimuli coordinates, and search results, may be registered; whereas, the plurality of stimuli types is then stored correlatively with the corresponding stimuli coordinates, and search results thereof; in a manner in which they may be identified. The stimuli source is usually the source of the initiating stimuli. For example, a DVD (the stimuli source) contains a movie (static initiating stimuli) with a scene in which a truck (embedded stimuli) is seen by viewers of the movie. The truck initiates a request by the user, so the truck is therefore an embedded initiating stimuli. It is understood however, that a single stimuli source, such as a DVD movie, may contain a plurality of initiating stimuli types including static, embedded, split, and stacked, initiating stimuli types; as discussed above (also discussed in related patent applications).

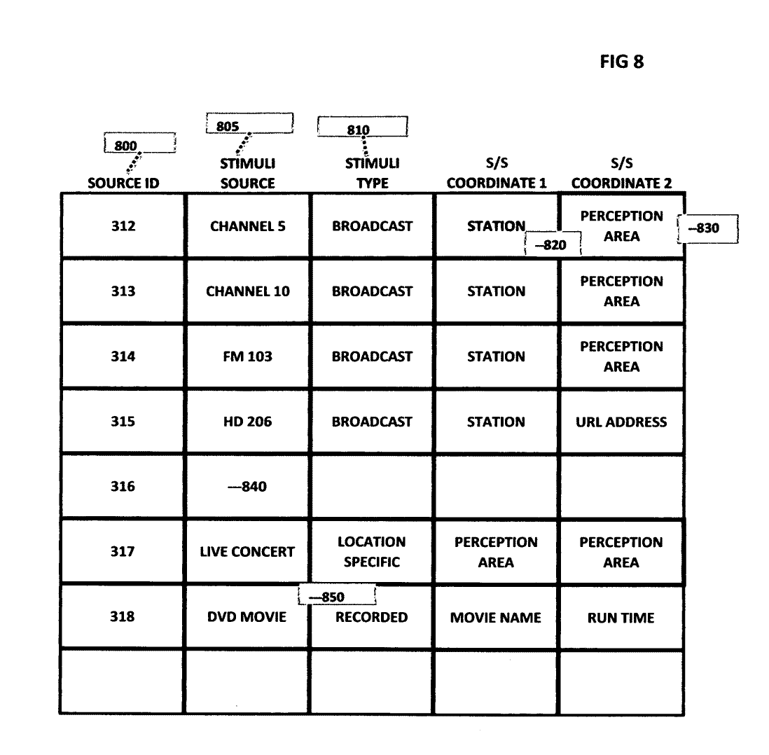

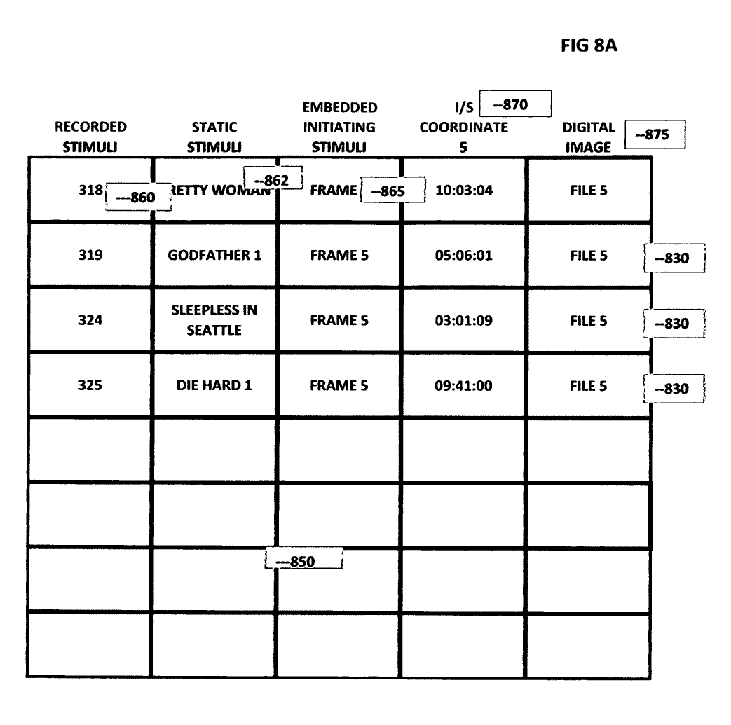

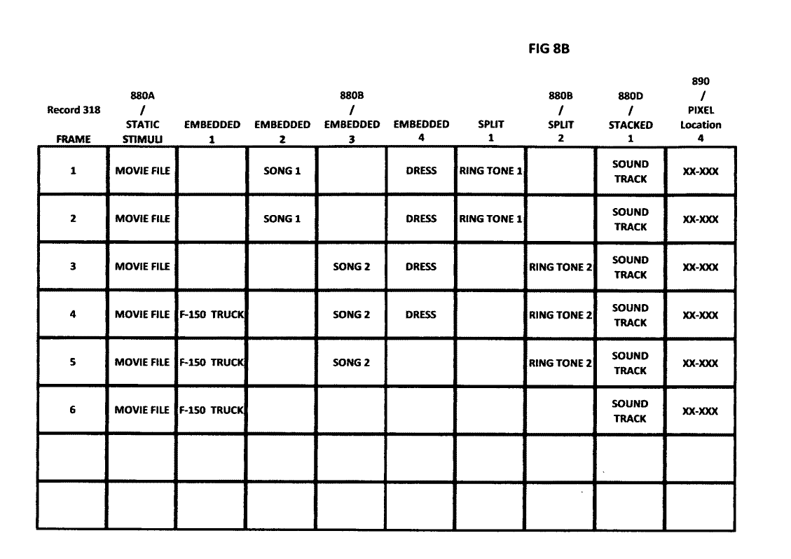

FIG. 8 is an illustration of a database table storing broadcast stimuli correlatively with the stimuli coordinates thereof; to help to clarify the storing of multi-dimensional stimuli. In the example, a stimuli source ID, is shown (at 800), source name (805), and the stimuli source type is identified as “Broadcast” (at 810). The record also includes, among other things, a plurality of stimuli coordinates such as; the broadcasting station (at 820), and a broadcast perception area (at 830). Alternatively, the stimuli source may a live concert (at 840), a DVD (at 850), and the like.

FIG. 8A, a continuation of FIG. 8, illustrates the storing of initiating stimuli with stimuli coordinates thereof. For example; the individual initiating stimuli ID 318 is store (at 860), static stimuli name is stored (at 862), and embedded stimuli such as an individual movie frames are stored (at 865), correlatively with a plurality of stimuli coordinates such as; the synchronized perception start time (SPST) (at 870), and a digital image (at 875). The movie frames, in this example, may be stored corresponding to every frame, or to larger intervals; such as four second intervals, or several minute intervals. Continuous frames may be grouped together and referred to as scenes. A plurality of corresponding search results may be stored correlatively with each frame; as discussed below at 8B.

FIG. 8 B, a continuation of FIGS. 8 and 8A. Further clarifies the storing of multi-dimensional initiating stimuli in a manner in which they may be identified. In this example, a plurality of initiating stimuli are stored correlatively with movie frames embedded in recorded movie 318 including; static stimuli comprising the movie itself (at 880 A), embedded stimuli, such as; the song playing in the background; a dress worn by an actress, a truck driven in the scene (at 880 B); split stimuli such as the ring tone on that song (at 880 C; and stacked stimuli such as the movie soundtrack based on the song (at 880 D) Also, embedded initiating stimuli, such as the dress (at 880 B) may be more exactly located by utilizing the stimuli coordinate such as; pixel location (at 890), and the like.

Initiating stimuli may be stored correlatively with a plurality of the stimuli coordinates, and a plurality of search results (not shown) thereof.

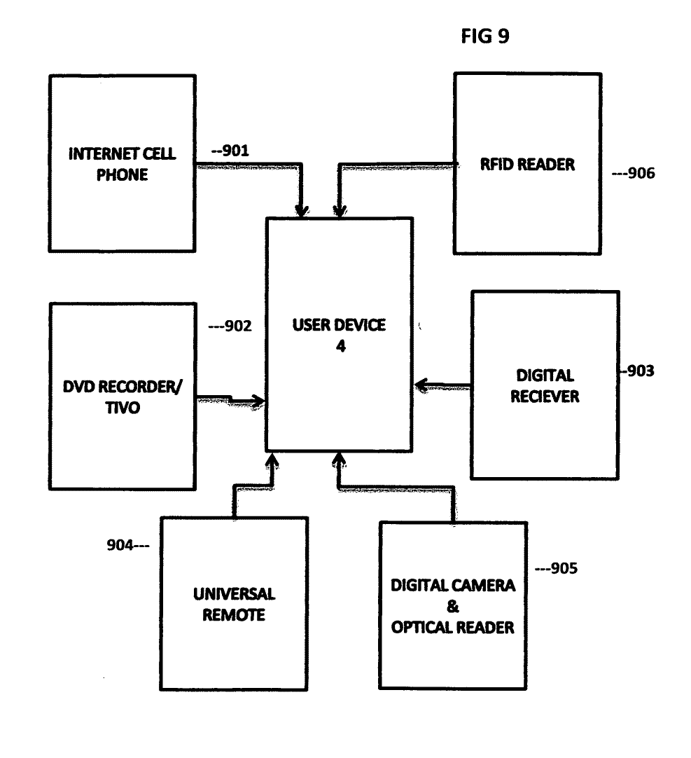

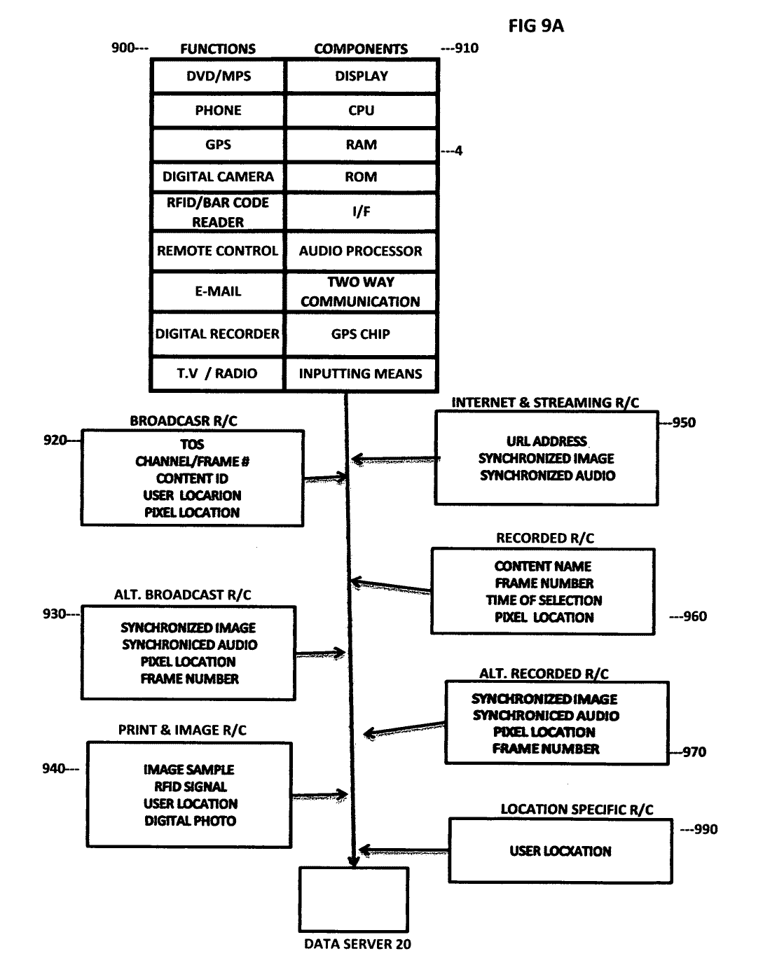

FIG. 9 is a drawing illustrating one embodiment of the construction of a user device 4 according to the first embodiment for the present invention. As discussed above, the diversity and efficiency of the present invention varies depending on the capabilities of the user device 4 onto which a user loads the control program. The program may be loaded and effective on a plurality of devices including; cell phones, computers, PDA's, universal remote controls with CPU and storage capacity, T.V. top boxes, and similar devices. However, a device with more functions will increase the efficiency of the present invention; while allowing it to identify the maximum number and stimuli types with a minimum of manual input.

Referring to FIG. 9, one embodiment of a combination user device 4 is shown which would maximize the effectiveness and efficiency of the current invention. First, a cellular phone is illustrated (at 901), such as the Apple I-Phone, the Version music phone, or similar devices. The phone comprises the functions of; communication through cellular networks, internet, and Bluetooth, communication for the sending of requests and the reception of request results. Also comprising GPS capability for determining the location of the user.

A DVD/TiVo recording means is illustrated 902 with the capacity to record and replay both audio and video while being directed by a control program.

A digital receiver/decoder 903 is illustrated with the capacity to receive and display; FM radio, broadcast television, satellite television, satellite radio, podcast, streaming audio and video, HD radio, and similar media.

A universal remote 904 is illustrated with the capacity of controlling all internal audio and video equipment, of the user as well as the user device 4,; whereas the control program captures all channel information to be utilized as request coordinates (discussed later). The remote control component and channel selection information may also be used by a control program to synchronize the digital receiver/decoder and digital recorder for the capture of additional stimuli and request coordinates; such as audio and video copies of initiating stimuli.

A digital camera/optical input device 905 is illustrating which may be utilized for capturing images of stimuli sources, initiating stimuli, stimuli coordinates, and request coordinates. Also a bar code reader to assist in the registration of stimuli.

A RFID/signal reader 906 to identify signals from RFID chips, and other signal types, being utilized as stimuli coordinates, and to facilitate the storage of information representing stimuli and stimuli coordinates.

According to the present invention, the features, functions, and components, of the above discussed devices (901-906) are combined into one user device 4; which would maximize the effectiveness and efficiency of the current invention.

FIG. 9A, a continuation of FIG. 9, is a schematic drawing of one embodiment of a combination user device 4. The user device 4 is designed to maximize the functionality of the present invention by consolidating and simplifying the source of a maximum number of request coordinates, which are then in turn utilized to identify the maximum number of stimuli source types and initiating stimuli types.

The user device 4 comprises the functionality of several known devices into one. First the functions (at 900) and components (at 910) of the device include: and internet enabled cell phone; able to communicate via cell signal and internet, able to play MP3, recorded video, television, streaming video, FM radio, HD radio, satellite broadcast; as well as the ability to download files wirelessly and to store control programs and other computer programs, similar to an Apple I phone or Verizon music phone.

The second set of functions are similar to Logitec Harmony 1000 universal remote, which includes functions for controlling media components such as TV, stereo, VCR, VDR, TiVo, radio tuner, HD tuner, satellite tuner, the user device 4, and the like. The communications means between the user device 4 and external media components may include: radio control capacity and two way communication, internet, infrared, Bluetooth, radio frequency, FM radio station frequency, proprietary peer to peer communication, and the like Other functions included in the user device 4 are; a RFID reader, a digital camera/optical reader, GPS location capability, and digital recorder.

Referring to FIG. 9A, by combining the above functions and components into one user device 4, the user is able to capture and include the most diverse set of request coordinates. For example, broadcast request coordinates (at 920), alternative request coordinates (at 930), printed and image specific coordinates (at 940), internet and streaming video request coordinates (at 950), recorded request coordinates (at 960), alternative recorded request coordinates (at 970), location specific request coordinates (at 990), and the like.

These request coordinates are not exhaustive or mutually exclusive but can vary depending of the capability of the user device 4. This may be a combination device as described in FIGS. 9 and 9A; but alternatively, could be a plurality of devices able to store and execute the control program such as a universal remote, a PDA, cell phone, lap top computer, desk top computer, TV top box, MP3 player, television, radio, and the like.

FIG. 10 is a flowchart illustrating generally the process steps involved in a search method according to this embodiment of the present invention, in which initiating stimuli is identified.

First, a request is initiated based on a response to an initiating stimuli (at 1010); such as an object in a move scene, or the relative position of a person. This request may be initiated by a user or by an automatic process triggered by a control program and a set of pre-specified parameters. Next the request coordinates are identified (at 1030) by proper means (request coordinate identification method discussed below); and transmitted by proper communication means to the data server (at 1040). The data server is then searched (at 1050) by utilizing the request coordinates as search conditions, to identify the initiating stimuli (at 1060); information representing the initiating stimuli stored correlatively with the stimuli coordinates thereof; (as discussed in the stimuli registration methods above). The data server may be an external unit connected to the data server by proper communication means; or alternatively, and internal unit located inside the user device 4.

FIG. 10 A is continuation of FIG. 10, illustrating the general process steps involved in one embodiment of a request coordinate identification method and system comprising the steps; 1) the stimuli source type is identified by proper means (at 1012); 2) the initiating stimuli type is identified (at 1014) by proper means; 3) the request type is identified by proper means (at 1016); 4) user device capabilities are identified by proper means (at 1018) 5) all relevant request coordinates are acquired by proper means (at 1020); and 6) the request coordinates are stored with additional request information thereof. The additional information stored with the request coordinates may include; user I.D., additional search parameters, search filters, and the like.

FIG. 10B is continuation of FIG. 10, illustrating the process steps involved in a information distribution method, comprising the steps; 1) utilize identified initiating stimuli as a search condition to search data server (at 1070); the data server storing a plurality of initiating stimuli correlatively with the related search results thereof; such as, advertisements, information, digital files, product photo's, website links, retail locations, product information, search phrases, and the like. 2) information representing search results is output (at 1080); 3) transmit information representing search results to the user device to other location as designated by the user (at 1090). The data server may be an external unit connected to the data server by proper communication means; or alternatively, and internal unit located inside the user device 4.

FIG. 10C is a flowchart illustrating a search string translation method and system which utilize the search method and distribution methods above; and which allows traditional search engines, such as Google and Yahoo, to be utilized without the need for a user to input or know a keyword or search phrase.

Referring to 10C, once the initiating stimuli is identified (at 1060) the system determines (at 1061) if the user has requested the use of a traditional search engine, such as Google for example. If so, the system utilizes the identified initiating stimuli as a search condition to query the data server; and the associated search keywords and phases are output as search results (at 1062); search keyword and phrases are stored correlatively with the information representing initiating stimuli. Next, the search keyword or phase is utilized as a search condition with the traditional search engines (such as Google) and results output (at 1063). These results may be returned to the user (at 1090). Alternatively, if additional search filters and parameters were transmitted with the user request (at 1064), the search is conducted with the additional parameters (at 1065) and then filtered (at 1066) to achieve the results returned to the user (at 1090).

As discussed in the result registration method above; the search strings, keywords, and phrases, stored in the data server correlatively with initiating stimuli; may be input by the data server administrator to ensure the most accurate and relevant search results; or alternatively, by the advertisers as a form of paid search to ensure their own favorable placement in the search results.

FIG. 10D is a flowchart illustrating the general process steps involved in a search result priority method and system; which utilizes the search method and distribution method above, and allows a user to prioritize search results based on a plurality of dynamic factors such as; user location, relative position, relative position of other people or things, gender, price, time of day, combined weighted scores of user defined factors, and the like.

Referring to 10D, the request coordinates are identified and stored (at 1022). The user (or user device 4) may include in the request additional search parameters in order to provide the most relevant results. For example, the user location may be included with the request (at 1024), and the system may use the location as an additional search parameter (at 1026), and as a filter to prioritize the search results by distance to the user. Other additional search parameters may be include (at 1028). These may include; relative location, social profile, traffic patterns, season, time of day, and the like. The system may then (at 1029) apply these additional parameters to the search or to filter the results prior to providing the results to the user (at 1090). These dynamic search parameters may be outlined generally by the user, but may vary depending on changing conditions such as; time of day, season of the year, location of user, relative position of user, relative position of other peoples, relative position of multiply items or request, type of request, user defined parameters, and the like.

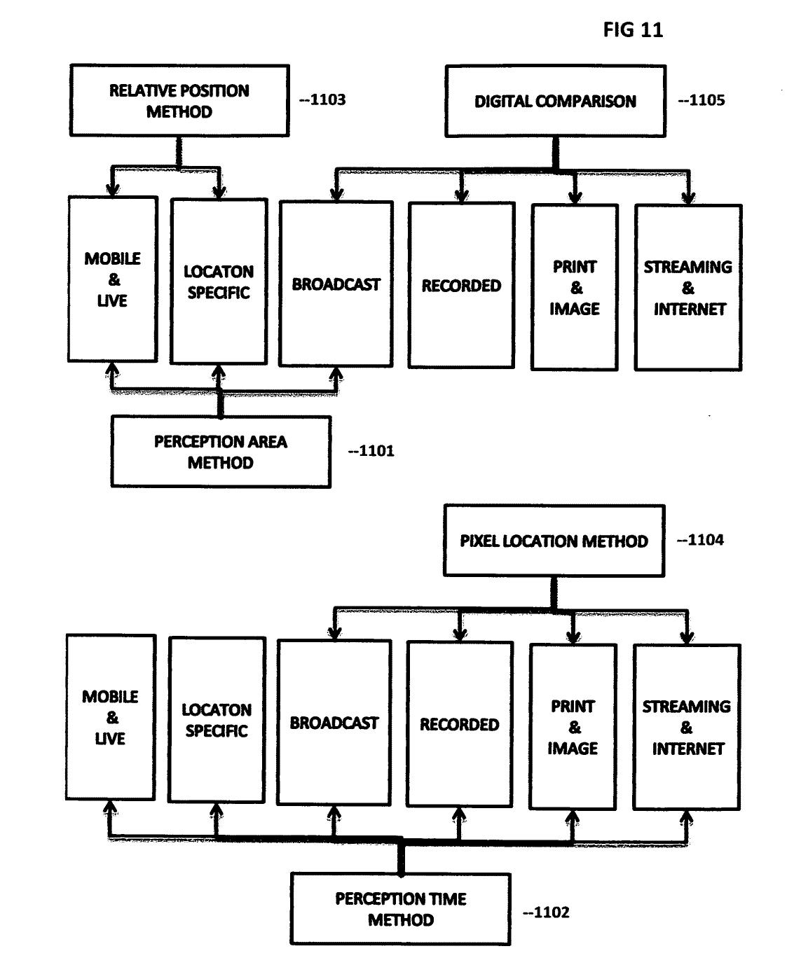

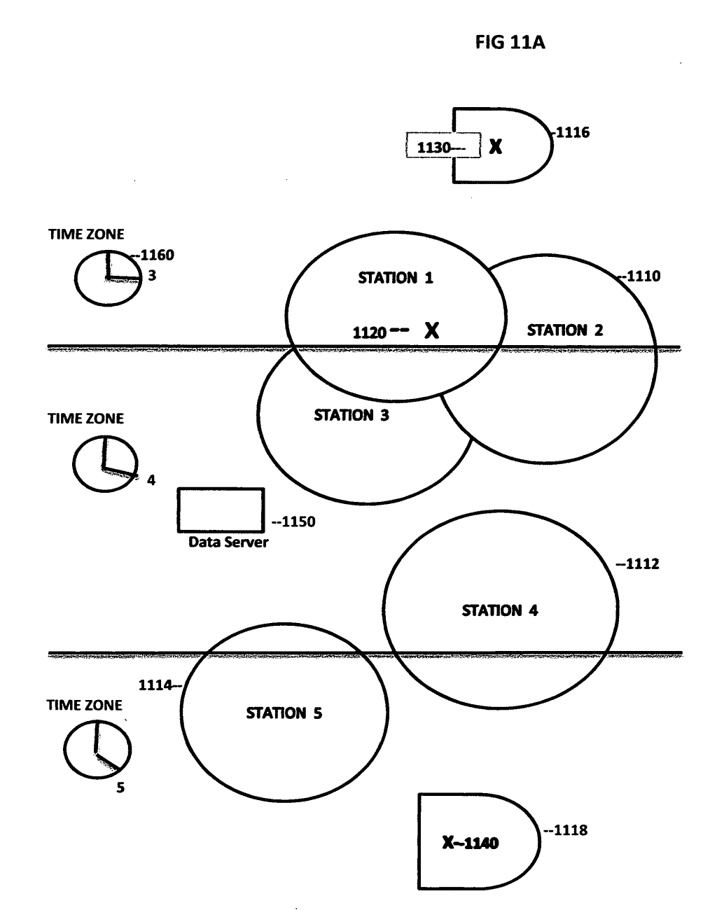

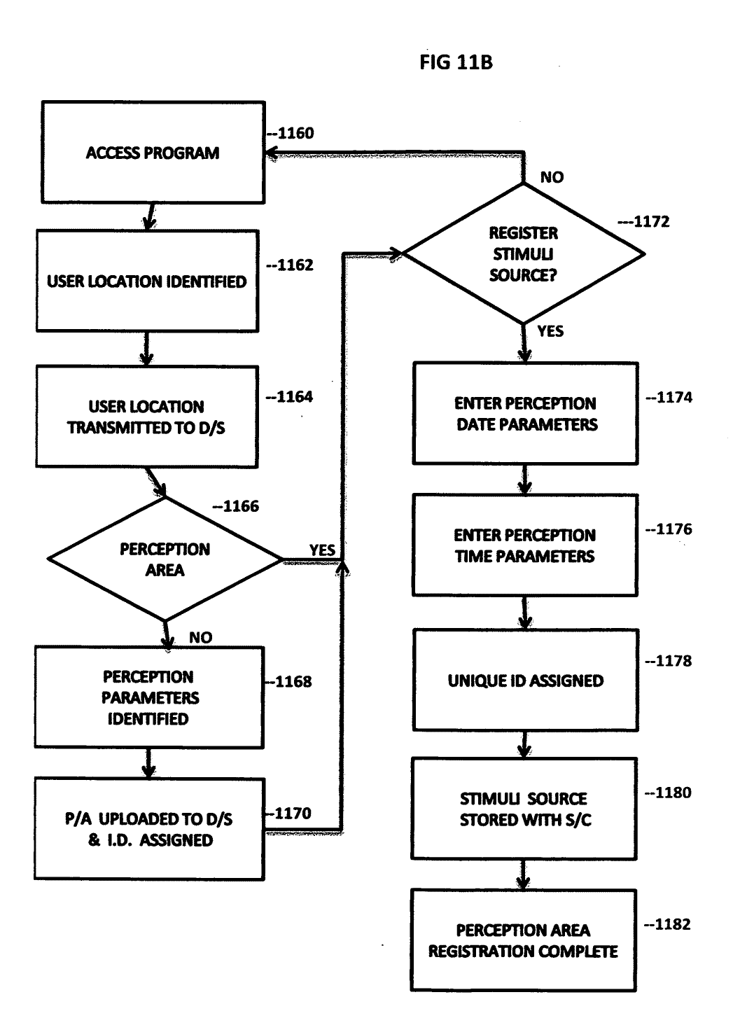

FIG. 11 is a schematic illustrating certain details of a searching system that comprises; a perception area search method (at 1101), a perception time search method (at 1102), a relative position search method (at 1103), a pixel location search method (at 1104), and a digital comparison search method (at 1105).

Further, according to the present invention there is provided a perception area search component (at 1101) which utilizes the search method above comprising the steps; 1) stimuli is stored correlatively with the perception area (PA) thereof, 2) user request contains at least user location, 3) user location is transmitted to the data server by proper means, 4) user location is utilized as a search condition to identify the corresponding perception area stored at (1) above; thus identifying the initiating stimuli or stimuli source.

Further according to the present invention there is provided a perception time search component (at 1102) which utilizes the search method above comprising the steps; 1) stimuli is stored correlatively with the perception time (PT) thereof, 2) user request, contains at least the adjusted time of selection (ATOS), 3) ATOS is utilized as a search condition to identify the corresponding (PT) stored at (1) above; and thus identifying the corresponding initiating stimuli or stimuli source.

Further, according to the present invention there is provided a relative position search component (at 1103) which utilize the search method above comprising the steps; 1) stimuli is stored correlatively with the real time current location thereof, 2) user request contain at least a user's real time current perception area, 3) the user current perception area is utilized as a search condition to identify the corresponding stimuli location stored at (1) above; and thus identifying the corresponding initiating stimuli or stimuli source. The user real time current perception area is a user defined distance that encircles a mobile user and is often used to trigger a pre-determined automate request. Both stimuli location and user location are updated in such a manner as to keep them current; alternatively the stimuli location may be stationary.

Further, according to the present invention there is provided a pixel location search component (at 1104) which utilizes the search method above comprising the steps; 1) stimuli is stored correlatively with the pixel location or configuration thereof, 2) user request contains at least a single pixel location, 3) pixel location is utilized as a search condition to identify the corresponding pixel location stored at 1) above; thus identifying the corresponding initiating stimuli or stimuli source.

Still further, there is provided a digital comparison search method (at 1105) that is utilized to identify stimuli sources and initiating stimuli comprising; 1) provide a record medium for recording a control program that causes the initiating stimuli or stimuli source to be identified comprising the steps; 2) store a digital copy of the initiating stimuli or stimuli source correlatively with information representing at least a unique identification corresponding to the initiating stimuli or stimuli source thereof; 3) user request includes at least a digital copy of initiating stimuli or stimuli source, 4) user request is transmitted to data server by proper means, 5) recognition software utilizes digital copy as a search condition to identify the corresponding digital copy stored at (2) above; thus, identifying the corresponding initiating stimuli or stimuli source. The digital copy may be an exact replica of the initiating stimuli or partial replica, and may be an audio file, a video file, or both combined. The recognition software may utilize image recognition, audio voice recognition, pixel configuration recognition, and the like.

FIG. 11A helps further illustrate the perception area search method; as well as, a method for acquiring a synchronized time of selection, by the identification of the correct time zone of the user, in relation to the data server. For this example, a plurality of stimuli source types are represented including; radio stations (at 1110, 1112, 1114), live concert (at 1116), and a billboard (at 1118).

Referring to FIG. 11A, a request that originated (at 1120) would include a user location which would be utilized to identify the stimuli sources available to the user. The user location (at 1120) coincides with the location of multiple (three) radio broadcast perception areas; however, the user (at 1130) is exposed to only one live concert, and (at 1140) only one billboard. In this way, user location can be utilized as a solo request coordinate to identify stimuli sources that do not overlap, and to reduce stimuli sources of the same type who do have over lapping perception area coordinates.

FIG. 11A also helps clarify certain details of the perception time search method discussed above; such as, the time synchronization method. A method for acquiring a synchronized time of selection by the identification of the correct time zone of the user, in relation to the time zone of the data server. For example the date server (at 1150) represents the master time zone or 4:00. A user request that originated (at 1120) would include a user location which would be utilized to identify the time zone of the user (at 1160), where it would be 3:00. The user time of selection would then be adjusted to the master time zone (3:00+1:00=4:00) to be synchronized with that of the data server. The same is true of broadcasts which span more than one time zone, such as satellite radio for example. All stimuli coordinates are also synchronized to the master time zone by proper means.

FIG. 11B illustrates one embodiment of a perception area registration method utilized in the present invention to assist in identifying location specific stimuli sources and initiating stimuli. According to the first embodiment, the user device 4 comprises a communication means allowing both sending and receiving of information, a storage medium for recording control programs for implementing the above methods and from which data can be mechanically read, and GPS capabilities.

Referring to FIG. 11B, the user first accesses the perception registration program stored on the user device 4 (at 1160) and the users location is determined by GPS coordinates (at 1162) which are transmitted to the data server 20 by proper means (at 1164) like the internet, WiFi, and the like. Then (at 1166), it is determined if the location is registered. It is not registered, the perception parameters are identified (at 1168) by utilizing the user device in conjunction with the automated program stored on the device. The perception parameters are defined as the line around the perception area. Then the perception parameters are uploaded to the data server (at 1170) and the perception area is assigned an unique I.D.; and the site perception area registration is confirmed (at 1166). Once the system confirms the site is registered, then the user may proceed to register the stimuli source (at 1172), in this example a live concert. If the user chooses to register a concert at the registered location, perception dates would be entered (at 1174). This would be the date at the actual event. The perception time would be entered (at 1176). A unique ID is assigned to the stimuli source (at 1178) and the concert is stored correlatively with the stimuli source coordinates (at 1173) and the concert is stored correlatively with the stimuli source coordinates (at 1180). The perception area registration is then complete (at 1182). As discussed above, once a perception area has been registered, it may be utilized to register a plurality of stimuli sources; for example, different concerts given in the same arena, or different sporting events held at the same stadium on different dates, or at different times.

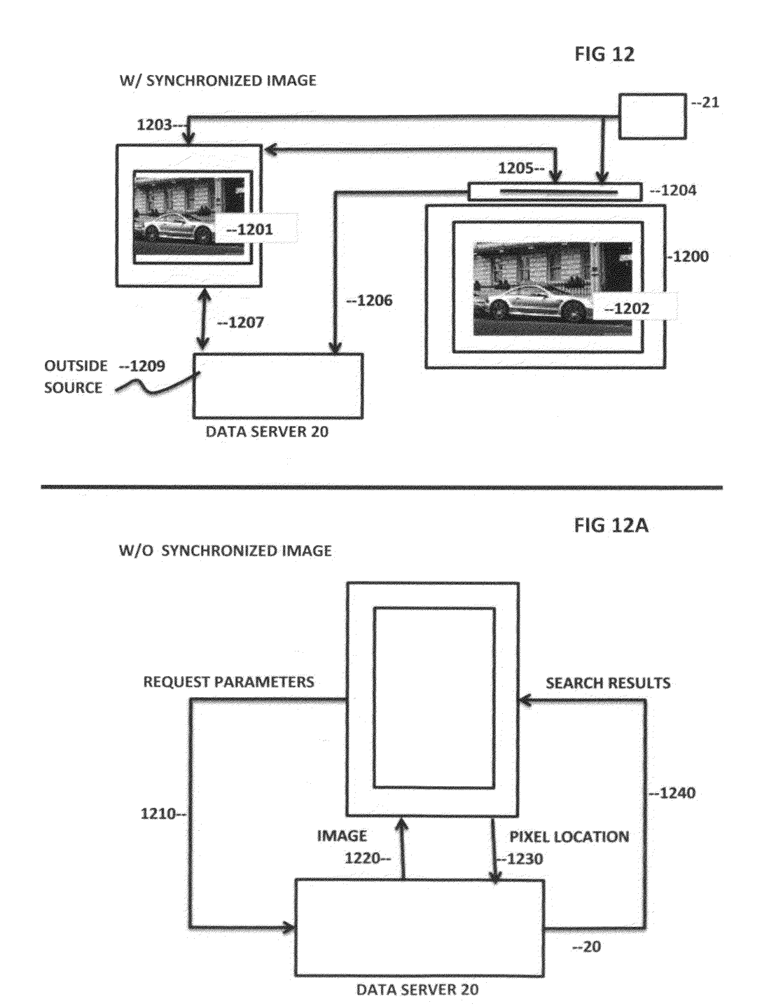

FIG. 12 illustrates certain details of the request coordinate identification method and system in which a synchronized stimuli, in this example of a synchronized movie image, is available to the user device 4 and utilized by a searching method and system to identify initiating stimuli. According to the first embodiment, the user device 4 operates as a universal remote control (discussed above) and contains; an IRD (Integrated Receiver Decoder) that is a digital broadcasting receiver, a digital recorder, a display means for audio and video output, a bi-directional communication means, and a storage medium for recording a control program for implementing the above methods and from which data can be mechanically read. Also, it is preferred that the display device (at 1200) is equipped with a recording means for recording a control program such as a hard drive, and bi-directional communication means such as the internet.

Referring to FIG. 12, the user may tune the television (at 1200) to a movie for example, using the universal remote feature of the user device 4. Simultaneously the same “synchronized” image is received and displayed at the user device 4 by proper means (at 1201).

The source of the synchronized image may be a broadcast station 21, broadcasting to both devices simultaneously (at 1203) and utilizing the IRD feature of the user device 4. Alternatively, the source of the synchronized image at the user device 4 may be a simulcast type control program and connection between the television 1200, (or other device such as a DVD player 1204), and the data server 20 through a communication means (at 1206) such as the internet. The data server 20 and the user device 4 are also connected by proper communication means (at 1207). This allows a simulcast of the content displayed on the television 1200, (or from the DVD player 1204), to be simultaneously displaced on the user device 4. Alternatively it is also contemplated that the user device 4 and the DVD player 1204 (or other devices) may communicate directly instead of through the data server 20 as shown (at 1205).

According to the first embodiment of the present invention, the user is able to “freeze” the synchronized image displayed (at 1201) on the user device 4 by the means of an automated software program; said image corresponding to the image of the television (at 1202), or on some other display means (not shown). Once an image is selected, the request coordinates may be acquired and stored for inclusion in the user request. A plurality of request coordinates may be acquired such as: movie name, the frame number, the digital image itself, (ATOS), and the like. The particular request coordinates which are extracted from the frozen frame by a control program, is dependent upon the stimuli types involved, the user device 4 features, and the request type. Alternatively, the initiating stimuli may also be viewed only on the user device 4, if said device is equipped with a display screen and proper capacity, without the use of another display device 1200.

Moreover, the request coordinate identification method may be utilized to identify request coordinates relating to a plurality of stimuli types; such as, streaming video, recorded movies, downloaded video, radio broadcast, satellite broadcast, and the like. Other display means for synchronized broadcast may include; a movie theater, a radio, a DVD player, live concert, digital billboard, a radio, a television, and the like.

It is also contemplated that the request coordinates may also be transmitted (at 1209) to the data server by proper means, from a source other than the user device 4. The request coordinates are then utilized as keywords to query the data server and identify a plurality of stimuli sources and initiating stimuli by proper means.

Further, FIG. 12 also helps illustrate the identification of the request coordinate “pixel location”; which is utilized by the pixel location search method. The user may select the embedded initiating stimuli (the car for example) by selection at least one pixel location comprising the image of the car (at 1201), before the request is transmitted to the data server 20. A pixel location may comprise, for example; a frame number, indicating the proper frame; a line number, indicating the vertical position within the frame; and a column number indicating the horizontal position within the frame. This selection may be made using point and click, touch screen, painting, or similar procedure. The pixel location is then included as a request coordinate and utilized by the appropriate search methods, as discussed above, to identify the car; (at 1202); the location of the pixels which make up a particular image, are stored correlatively with the initiating stimuli image (the car) thereof. In this way, single items of interest within a frame (embedded initiating stimuli) may be identified and returned to a user; instead of all items contained in a selected frame.

FIG. 12 A is a drawing which helps to illustrate an alternative embodiment of the request coordinate identification method and system in which a “synchronized image” is not available to the user device 4. Whereas the user device 4 transmits a set of stimuli coordinates to the data server 20 (at 1210); and utilizing a search and distribution methods discussed above, a copy of the initiating stimuli, a movie frame for example, is identified as the initiating stimuli and is output as a search result, and the image is returned to the user (at 1220). The user may then select an embedded stimuli by proper means, and the pixel location coordinates are transmitted (at 1230), to the data server 20; where they are utilized as search conditions to search the data server 20; pixel location stored correlatively with information representing initiating stimuli and corresponding search results thereof. Then the initiating stimuli is identified and result returned to the user (at 1240); as discussed in the information distribution method.

FIG. 13 illustrates an alternative embodiment of a search method for identifying initiating stimuli corresponding to a plurality of stimuli source types including but not limited to: broadcast, recorded, internet, location specific, print, mobile, and live, by utilizing the digital comparison search method. A digital copy of the initiating stimuli is acquired by proper means, and is transmitted from a user device 4, (with or without display capability), to the data server 20 by proper communication means, with or without other stimuli coordinates (at 1300); whereas the stimuli source name (for example a movie name) is identified by utilizing specialized software such as image recognition software, audio fingerprinting, and the like. This method may also be used to identify the initiating stimuli without the use of additional request coordinates. Alternatively, this method may be used in combination with other search methods. For example, a static initiating stimuli such as movie name is acquired by using an image comparison method in conjunction with recognition software; then by utilizing other request coordinates such as pixel location to search the data server (and other databases) in order to identify the embedded initiating stimuli, and output the user request (at 1310). The digital copy utilized may be a complete or partial replica of the original.

FIG. 13A demonstrates an alternative embodiment of a searching system in which the transmission of request coordinates, such as a digital image, are transmitted to the data server 20 by proper means from an external source (at 1330); instead of being transmitted from the user device 4 directly to the data server as discussed above. In this embodiment, the request coordinates are received by the data server from an outside source (at 1330). Stimuli sources and initiating stimuli are identified using the request coordinates and appropriate search methods, as discussed above. Next, (at 1340) the user request is output and transmitted by proper means to the user device 4; or other location as designated by the user. A plurality of request coordinates may be transmitted to the data server from an outside source; such as digital image, time of selection (TOS), pixel location, content name, channel, and the like. The outside sources may include a plurality of devices, sources, and communication means, including; other user devices 4, cell phones, PDA's, televisions, TV Top Box, VDR, broadcast stations, peer to peer devices, IRD's, movie theaters, data server, computer, cable broadcast systems, satellite broadcast systems, and the like.

FIG. 14, is a flow chart outlining the general steps of the request coordinate identification system which utilizes the search methods, distribution method, and the request coordinate identification methods, as discussed above comprising the steps; the stimuli sources and the initiating stimuli (hereafter referred to as I/S) are registered and stored to the data server, correlatively with a plurality of stimuli coordinates thereof (at 1445); if the user device 4 has access to a synchronized image (at 1450), then the user may select embedded stimuli (at 1480), and the request coordinates are acquired from; the synchronized image, user device 4 functions, and user input, as needed (at 1485). These request coordinates (hereafter referred to as R/C) may include the synchronized image itself. Next, the R/C are stored (at 1490), with or without pixel location coordinates.

Alternatively, if (at 1450) a synchronized stimuli is not available to the user device 4, the request coordinates are identified (at 1455) from both the user device functions, (GPS location, time, channel, and the like); and user input as needed. Next, the R/C are transmitted to the D/S (at 1460), and utilized as search conditions to query the data server and to identify the initiating stimuli (at 1465), and the I/S is output (at 1470) with a corresponding digital image. The image is then returned to the user device 4 (at 1475) where the user may select embedded stimuli (at 1480). The additional R/C are acquired (at 1485), including pixel location coordinates if applicable. Finally the R/C are stored (at 1490) and utilized in the request transmission (at 1495).

Once the identification of the request coordinates is complete, a request transmission is initiated (at 1495). This request may be initiated by the user; or alternatively, may be an automatic request initiated by a control program in response to a stimuli such as the relative position of another person or object. The request may contain; request coordinates, user ID information, as well as additional search filters and search parameters.

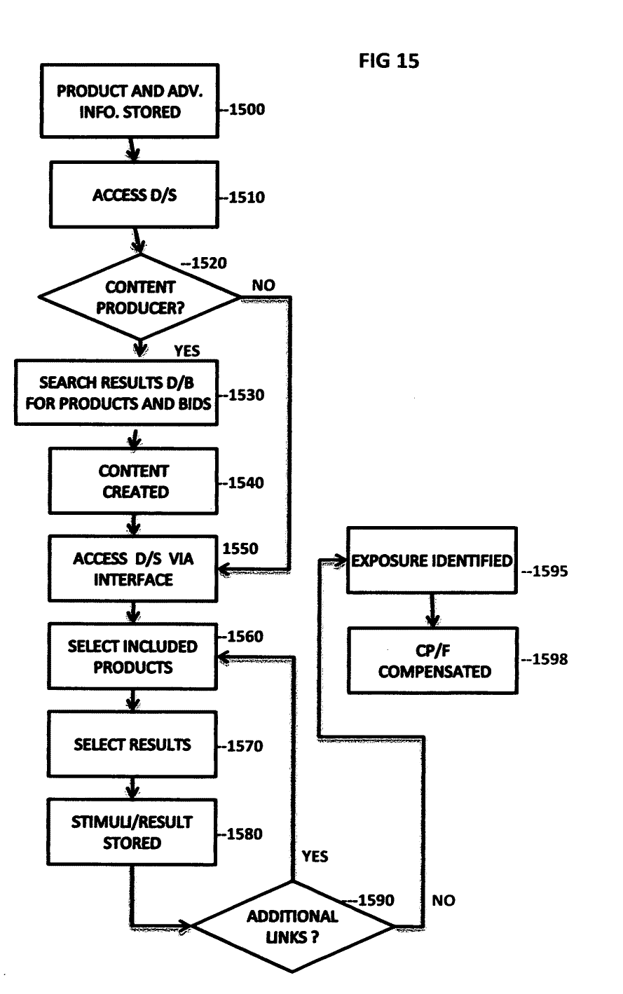

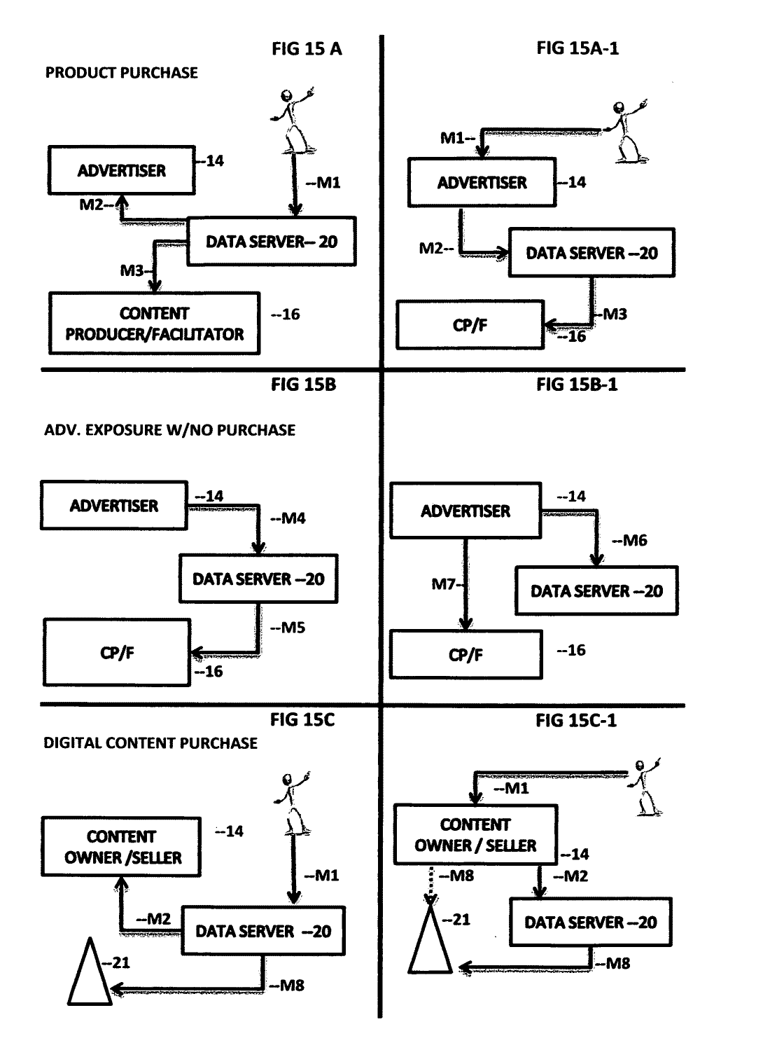

FIG. 15 illustrates generally the process steps involved in an advertising method and system according to the first embodiment of the present invention; which utilizes; a result registration method, a stimuli/result linking method, an exposure tracking method, and an advertiser payment method.

Referring to FIG. 15, beginning (at 1500), information representing products are stored correlatively with advertisement and advertisement bid information (results registration method discussed above). For example, information representing a Ford truck is stored correlatively with advertisement information such as a video commercial, product specifications, dealer location, website hyperlink, price information, search strings, and phases, and the like; as well as the “bid” information representing the amount of money the advertiser is willing to pay, for example, for each exposure of their advertisement, or purchase of their product.

Once the data server has been populated (at 1500) then the content producers and facilitators may access the data server via the interface (at 1510). If the user is a content producer (at 1520) then they may preview the request result data table to determine the products (and bids) that interest them and which they would like to include in their newly produced content. This content (stimuli source) may take a plurality of forms such as a major motion picture, a YouTube video, a store window, and the like. The user will then create their content (stimuli source) (at 1540) and include the products and services they have pre-chose (at 1540) into the content.

Once the content is created the content producer may access the D/S (at 1550) to register the products by selecting the products from their content (at 1560), selecting the advertisement (at 1570) and the product placement link is completed and stored (at 1580) where it makes available advertisements based on the user response to stimuli (stimuli/result linking method discussed above).

If it is determined (at 1520) that the user is not a content producer but rather a facilitator (someone interested in linking existing content and advertisements), they may access the D/S (at 1550) where they may search the data base for advertisers and products. The facilitator may then proceed to register advertisements to existing content by selecting the product (initiating stimuli) (at 1560) and then selecting the advertisers and products they would like to link to those products (at 1570). The products/advertisement linking process is complete (at 1580). Both the content producer and facilitator is given an option to link additional products (at 1590). They may then return to (at 1560) and choose a different stimuli to link with the same advertisement (at 1570); or alternatively choose the same stimuli (at 1560) and link this with a different advertiser (at 1570).

Once the content has been created and linked to the advertisers desired results, then each exposure is identified and stored (at 1595) by proper means, (exposure tracking method discussed below). Finally, the content producer/facilitator is compensated (at 1598) for each exposure; whereas a fee is earned according to the advertiser bid conditions and parameters (advertising payment method discussed below).

According to the first embodiment, there may be money flows among the user, the advertiser, the content producer/facilitator (CP/F), a stimuli source such as a broadcast station, and the data server 20 (D/S). FIG. 15A-15C-1 are schematic drawings illustrating the transaction components of the present invention and show the money flows that may take place. It is understood that these method are not necessarily mutually exclusive but may be used collectively or in a plurality of combinations.

FIG. 15A illustrates a user payment method, whereas a user purchases a product corresponding to the search results obtained by the present invention; whereas, the user pays a fee M1 for the product to the advertiser 15. The money M1 may flow from the user to the data server 20 where a transaction fee may be retained; and a product payment M2 may flow from the data server 20 to the advertiser 14; also a CP/F fee M3 may flow from the data server 20 to the CP/F 16; whereas a fee is earned by the CP/F 16 according to the advertiser bid conditions and parameters.

FIG. 15 A-1 shows an alternative money flow for an user payment method, whereas a user purchases a product corresponding to the search results obtained; whereas the product payment fee M1 may flow from the user directly to the advertiser 14; then a bid fee M2 may flow from the advertiser 14 to the data server 20 where a transaction fee may be retained, and a CP/F fee M3 may flow from the data server 20 to the CP/F 16; whereas a fee is earned according to the advertiser bid conditions and parameters. It is also contemplated that the advertiser 14 may pay the CP/F fee M3 directly to the CP/F 16 (not shown).

FIG. 15 B shows an advertising payment method in which a money flow takes place between the advertiser 14, CP/F 16, and the data server 20, without a product purchase; whereas an bid fee M4 may flow from the advertiser 14 to the data server 20 where a transaction fee may be retained; and then a CP/F fee M5 may flow from the data server 20 to the CP/F 16; whereas a fee is earned according to the advertiser bid conditions and parameters.

FIG. 15 B-1 shows and alternative money flow for an advertising payment method in which a money flow takes place between the advertiser 14, CP/F 16, and data server 20, without a product purchase; whereas an transaction fee M6 may flow from the advertiser 14 to the data server 20; and whereas the money flow of a CP/F fee M7 may flow from the advertiser 14 directly to the CP/F 16; whereas a fee is earned according to the advertiser bid conditions and parameters.

FIG. 15 C illustrates the possible money flows between the user, content seller 14, a broadcast station 21, and data server 20, when digital content (such as a song and the like) is purchased according to the first embodiment of the present invention. When a digital file is purchased, a product fee M1 may flow from the user to the data server 20 where a transaction fee may be retained; a product payment M2 may flow to the content seller 14; and an exposure fee M8 may flow to the stimuli source, in this example a broadcast station 21; whereas a fee is earned by a broadcast station 21 in exchange for broadcasting the initiating stimuli corresponding to the digital content purchase.

FIG. 15 C-1 illustrates an alternative money flow when digital content is purchased; whereas product fee M1 for the purchased digital content flows from the user directly to the content owner/seller 14; then a bid fee M2 may flow from the advertiser 14 to the data server 20 where a transaction fee may be retained; further, an exposure fee M8 may flow from the data server 20 to the broadcast station 21, (stimuli source); whereas a fee is earned by a broadcast station 21 in exchange for broadcasting the initiating stimuli corresponding to the digital content purchase. Alternatively, an exposure fee M8 may flow to the stimuli source directly from the content owner/seller 14 and not through the data server 20.

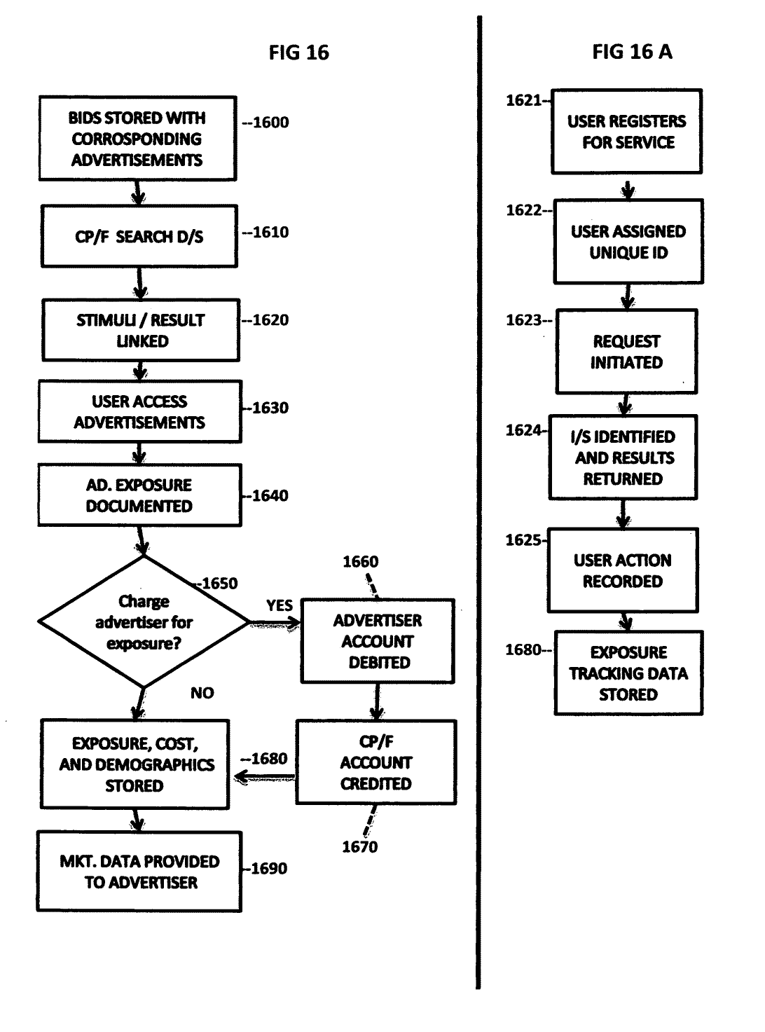

FIG. 16 is a flowchart outlining generally the process steps of the product marketing method and system according to the first embodiment of the present invention comprising; a result registration method, and advertising method, a marketing method, exposure tracking method, and an advertising payment method.

Beginning at (1600) the advertiser registers “bids” or the amount of money it is willing to pay for each user exposure to their advertising material. Then at (1610) the content producers and facilitators may search the D/S and identify products and services available for product placement inside both new and existing content (at 1620).

Then (at 1630) the users may access the advertisements by making a request based on an initiating stimuli. The information related to the exposure is then identified including; exposure type, advertisement type, user demographic, stimuli source, and the like. Once the advertisement exposure has been documented (at 1640) the system determines at (1650) if the advertiser is charged for the exposure. If so, the advertiser account is debited (at 1660) and the producer/facilitator account is credited (at 1670). Finally, the exposure, cost, and demographic information is stored (at 1680) for management action. Finally, the marketing information is provided to the advertiser (at 1690). This marketing information allows each advertiser to determine, and control, their per person cost of product placement advertising and adjust their marketing accordingly.

FIG. 16A is a flowchart generally illustrating the exposure tracking method utilized in the product marketing system according to a first embodiment.

First a user registers to use the system by accessing the data server via a user interface at (1621). This registration information may include name, address, phone, device, demographic, and billing information (such as credit card or PayPal information) and the like. Next, the system assigns a unique identification (at 1622) and the user is able to make request as a response to a plurality of initiating stimuli (at 1623), and the request is identified by first identifying the initiating stimuli and then by returning the corresponding search result to the user (at 1624). This search result may comprise information, additional menu choices, purchase options, digital files, hyperlinks, video, websites, photographs, traditional search result, and the like. Additional marketing information such as, stimuli source, initiating stimuli, subsequent selections, selection time, purchases, and stimuli ignored, are collected via a software program and recorded correlatively with the user I.D. and demographic information (at 1625) and then stored correlatively with advertiser expense data (at 1680). The exposure tracking method and system is also utilized by the advertising system and marketing systems as discussed above.

### Second Embodiment

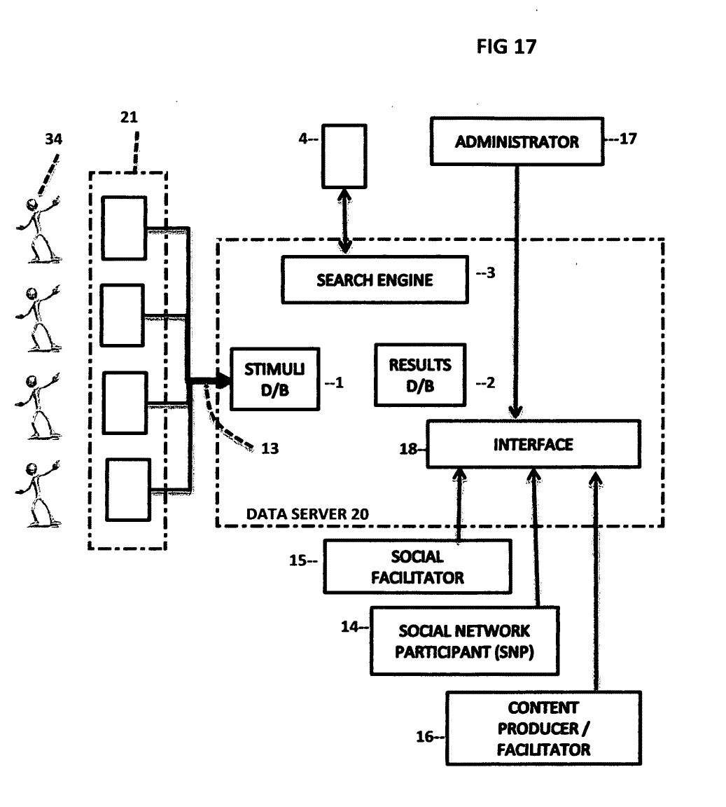

Next a second embodiment will be described with reference to FIGS. 17 to 22 with similar components labeled with similar reference numerals. In this embodiment, the initiating stimuli is comprised of individuals; and information is returned to a user in response to a user request, whereas said request results take the form of social networking information and communication options, instead of product advertising and information; thus functioning as a social networking search system. Therefore, users may obtain social network search information and communication options about individuals without the need for a keyword or phrase, (such as a phone number, name, e-mail address, and the like) based on an user direct response, automated response, or free association response, to a plurality of initiating stimuli.

In general, social networking by computer has become very popular as sites such as; Match.com, MySpace.com, Facebook.com, and e-harmony.com, have attracted users from all demographics. These users meet and communicate via peer to peer computer networks; however, primarily from remote locations limiting personal contact.

Therefore according to this embodiment, in order to provide a more personal and interactive social networking system; users may register for the service, load the software on their user device (such as a cell phone), and then compatible individuals may be identified as location specific initiating stimuli, as discussed in the first embodiment. In other words, a person of interest enters a user's perception area, a request is initiated, the person is identified, and search results are returned to the user. This information may be social information such as; a Facebook page, a MySpace page, Match.com profile, a proprietary personality matching system, a compatibility rank, a personal profile, relative location, and the like. Alternatively, results may be business information such as; profession, business resume, and the like. The search result may also be communication options such as; a simultaneous phone call, or text message, allowing communication without knowing or exchanging personal information.

Further, according to the second embodiment, as a person travels to work, a club, or shops at the mall; the searching system may initiate an automated request to identify each initiating stimuli (person) who meets a minimum requirement (such as a preset 90% personality match) and output a request result which may comprise; a social profile, a personality match, a compatibility rating, or a simultaneous phone call connecting the two people, along with a relative position (location) of the person to which a social match has been made. The display of relative position information as a component of the search results, allows each user to approach the other or to just observe personal appearance from a distance as from across a restaurant. Said relative position may also be utilized by a user to avoid certain individuals.

Therefore, by utilizing the social network searching system, in conjunction with the automated request component triggered by the relative position of two individuals, (as discussed in the first embodiment), social networking can be a mobile, interactive, experience played out in the real everyday world instead of a data base search confined to separate locations.

FIG. 17 shows an overview of a social network searching system according to the second embodiment of the present invention; whereas the stimuli source 21 is a plurality of user device 4, broadcasting location information by proper means to the data server; location information is stored correlatively with the corresponding user I.D. and social networking information thereof. The user device 4 may include a plurality of device types including; cell phones with GPS function, computers, and the like, with transmitting means (either wirelessly or non-wirelessly).

Further illustrated in FIG. 17 according to this embodiment, initiating stimuli 34 is defined as individual people characteristics which may include; a persons relative location, physical appearance, personality compatibility, profession, dress, and the like. The social network participator 14 (SNP) is the person registering as a user and supplying social information to the other users about themselves (the product). This social information may take a plurality of forms such as dating profiles, personality matching data, photographs, live phone connection information and the like.

Referring again to FIG. 17, similar portions to those in FIG. 2 are denoted by similar reference numeral. As in the first embodiment, the database 1, the database 2 and the search engine 3, compose a data server 20. The user interface 18 allows access to the data server 20 by social network participants 14, social facilitators 15, content producer/facilitator 16, and the system administrator 17.

The data server 20 is connected to another website 19 (not shown) through a communication means such as the internet. The broadcasting stations 21 is, for example, a plurality of social network participants who are transmitting their locating and other information to the website 19 by proper transmitting means; or alternatively, transmitting directly to the data server 20 or directly to other user devices 4. Data representing stimuli coordinates such as; user I.D., current location, and the like, are transmitted from the broadcasting station(s) 21 to the data server 20 where the data is classified and stored into corresponding records; the locating coordinates stored correlatively with the user I.D. and corresponding social networking information thereof.

Stimuli source coordinates (such as location data) related to the broadcast station(s) 21 are not always transmitted from the user device 4 or the corresponding website 19. In other words, the data server may be populated by a plurality of methods and sources including but not limited to; data links, manual input, downloads, uploads, RFID Reader, relative position calculation, cell tower triangulation and the like. The information representing stimuli coordinates may also be stored to the data server 20 through a predetermined storage medium, or the information may be created on a system other than the user device 4 and transmitted to the data server 20. A plurality of methods may be used alone and in combination to determine the stimuli coordinates of each user device 4. The location information of each user device 4 is received and stored in such a way as to keep the location information current.

Data server 20 can store information representing a plurality of initiating stimuli (individual people) as well as the corresponding stimuli coordinates; for example, relative position, compatibility scores, physical attributes, unique user I.D., user name, college attended, employer, and the like, in such a manner that they may be identified.

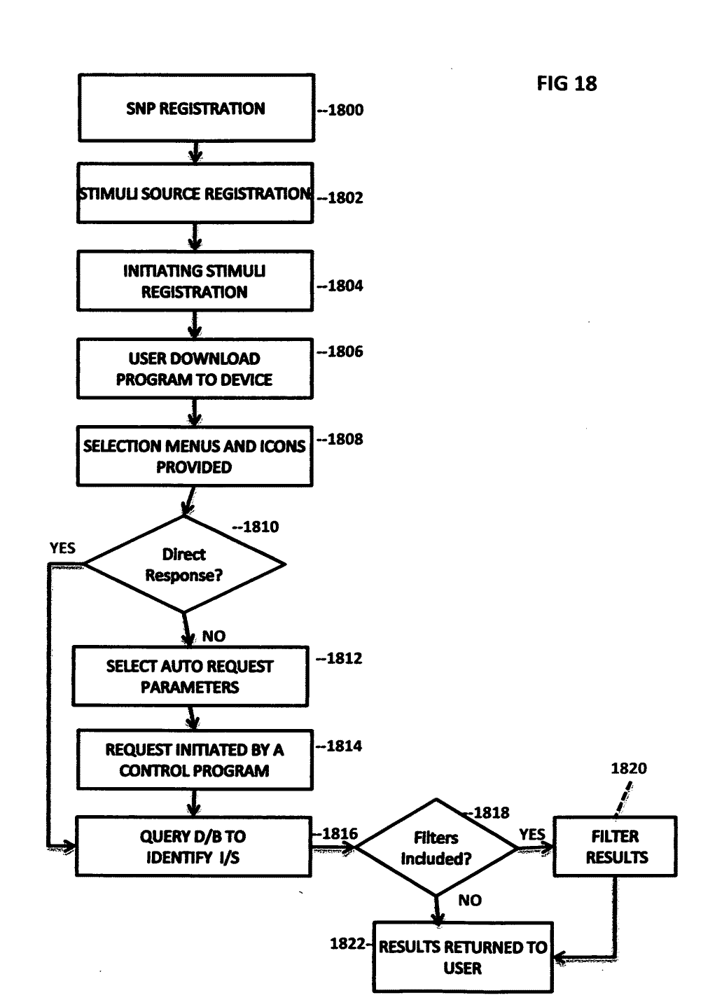

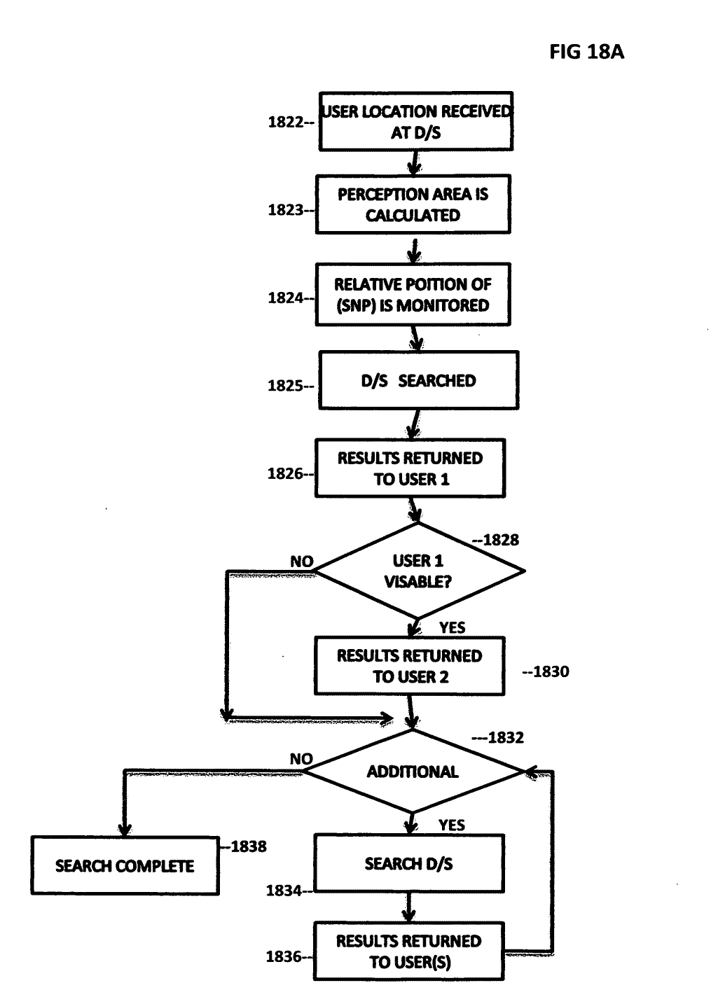

FIG. 18, is a flowchart outlining the general process steps involved in a social network search system including; a result registration method, a stimuli source registration method, an initiating stimuli registration method, a selection method, a search method, and a distribution method, according to the second embodiment of the present invention.

Beginning (at 1800) the social network participant 14, (hereafter referred to as SNP) registers to participate in the social network search system, utilizing the request result registration method as discussed in the first embodiment. The SNP accesses the data server 20 via the user interface 18 (not shown) and inputs personal information data such as; name, address, billing information, cell phone number, e-mail address and the like. Next, the SNP may select and register search results that will be transmitted in response to request; such as, a MySpace page, photos, personal biography, Match.com profile, Facebook page, instant message screen, phone connection, and the like. The SNP are assigned an unique I.D. and all registration information is stored at the data server 20; the unique I.D. stored correlatively with the search results thereof.

Next (at 1802) the SNP 14 registers the stimuli source by registering the information related to their user device 4, said device acting as a broadcast station 21 (stimuli source registration method discussed in the first embodiment). Information representing stimuli coordinates, such as location, is acquired by proper means; and a plurality of stimuli sources are stored with at least a unique identifier and the stimuli source coordinates thereof. It is preferred that the location information of the user device 4 be transmitted directly to the data server 20 or other website 19; where it is stored correlatively with the unique I.D. of the user and the additional networking information. However, it is contemplated that the location information of the user device 4 may be transmitted directly to other user devices directly; without being first transmitted to the data server 20.

The SNP who is registered above, also functions as a static initiating stimuli; other initiating stimuli are also registered by proper means (at 1804) in a manner which will allow the static initiating stimuli (SNP) to be identified. Said initiating stimuli may include; personal social networking preferences, contact preferences, user defined perception area (100 feet, 50 feet, etc.) compatibility test result, relative position, visibility to other users, profession, schools attend, club memberships, hobby, proprietary matching score, name, user name, physical appearance, personal compatibility, profession, clothing, digital image, and the like. Information representing stimuli coordinates is stored correlatively with the information representing initiating stimuli and corresponding search results thereof.

Once the request results, stimuli sources and initiating stimuli, registrations are complete as discussed above; a SNP may then download the program onto their user device 4 (at 1806) and begin selections based on exposure to initiating stimuli (selection method discussed in the first embodiment). These may include a plurality of response types including; direct, free association and automated response to multidimensional stimuli.

Selection menus and icons are then provided (at 1808) representing a plurality of initiating stimuli (SNP). Said icons are displayed on the user device as the individuals (static initiating stimuli) move into the users perception area; said icons may also convey the relative position of each SNP within the perception area and in relation to the user. The user may utilize a direct response (at 1810) and request information on a particular individual within their perception area screen display; by touch screen, voice command, and the like. Said display may include all SNP within the user perception area; or alternatively, a filtered list (at 1813) by selecting stimuli filters such as, men with certain personality characteristics and certain hobbies who attended certain schools. The user may also select embedded stimuli, such as a registered dress worn by a woman. In addition, the user may select both split and stacked stimuli based on that dress (selection system and method as discussed in the first embodiment). Once a direct response is initiated (at 1810), a query is conducted at the data server, (at 1816) using R/C as search conditions, and the SNP is identified. If filters are included in the request (at 1818), then results are filtered (at 1820), and appropriate results are returned to the user (at 1822) by proper means (search methods and distribution method discussed above in the first embodiment). Search results may include; MySpace page, photos, Match.com profile, Facebook page, proprietary matching score, profession, business, resume, live phone connection, instant message screen, simultaneous e-mail message, simultaneous cell phone call connecting two people, a special ringing sound or ring tone, and the like.

Alternatively, if (at 1810) the response is not direct, then the user may utilize an automated responses whereas (at 1812) the user may choose by proper means automatic search request parameters such as; relative position, minimum compatibility match percentage, profession, schools attended, club membership, social fraternity memberships, proprietary matching score, name, user name, personality compatibility, profession, digital image comparison, and the like. These parameter may be designated by a plurality of means including; menu selection, downloads, uploads, data links, manual input, and the like. Once the parameters have been designated, the control program monitors the perception area of the user and a request is triggered (at 1814) when a SNP enters the perception area of the user.

Once a request is initiated (at 1814), a query is conducted of the data sever, (at 1816), and the SNP is identified by searching the data server with the request coordinates as search conditions; information representing SNP stored correlatively with the stimuli coordinates and search results thereof. If search filters are included in the automated request (at 1818), then the results are filtered (at 1820) with the pre-designated parameters, and then the relevant search results meeting the user parameters are then returned to the user (at 1822) by proper means (search methods and distribution methods discussed above in the first embodiment). Search results may include; a MySpace page, photos, personal biography, Match.com profile, Facebook page, proprietary matching score, profession, business resume, live phone connection, instant message connection, simultaneous e-mail message, simultaneous cell phone call connecting the two people, a special ringing sound or ring tone, and the like.

FIG. 18A is a flowchart that illustrates certain additional details of the social networking search system outlined generally in FIG. 18; such as the process steps of; perception area calculation method, location monitor methods, and additional search methods, according to the second embodiment of the present invention.

Beginning (at 1822) a plurality of user locations are received by the data server by proper means. Next, the perception area is calculated by proper means (at 1823) for each SNP; utilizing the present location and the pre-designated user preference as to perception area size. The control program then monitors the system; when a user's location coordinate is found to be inside the perception area of another SNP (at 1824) a request is automatically triggered.

The data server is then queried to identify the SNP (at 1825), whereas search results are returned to the user (at 1826). If the user had decided not to be visible to other users (at 1828), then they may still receive information on users inside their perception area but they will remain invisible to the other SNP. However, if the user (at 1828) opts to be visible to other SNP, then search results relating to user 1 will be transmitted to user 2 (at 1830) when a request in initiated by user 1. In this way, the system provides bi-directional search results to both people regarding the each other. The option to be visible or not visible to other users, may be an option that applies to all SNP; or alternatively, an option which operates based on pre-designated parameters and applies to only select SNP.

Next (at 1832), the user is given options to request additional information. This may be personality profile, a Facebook page, a MySpace page, an enlarged photography, a Match.com profile, an instant message screen, a simultaneous phone connection in which both user 1 and user 2 devices ring at once (discussed later), a proprietary compatibility rating, and the like. If the user requests additional information (at 1832), the data server query is conducted (at 1834) and (at 1836) the additional request is returned to the user. The user is again given the opportunity to request additional information (at 1832). If the user elects not to request additional information, the search process is complete (at 1838).

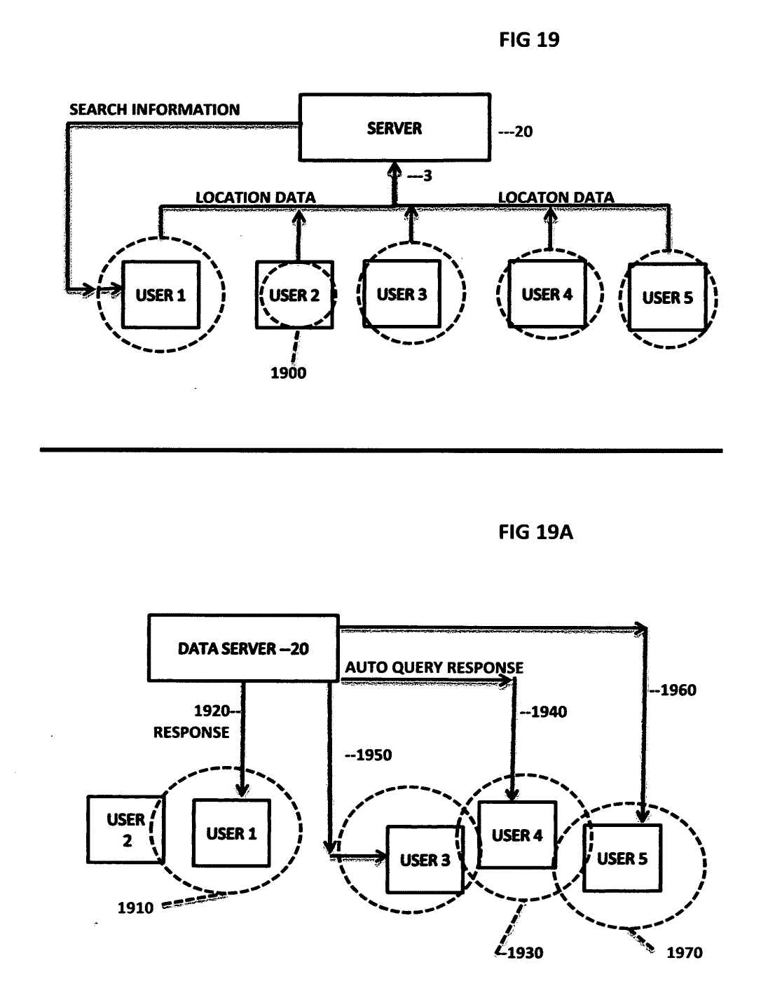

FIG. 19 is a schematic drawing helping to clarify certain additional details of the social search system and perception areas, according to the second embodiment of the present invention.

Referring to FIG. 19, each user device 4 (identified here for example as user 1 through user 5) transmits location data to the data server 20 by proper means. This may be transmitted by a plurality of communication means either wirelessly or non-wirelessly. For this example, it is assumed a wireless internet communication is utilized; however, a cellular phone network could be used as well as communication infrastructure such as DSRC, PHS, HDR, etc. The location information may be GPS coordinates, cellular triangulation. Location data may be transmitted directly to the data server or through another website 19 (not shown) as discussed above.

FIG. 19 also illustrates the perception area of users 1-5 (at 1900). As illustrated, the perception areas do not overlap and are different sizes depending on the preset user preference (at 1900).

FIG. 19A is a continuation of FIG. 19 and illustrates the automated request initiated by the relative position at the users.

As User 1 and 2 move closer together, User 2 enters User 1 designated perception area (at 1910) and an automated response to the stimuli is executed (at 1920) and delivered to user for display on the user device. This information may be the location of user 2 and the option to request more information or alternatively, it may be a Facebook page, a proprietary match ranking to compare compatibility of User 1 and User 2 (92 percent, for example), an instant message communication, a photo, a short biography, simultaneous phone connection between User 1 and User 2, and similar social information, and communication options.

As further example, when Users 3 and User 5 enter the designated perception area of User 4 (at 1930), then User 4 will receive social information, information options, and communication options, on both User 3 and User 5 (at 1940), User 3 will receive information and communication options regarding User 4 only but nothing regarding User 5 (at 1950); and User 5 will receive information on User 4 (at 1960), but nothing on User 3, because User 3 is outside user the designated perception area of User 5 (at 1970).

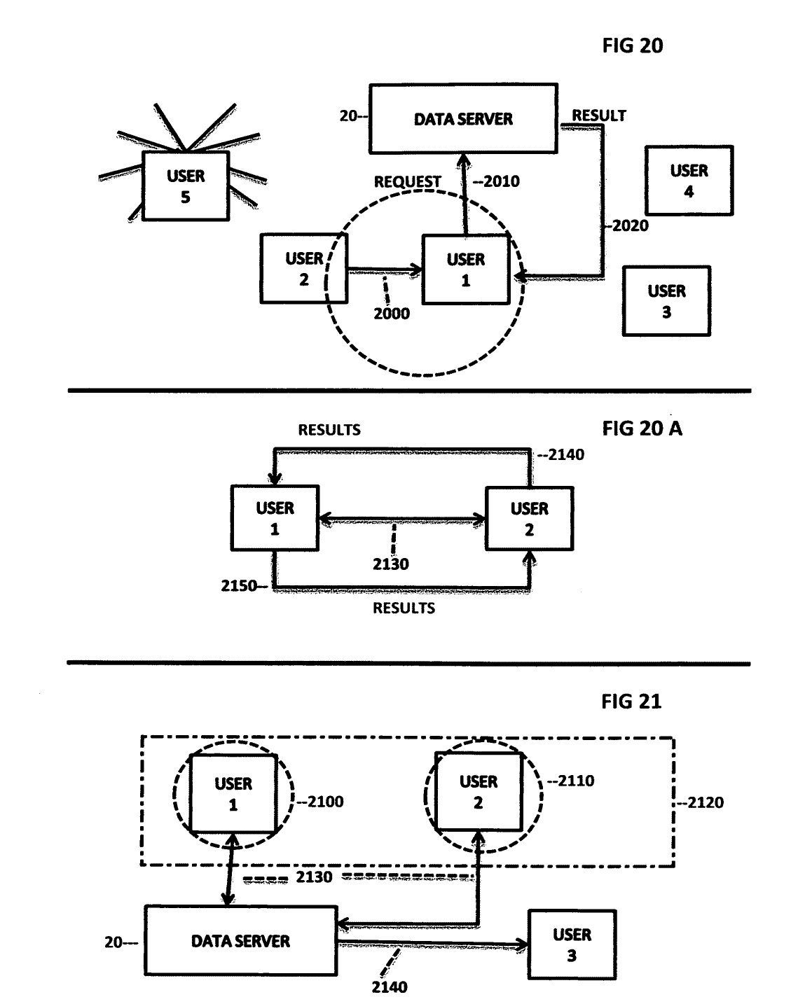

FIG. 20 illustrates an alternative method for identifying the relative position of users, which in turn, is used to identify the user and initiate an automatic request according to the second embodiment of the present invention.

In this alternative construction, location information is not transmitted to the data server 20, but rather, a plurality of user devices communicate to each other their relative position (at 2000); which in turn, initiates an automated request (at 2010) for the social networking information which is then returned to the user (at 2020). The means of communication between user devices may be; Bluetooth, wireless fidelity (WiFi), Zig Bee, ultra wide band (UWB), radio frequency identification (RFID), infrared (IR), near field communication (NFC), ISM band radio, cypress semi conductors, wireless USB chips, wireless home network, cell phone hot spot connection, and similar transmitting means. The broadcast range of said transmitting range may, determine the perception area of a stimuli. For example, user 5 is outside (PA) of User 2 due to broadcast range.

FIG. 20A illustrates another construction modification of the second embodiment whereas social networking information is stored and initiated from each individual user device, and not from a central data server 20.

Referring to FIG. 20A, user device 1 and user device 2 communicate in such a manner that it is determined that they are within the perception area of each other (at 2130). Then, the social networking information is transmitted from user 2 to user 1 (at 2140) and if user 1 has opted to be visible, social networking information is bi-directionally transferred from user 1 to user 2 (at 2150).

FIG. 21 is a schematic drawing illustrating the social facilitator method which individual user selections, such as perception area, can be suspended in specific location and replaced with temporary parameters.

Referring to FIG. 21, the perception area of user 1 is 100 meters (at 2100) and that of user 2 is 75 meters (at 2110). In most locations, no search would be initiated as neither user is within the perception area of the other; and thus, no information would be exchanged. However in this example, a social facilitator may designate a particular area, for example a football stadium or specific night club as a “hot spot” in which social networking parameters are suspended, expanded, or contracted, while the users are located inside the social facilitators designated perception area (at 2120). This area may be selected by using the perception area registration method as described in FIG. 11B of the first embodiment. In this example user 1 and 2 would exchange information (at 2130); as long as they were within the “hot spot” designated by the facilitator. When the users exit this area, the individual parameters return to control. This type of “hot spot” may also be active only during certain hours of the day or on certain dates. Group demographics and group attitudes may also be utilized as stimuli and search results. (at 2140)

As discussed above, search results may include not only personal and business information such as; relative location, a MySpace page, photos, personal biography, Match.com profile, Facebook page, proprietary matching score, profession, business resume, and the like; but may also include communication options such as; live phone connections option, instant message connection screen, simultaneous cell phone call connecting the two people, and the like. FIG. 21 also help illustrates the preferred embodiment in which all communication options (at 2130) travel through the data server 20. It is preferred that no personal data such as phone numbers, e-mail addresses and the like are available to other SNP. When a user leaves a perception area, a hot spot, or blocks visibility to all or specific users, no further contact is possible.

### Third Embodiment

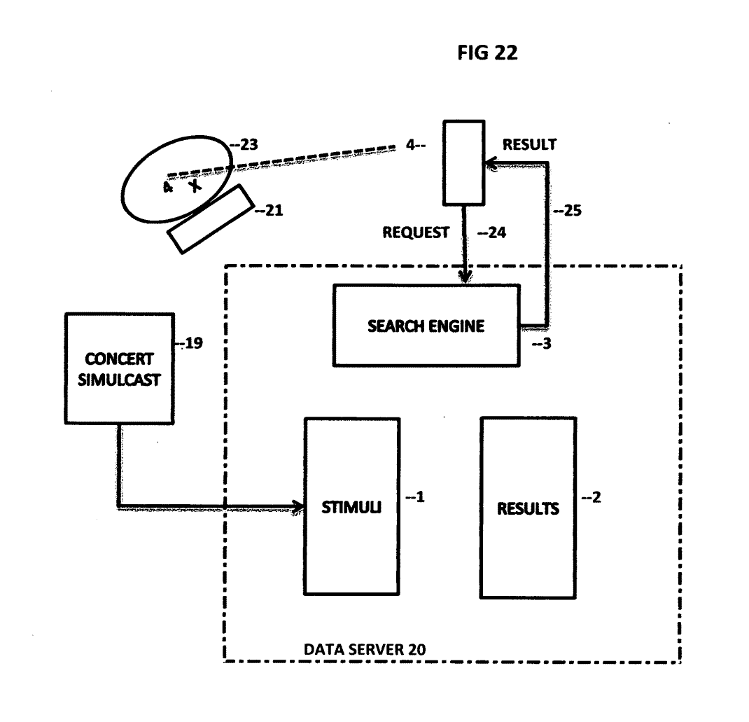

Next, a third embodiment will be described with reference to FIG. 22 through FIG. 25, wherein similar components are labeled with similar reference numerals. In this embodiment, initiating stimuli distributed though location specific stimuli sources (hereafter referred to as LSSS) are searched, identified, and sold.

In this embodiment, as in the case of the first embodiment, there are two basic types of LSSS; various output LSSS and constant output LSSS. Variable output LSSS would include, for example, live music concerts, digital billboards, movie theaters, and the like. Constant output LSSS would include for example, a traditional billboard, people, a store window display, an artwork painting, a landmark, a house, and the like.

For this example, it is assumed the variable output LSSS is a live music concert and the initiating stimuli is a song. In general, music and video broadcast through live events such as a music concert is not available for searching, identification, and purchase. Therefore, according to this embodiment, in order to allow for the search and purchase of the live music (or a copy), the perception area of the music venue is registered (perception area registration method discussed above) and stored with information representing the unique concert I.D. and corresponding play list so the LSSS (the exact concert) may be identified using only one stimuli coordinate, user location. Once the concert is identified, then the user may purchase the content, including the live version of the concert to which they were in attendance. Additionally, the user may request a single song, other information, or purchase related products that were returned to the user device as additional selection options facilitating additional request and responses.

FIG. 22 is a schematic drawing representing the searching method, distribution method, and purchase, of music and video being broadcast from a live concert. The user device 4 is located within the perception area 23 of the live concert 21 (LSSS). In this example, the concert broadcast is transmitted to the data server via a connection to another website 19, which is simulcasting the concert. Information representing each live musical piece is received at the data server 20 and stored correlatively with the appropriate stimuli coordinates and the corresponding search results thereof.

Once the user 4 is exposed to a stimuli (in this example a live song) the user makes a request 24 (touch screen for example) and the request coordinates, including at least I.D. and location, are transmitted by an automatic program to the data server 20. The location information is used to identify the concert (LSSS) by utilizing the location as the keyword to search the data server 20, the data server correlatively storing information regarding perception area and the specific concert (LSSS) thereof. The results 25 are then identified by proper means and returned to the user.

If additional request coordinates were transmitted with the request, such as TOS (Time of Selection), RAV (Request Adjustment Variable), song title, and the like, as discussed in a previous related application, then the exact song is identified for example, by using the TOS to query the data server; the concert song play list song is stored correlatively with the PST (Perception Start Time) thereof. Once the exact song is identified by proper means, then a digital copy of the song may be returned to the user as results 25 and the user would be charged a fee (money transfer methods discussed above). Alternatively, it is contemplate that the user may be provided with a menu of the play list or selection of a specific song, or presented with each song as it is played.

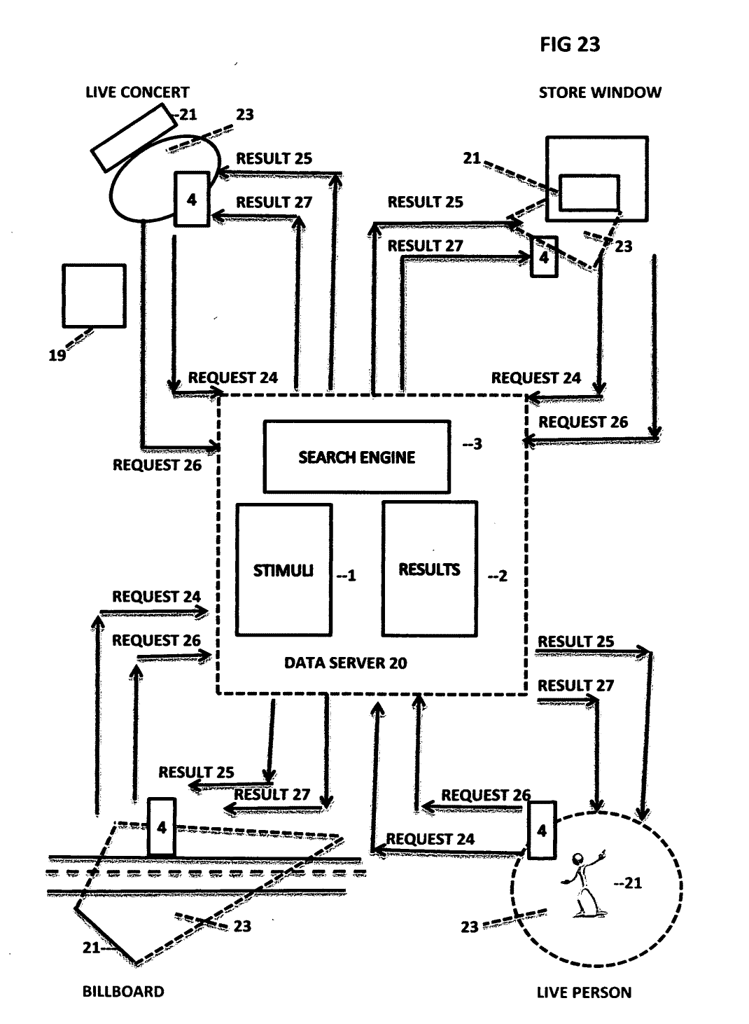

Further, in this embodiment, as in the case of the first embodiment, the user has the ability to search and purchase products based on a plurality of LSSS including both variable output LSSS (such as a live concert) and constant output LSSS such as a store window, a traditional billboard, and a live person, as illustrated in FIG. 23 below.

FIG. 23 is a schematic drawing illustrating the plurality of LSSS providing initiating stimuli to search; as well as, certain details of the stimuli search and purchase methods discussed in FIG. 22 above.

Referring to FIG. 23, the user is exposed to a plurality of LSSS 21. The user then located within the perception area 23 of the LSSS (in this example, a concert a billboard, a window display and a person functioning as a live mannequin) initiates a request by selecting an icon on the user device 4 (selection method discussed in FIGS. 4-4F). A request 24 is then transmitted from the user device 4 to the data server by proper transmitting means (such as the internet). The request contains at least a unique user I.D. and location information. The system then identifies the LSSS by searching the data server 20 utilizing the locating as a keyword in the data server 20; the data server correlatively storing information representing a plurality of LSSS correlatively with at least the perception areas and search results thereof. The results 25 may then be returned to the user device 4, or to another location.

The results 25 may include a digital file for purchase; or alternatively, selection options such as a digital image of the LSSS which allows the user to “point and click” a portion of the image (a specific item in the store window for example). This additional information (pixel location coordinate) is then re-transmitted in a second request 26. The pixel location (or other request coordinate) is utilized to identify a more exact initiating stimuli by searching the data server 20 using the pixel location as a keyword; the data server 20 correlatively storing the LSSS with a plurality of initiating stimuli and corresponding pixel locations thereof.

In one example, a digital image of the store display window (or a live person) would be returned as the result 25 to the user request 24. The store window contains mannequins dressed in winter clothes. The user may select the image of the woman's coat, and the new request 26 is transmitted and the specific results 27 refer only to the winter coat. This may be purchase options, price, color variations and the like. This same process would apply to a woman who was registered as an initiating stimuli, in effect becoming a “live mannequin” for everything she is wearing.

The results 25/27 may be returned to the user device 4 or to another location designated by the user.

It is also contemplated that the LSSS 21 can be a movie shown at a theater or a film festival whereas users could instantly purchase copies of the film, film clips, or particular scenes.

It is also contemplated that the LSSS 21 may also be a plurality of constant output types such as; a traditional billboard, an historic site, art work, a banner, advertisement, signs, a store window display, a product display, people, live mannequins, durable goods, and the like.

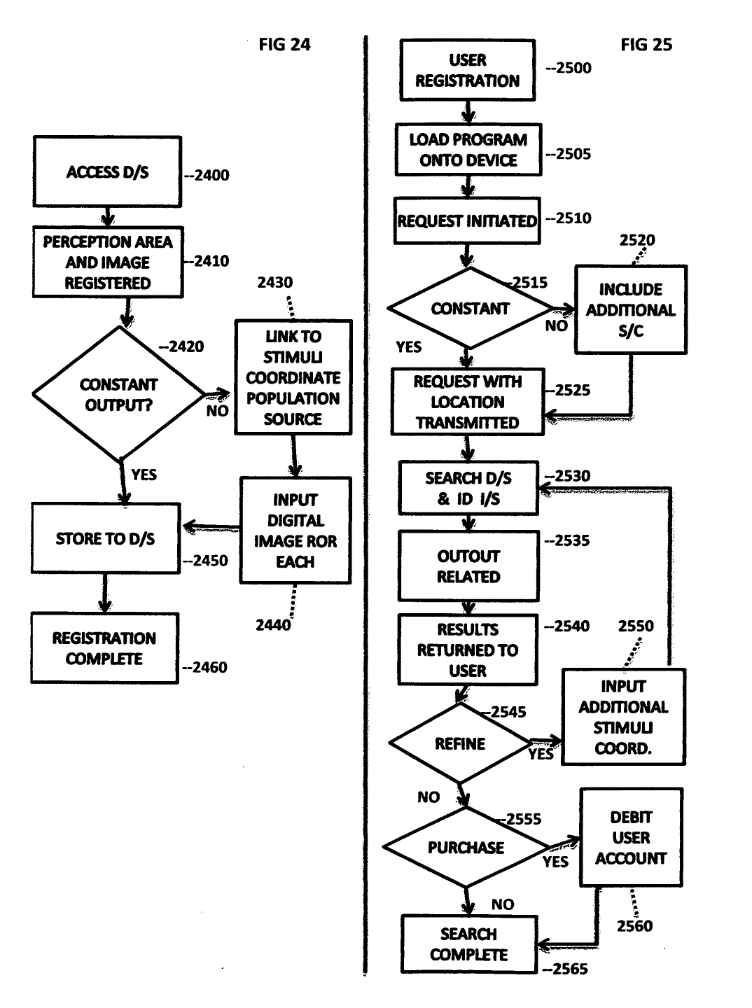

FIG. 24 is a flowchart outlining the general process steps involved in the registration method for both constant and variable output LSSS, helping clarify the stimuli source registration method discussed above.

First, the facilitator accesses the data sever (at 2400) via the interface (discussed above). Then the facilitator registers the perception area utilizing the perception area registration method (discussed in FIG. 11B above); and then registers an image of the LSSS, if applicable, in the form of a digital photograph (at 2410). If the LSSS is determined to be a constant output type such as a store window display (at 2420), then the location information is stored correlatively with a digital image, corresponding products and information, in a manner which will allow them to be searched and identified (at 2450). The registration process is complete (at 2460). The additional products and services that are linked with the window display image (for example a clothing store) may include static stimuli such as the clothes worn by the mannequin, an embedded initiating stimuli such as the snow skis used as accessories in the window, or a free association stimuli such as a ski vacation evoked by the winter theme of the window display. The registration of people as initiating stimuli is discussed in more detail in the second embodiment above.

Alternatively, if the LSSS is determined to be of the variable output type (at 2420) such as a digital billboard or a live concert; then the data server 20 is linked to a data source (at 2430) such as a web site by proper communication means (such as the internet). The data source populates the data server 20 with additional stimuli coordinates utilized to identify the initiating stimuli. The Facilitator then adds a digital image that represents each change (at 2440) as appropriate, such as in the case of a digital billboard. Alternatively, a play list may be acquired in the case of a live concert. The data is then stored to the data server 20 (at 2450); storing the information representing location correlatively with initiating stimuli and corresponding search results thereof; in a manner which will allow them to be searched and identified. The LSSS registration process is complete (at 2460).

FIG. 25 is a flowchart outlining the general steps involved in a registration, search and purchase method according to the third embodiment of the present invention.

Beginning (at 2500) the user registers to use the system. This information includes name, e-mail, address, billing information, device information, product delivery preferences, and the like. Once the user registration is complete including the assignment of a unique I.D., then the user may download the control program onto their user device (at 2505). This device may be a smart phone or wireless handheld such as an I-Phone, Palm Pilot, or Blackberry. The device is preferable a proprietary combination device which maximizes the effectiveness of the current invention as discussed in FIGS. 9 and 9A above; but may include a plurality of devices with various capabilities.

Once the program is loaded onto the user device (at 2505) the user is exposed to a LSSS (at 2510) which initiates a user request. Then (at 2515) it is determined if the LSSS is of the constant output type. If so, such as a store window display or live person, then the request is transmitted to the data server 20 by proper means and includes at least a user I.D. and information representing the user location (at 2525). The data server 20 is then searched (at 2530) utilizing at least the location coordinates included in the request to identify the LSSS; the data server 20 correlatively storing information representing a plurality of LSSS with the perception area thereof. The LSSS unique I.D. is then utilized (at 2535) to identify the corresponding results by searching the data server 20 utilizing the unique I.D. of the LSSS as a keyword; the data server correlatively storing information representing unique I.D. for each LSSS with a digital image and corresponding search results thereof.

If (at 2515) it is determined that the LSSS is of the variable output type, such as a live concert, then the request will include additional stimuli coordinates (at 2520) such as TOS (Time of Selection), a radio frequency identifier, and the like. This additional information is included in the request and is transmitted (at 2525) to the data server. Said request coordinates are then utilized as search keywords to identify the LSSS (at 2530) and the request results (at 2535); the data server correlatively storing information representing LSSS correlatively with the perception area, related stimuli coordinates, and corresponding search results, thereof.

Once the LSSS is identified (at 2530) and the initiating stimuli (as applicable) is identified (at 2535), then the search results are returned to the user by proper menus (at 2540). The search results may include; a digital song, a live concert recording, a live concert video, a digital image of the LSSS (such as a store display window), selection menus, purchase information, purchase options, retail locations, product information and the like. The types of responses may include static, embedded, and free association material.

After receiving the initial search results (at 2540), the user is given an option to refine the search (at 2545). For example, if the result from a constant output LSSS was a digital image of the window display or live mannequin, then the user may select a specific item in which they wish to search such as a winter coat. By selecting the coat by proper means (touch screen for example) a pixel location is included in the re-transmitted request (at 2530) and the data server is searched utilizing the additional stimuli coordinates to return results specifically regarding the selected coat. However, the selecting of additional stimuli coordinates is not limited to a touch screen image; but, may also include a menu selection reflecting all products available in the image (store window display or worn by a live person), a point and click method, and similar means.

Once the search is complete and the user no longer wants to refine the results (at 2545), the user is given an option to purchase the product or service at (2555). If the user elects to purchase the product, the user is billed (at 2560) and the product is delivered as instructed, and the process is complete (at 2565). If (at 2555) the user declines to purchase the product, the process is complete (at 2565).

### Fourth Embodiment

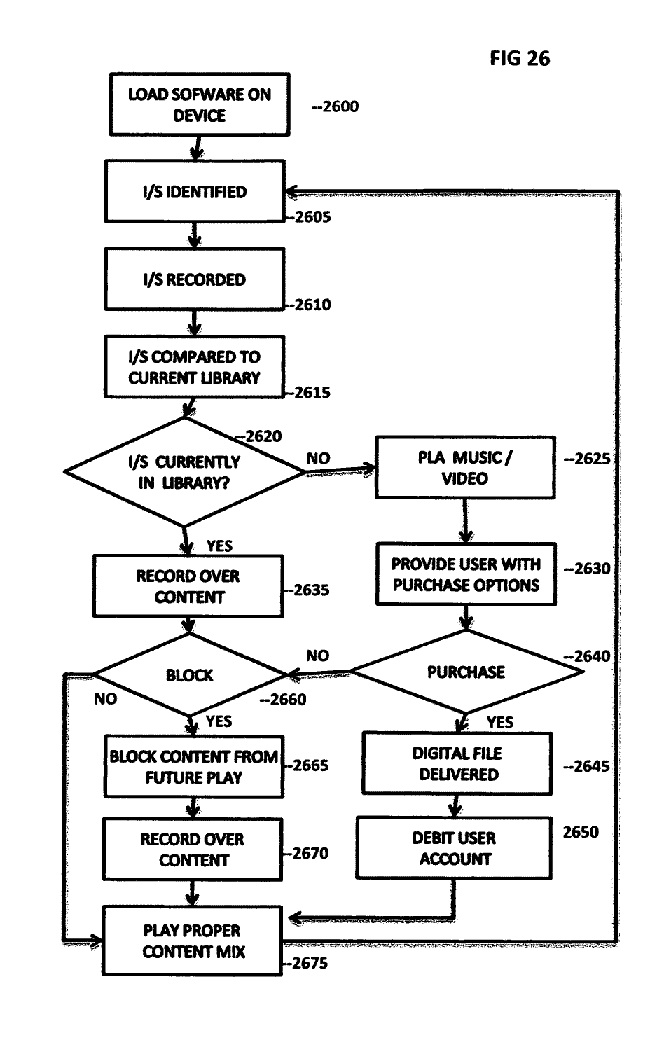

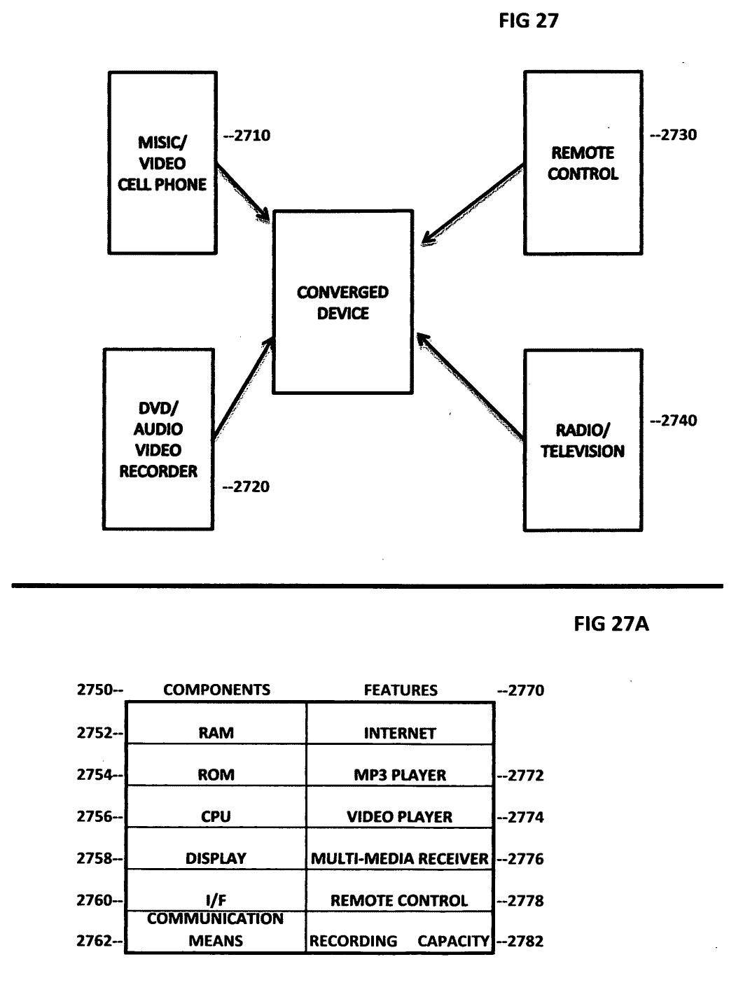

Next, a fourth embodiment will be described with reference to FIGS. 26 to 27A. In this embodiment, broadcast multimedia content is searched, and identified by proper means. The identified content is then is filtered by utilizing music already owned by a user; and said results are then made available for listening, for purchasing and for automatic delivery.

In general, new music is purchased after being heard on the broadcast medium such as radio. Users usually switch from the music they own, for example on their MP3 players, to broadcast music and video in order to be exposed to new content. Users also switch from broadcast media to recorded media in order to avoid commercials.

Therefore, according to this embodiment, broadcast music and video is automatically searched, identified, filtered, and mixed in a ratio predetermined by the user (1 new broadcast song played to each 3 recorded songs for example); without forcing the user to switch device functions, listen to commercials, or listen to broadcast content already owned by the user. In this embodiment the stimuli source is; broadcast radio, HD radio, broadcast television, cable television, satellite radio, satellite television and the like. The automated request is; a request for the identity of all broadcast music, broadcast video files, and the like; in which the user chooses to monitor. The secondary request may be, in this example, digital music files, digital video files, and related products such as ring tones, sound bytes, or groups of individual music and video.

In this example, searching and distribution of broadcast multimedia content will be discussed; however, it is contemplated that a plurality of stimuli types may be utilized such as; recorded, internet, streaming, and the like; as discussed in the first embodiment. Further, in this example, the transmission method, a mobile protocol called HSDPA (high speed download packet access) is used for the transfer of the music and video files; however, any similar method may be utilized.

FIG. 26 is a flowchart outlining generally the search and distribution methods, according to the fourth embodiment, of the present invention. Beginning (at 2600) a user loads the software onto a user device (discussed later) and (at 2605) the system identifies the initiating stimuli (as discussed in the first embodiment), and then records (at 2610) the identified stimuli (song or video) to a storage medium (such as a hard drive) to queue for playing in the pre-designated mix. The song or video identification is then compared to the current library of owned content (at 2615). If a particular content is already owned (at 2620), then the system will record over the content with the next song or video (at 2635). If at (2620) it is determined that the song or video is not owned by the user, then the content is played at the appropriate time (at 2625) according to the pre-designated music/video mix instructions. The user is provided a purchase options (at 2630) in which they may select a “buy now” option as discussed fully in related patent application Ser. No. 11/460,604. If the user decides to purchase the new content (at 2640), then the digital file is delivered to the user device by HSDPA or similar means (at 2645) and added to the current library of owned content; and the user is charged for the purchase (at 2650). The control program then causes the playing of the owned recorded content as pre-designated by the user (at 2675), and the process continues the cycle (at 2605).

If the user decides not to purchase the new content (at 2640), he or she is given an option to block all future play of said content (at 2660). If the user blocks a particular piece of content (at 2665) because he/she did not care for the content and did not intend it to be played again at a later date, then the system will reject that particular piece of content even though it is not owned by the user. The system will not include it when it is broadcast in the future. The system then records over the content (at 2670), determines the proper music mix ratio (at 2675) and plays the proper mix of new content and presently owned recorded content as pre-designated by the user; finally, the process continues to cycle (at 2605).

As discussed in the first embodiment, the broadcaster (a radio station for example) may be compensated for providing the initiating stimuli that initiated a purchase (discussed fully in the marketing system, advertising system and cash flow methods above) It is also contemplated that the user may initiate additional request as a response to embedded, split, and stacked, stimuli originating from the filtered static stimuli to which they are exposed.

FIG. 27 is a schematic drawing illustrating the features of a converged device which maximizes the effectiveness of the fourth embodiment of the present invention; although the present invention does not require a specialized device and may be loaded onto a plurality of existing devices.

Referring to FIG. 27, the new converged device 2700 is a combination of devices comprising (1) a music and video enabled cell phone 2710 similar to the smart phones and wireless handhelds such as the IPhone, Palm Pilot, Blackberry, and Verizon Music Phone; (2) an audio/video recorder 2720; (3) a universal remote 2730 similar to the Logitec Harmony 1000; and (4) a radio/television receiver with the capacity to receiver and display, FM Radio, broadcast television, HD broadcast, satellite broadcast, and the like.

FIG. 27A is a drawing helping to further clarify details of the device discussed in FIG. 27, outlining certain features and components of the converged device 2700.

the components (at 2750) for the device (at 2700) may include at least; RAM (2752); ROM (2754); a CPU (2756); a display means (at 2758); an interface and/or inputting means such as a touch screen (at 2760); and a plurality of 2 way communication means (at 2762), such as the internet, inferred, bluetooth, and the like. The features (at 2770) for the device (at 2700) may include at least; internet access (at 2772); MP3 player (at 2774); video player (at 2776); multimedia receiver (at 2778) remote control capacity (at 2780); and recording capacity (at 2782).

It is contemplated that this embodiment may be utilized both with multimedia content broadcast to the user device 4, as well as with content broadcast to external devices. Thus, the features and components of the user device 4 may vary greatly without departing from the spirit of the embodiment.

### Fifth Embodiment

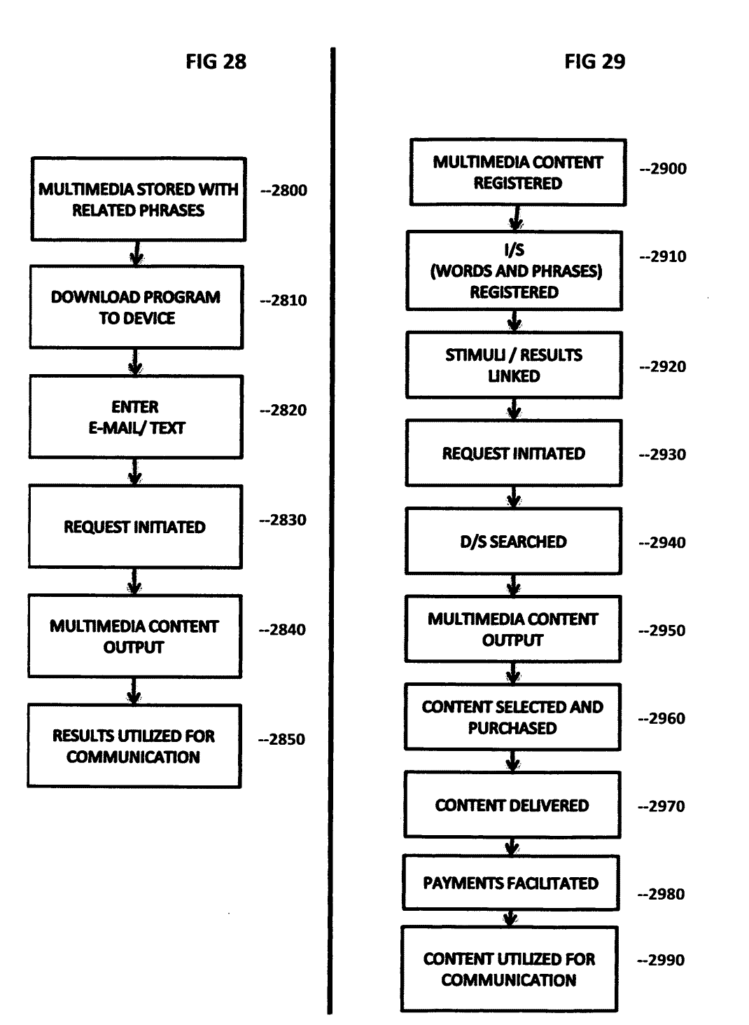

Next, a fifth embodiment illustrating an alternative marketing system for media content which may be identified and purchased utilizing the search system and purchase method outlined above will be described with reference to FIGS. 28 and 29.

Traditionally, multimedia content commonly referred to as “snippets,” “sound bytes,” “video clips,” and “gifs,” are downloaded from a myriad of sources and used in e-mail or exchanged via internet or other communication means.

Some media content is sold as ring tones or screen savers. However, most content is acquired without compensation to the owners of the content and without a definitive purpose or use.

There are thesaurus and translator programs which can make alternative words, suggestions, or translations, to another language, but none that utilize multimedia content.

The present embodiment allows for multimedia content to be purchased, classified, stored, searched and utilized as a form of communication; more particularly, the user may acquire multimedia content and then utilize the content as a substitution or supplement for words, ideas, phases, and concepts during electronic communication while facilitating payment to the copyright owner upon utilization of the content.

FIG. 28 is a flowchart illustrating generally the process steps involved in the search system as it utilized by the fifth embodiment of the present invention comprising the steps; 1) multimedia content is stored (at 2800) correlatively with related words or phases representing a plurality of concepts and ideas, by proper means; 2) user downloads control program (at 2810) to user device; 3) user enters e-mail, text, or instant message (at 2820) to communicate with another user; 4) automated request is generated (at 2830) in which the data server is queried using said words and phases as search conditions; 5) multimedia content is output and returned to the user (at 2840) by proper means; 6) multimedia content is utilized as substitution for original text or e-mail message (at 2850) to convey the same idea, concept, message, and the like.

FIG. 29 is a flowchart illustrating certain additional detail of the search system as it utilized by the fifth embodiment of the present invention comprising; the result registration method, the stimuli registration method, the stimuli/result linking method, the search method, the distribution method, the advertising method, the user payment method, and the advertiser payment method, as discussed in the first embodiment.

Referring to FIG. 29, therefore, according to this embodiment, (1) multimedia content is registered (at 2900) as search results; (2) initiating stimuli, in the form of words, phases, and concepts, are registered (at 2910) by proper means; (3) initiating stimuli are linked (at 2920) with results registered in (1), by content producers/facilitators by proper means; (4) request is initiated (at 2930), utilizing words and phrases as request coordinates; (5) D/S is searched (at 2940) by utilizing request coordinates as search conditions, D/S storing words, phrases and concepts correlatively with the corresponding multimedia content thereof; (6) multimedia content is output (at 2950) corresponding to the request coordinates thus identifying a plurality of text substitutions in the form multimedia content; said content may include: snippets, sound bytes, video clips, and the like.

Referring further to FIG. 29, (7) the content may be selected and purchased (at 2960), in the form of snippets, which are audio and video clips, and sound bytes, and the like; (8) content is delivered to the user (at 2970) by proper transmitting means, (9) payment is facilitated (at 2980) to the owner of the copyright material and/or the facilitator responsible for the stimuli/result link; and (10) the user then utilizes said multimedia content (at 2990) as substitution for the original text message, e-mail message, voice mail message, instant message, and the like.

As in the first embodiment, it is contemplated that the search results may be filtered by a plurality of parameters; such as, emotion level, humor level, most utilized, most current, and the like. Thus as discussed above, the fifth embodiment of the current invention allows the creation of a new lexicon to be utilized in electronic communication.

Although the present invention has been shown and described with respect to a best mode embodiment and several alternative embodiments thereof, it should be understood by those skilled in the art that the foregoing and various other changes, omissions, and additions in the form of detail thereof may be made therein without departing from the spirit and scope of the present invention.

Advertiser: One with a product to promote such as; a business wishing to sell a product; a (SNP) or person who advertises themselves on a social or business network; or the owner or seller of multimedia content wishing to advertise and sell same.

Content Producer: The originator, owner, author, or distributor of content or related products and services. May act as a facilitator for their own content and link said content with search results.

Copyright Materials: All original work of authorship (OWA)

Facilitator: Person or entity that links existing stimuli with search results.

Initiating Stimuli: Any stimuli responsible for the initiation of a request and may include; static, embedded, split, and stacked, initiating stimuli.

Initiating Stimuli Coordinates: Information stored correlatively with information representing initiating stimuli and used to identify same.

Initiating Stimuli Types: The classification of a initiating stimuli including:

Static Stimuli: Stimuli that is identical to the initiating stimuli. For example; the static stimuli of a movie is the movie itself.

Embedded Stimuli: Stimuli that is embedded inside a more complex stimuli, such as a song within a movie, or a car inside a YouTube video.

Split Stimuli: Stimuli that is only a portion of a large initiating stimuli. For example a ring tone that is part of a song, the color red which is painted on a toy present in a digital photograph.

Stacked Stimuli: Stimuli that is related to a smaller static, embedded or split stimuli. For example; a CD is stacked stimuli related to the original song to which the user was exposed; a song may be stacked stimuli related to a ring tone.

Link Credit: All rights associated with completing of the stimuli/result link.

Multidimensional Stimuli or (Complex Stimuli): Stimuli that includes static, embedded, split stimuli, and stacked stimuli; as well as all related products and services.

Multimedia Content: or Content: All copy written material including but not limited to; web pages, digital photographs, songs, music, commercials, sports broadcast, books, audio books, television shows, movies, video games, music videos; copy written material that is disseminated through any medium.

Multimedia Broadcast or media, or Broadcast: Any transmission or dissemination of copy written material, including but not limited to: radio, television, cable television, HD radio, HD television, webcast, webtv, movie theaters, digital transmissions, satellite television, satellite radio, podcast, program, and the like.

Perception Adjustment Variable (PAV): adjustment for different time variables used to insure an accurate perception time. For example, the time variance between the broadcast of digital data and the actual reception of a signal at a radio.

Perception Area—The designated area in which a stimuli may be perceived by a user.

Products—Products, services, information, digital files, and communication options; in other words anything an advertiser wishes to promote may be considered a product. For example, a person may become the product in a social network embodiment.

Purchase: to include but not be limited to the purchase, rental or subscription, used to obtain digital content, and other products, and services.

Request: the initiation of an action to identify initiating stimuli and related products; also initiation of an action to purchase products, acquire information, conduct traditional search, and the like.

Request Type—The classification of a request including:

Direct Request—A request based on a response to the initiating stimuli itself.

Free Association Request—A request based on a response to an idea originated by the initiating stimuli.

Automated Request—A request that is initiated by a control program; usually triggered when certain conditions are met such as exposure to a particular stimuli, or group of stimuli. Request parameters are usually predetermined by the user. For example, when a person entering a perception area has attended a certain school, the request may be triggered.

Request Coordinates: information included with a request which is utilized as search conditions to identify stimuli sources, initiating stimuli, and the corresponding search results thereof.

Request Results or Search Results: —the results returned to the user in response to a request. This result may include the identity of the initiating stimuli and related information. Results may also include; an image of the initiating stimuli that in order to allow the selection of a specific embedded stimuli; a menu of all available stimuli contained in a specific selection; a selection refining menu; a digital product; a purchase order; product information; advertisements; website links; websites; and search results from a plurality of traditional search engines. Said results may also be communication options such as; a two way phone link, instant message screen, and the like; a discussed in the second embodiment. Further, said results may also include a plurality of communication translation options in the form of multimedia stimuli; as discussed in the fifth embodiment.

Request Adjustment Variable (RAV): an integer, mixed number or fraction that is assigned to different time periods, and then used to identify the initiating stimuli.

Social Network participant (SNP): a person or entity registered to participate in a social network. Also functioning as an initiating stimuli.

Specialized Device: a device designed specifically to facilitate the function of a method or system.

Stimuli Coordinates—information stored correlatively with stimuli sources, and initiating stimuli, and utilized to identify same; such as the perception area of an arena or the PST of a broadcast movie.

Stimuli Source—Source from which an initiating stimuli originates, such as a television broadcast, streaming video, live concert, print magazine, and the like.

Stimuli Source Type—Classification of source from which an initiating stimuli originates. There are 9 general categories although they are not all mutually exclusive:

1) Broadcast—Television, radio, satellite radio, HD radio, and the like.

2) Recorded—DVD, CD, MP3, text message, and the like.

3) Live—Music concert, ballet, and the like.

4) Streaming—Audio and video streaming, Podcast, and the like.

5) Print—Magazine article, newspaper photo, and the like.

6) Internet—MySpace page, YouTube video, Flicker photo, e-mail, and the like

7) Location Specific—Billboard, store display window, real estate, live person, SNP, and the like.

8) Mobile—Live person, Social Network Participant, and the like.

9) Image Specific—Automobile parked on the street, a dining room table in neighbor's home, a wrought iron park bench in front of an art gallery, a sculpture, and the like.

Stimuli Type—The classification of a stimuli including all stimuli source types and all initiating stimuli types.

Synchronized Stimuli (or synchronized image): a stimuli that is received on two device at once. For example a recorded movie displayed on a television set and on a user device such as a cellar phone by simulcast, or similar means.

Time Related Terms:

Adjusted Time of Selection (ATOS): Synchronize selection time which is calculated using elapsed time, transmission time, master clock, and master time zone.

Selection Time (ST): the point at which a selection is made by the user. For example, the point they choose an icon for “previous movie”, or “current song.”

Time Feed: A source of accurate time data such as the time embedded in the signal of a cell phone.

Perception Time (PT): The time in which broadcast stimuli can be perceived by a user consisting of a at least a (PST).

Perception Start Time (PST): The point at which a user can first perceive an initiating stimuli.

Master Clock Single time source used to assign Perception Time (PT) to all broadcast stimuli stored in the data server.

Master Time Zone: the single time zone used when assigning times to all broadcast stimuli stored in the data server.

Advertising Incentive: A benefit received by a party in exchange for performing a function.

Communication Concepts Ideas, thoughts, and impressions which one wishes to communicate, most often thought written and verbal communication.

Group Profile: The collective demographic information of a group of people within a perception area. For example: male/female percentage, personality types, age distribution, and the like.

Event Profile: A compilation of the attitudes of a group of people, especially regarding attitudes and opinion toward specific stimuli; such as, a band party, outdoor event, political rally, and the like.

User Perception Area: The 360 degrees area surrounding a user in which stimuli may be perceived; the size of which may be determined by said user, a social facilitator, or a system administrator.

Visual Representation: Compiled data presented in a visual form such as bar graphs, color codes, pie charts, and the like.

1. An advertising method for utilizing non-traditional stimuli for advertising comprising the steps:
a) Storing information representing a stimuli in a manner which allows said stimuli to be searched;
b) Storing information representing search results in a manner which allows said search results to be searched;
c) Causing said information representing a stimuli (a) to be stored correlatively with at least said information representing search results (b) whereas said information representing stimuli is linked with said information representing at least one search result; wherein said information representing a stimuli (a) is chose from a group comprising initiating stimuli, and stimuli source.

2. A method as described in claim 1, wherein a facilitator causes said information representing stimuli to be linked with said information representing search results at step c), said facilitator earns a link credit for said causation, said linking may be accompanied by a means chosen from a group comprising manual selection, and automated software program.

3. A method as described in claim 1, wherein an advertising incentive is provided, said incentive provided for causing said information storing; said incentive is chosen from a group comprising monetary payment, rights, product, service, credit, marketing exposure, goodwill, and gratification.

4. A method as described in claim 1, comprising the additional steps:
d) Storing information representing at least one stimuli coordinate correlatively with said information representing stimuli;
e) Receiving a user request in response to a stimuli, said request containing at least one request coordinate, said request coordinate associated with said stimuli coordinate;
f) Inputting said request coordinate into a searching unit, said searching unit searching at least one stimuli coordinate from a database, said database storing said stimuli coordinates correlatively with information representing stimuli and corresponding search results thereof.

5. A method as described in claim 4, wherein said user request is caused by exposure to a initiating stimuli, said initiating stimuli is caused by a stimuli source, said stimuli source earning an advertising incentive for said causation.

6. A method as described in claim 4, wherein said stimuli coordinates are generated by a wireless device comprising:
location coordinate generating means, said generating means generating location coordinates related to said stimuli, said location coordinates comprising stimuli coordinates; and
communication means for communication with an external device

7. A method as described in claim 3, wherein information representing an advertising bid is stored correlatively with said information representing search results.

8. A method as described in claim 4, wherein said stimuli coordinate is chosen from a group comprising written communication, and verbal communication; said stimuli comprises communication concepts; said request coordinate is chosen from a group comprising written communication, and verbal communication; and said search results comprises multimedia content; further comprising the additional steps:
a) Initiating an electronic communication, said communication chosen from a group comprising e-mail message, text message, instant message, and voice message; said communication including or comprising said request coordinate;
b) utilizing said request coordinate to identify said search results by proper means, said search results comprises multimedia content stored correlatively with said related stimuli coordinate;
c) substituting said multimedia content identified at (b) for said request coordinate (a), wherein said multimedia content becomes a synonym.

9. A method as described in claim 4 wherein said search results are search strings, wherein said search strings may be customized by an advertiser; and wherein said advertiser pays a fee for said customized search string.

10. In traditional search in which keywords are developed by a user to query search engines and output search results, an improvement for increasing the relevancy of said search, said improvement comprising the steps:
a) storing information representing a stimuli coordinate in a database, said stimuli coordinate associated with a stimuli;
b) generating an user request, said request containing or comprising information representing at least one request coordinate, said request coordinate related to said stimuli coordinate;
c) inputting information representing said request coordinate (b) into a searching unit, said searching unit searching said database and outputting at least one said stimuli coordinate stored a storing step (a);
d) storing information representing at least one search result correlatively with said stimuli coordinate at storing step (a); wherein said corresponding search result is output at searching step (c); wherein said stimuli coordinate (a) is associated with a stimuli, said stimuli chosen form a group comprising stimuli source, and initiating stimuli.

11. A method as described in claim 10, wherein said search results comprise a second request coordinate; further comprising the additional step:
inputting said second request coordinate into a searching unit, said searching unit searching information related to said second request coordinate from a database; wherein said searching unit is chosen from a group comprising commercial search engines, private search engines, public search engines, and recognition software; and wherein said database is chosen form a group comprising worldwide web, website, webpage, commercial database, public database, and software application.

12. A method as described in claim 10, wherein information representing said stimuli coordinate (a) comprises at least one stimuli coordinate from a group comprising, stimuli perception area, stimuli location, and stimuli relative position; and wherein information representing said request coordinate (b) comprises at least one request coordinate chose from a group comprising, user location, user perception area, and user relative position; wherein said request at step (b) is an automated request and comprises the additional steps:
a) designating search conditions;
b) monitoring said user perception area for the satisfaction of said search conditions;
c) initiating said automated request when said designated search conditions are satisfied, said satisfaction occurring within said user perceptions area.

13. A method as describe in claim 12, wherein said request coordinate is received from an outside source, said request coordinate is transmitted by said source utilizing proper transmitting means, said transmitting means comprising a transmitting range, said range comprising said stimuli perception area, said stimuli perception area comprising said stimuli coordinate.

14. A method as described in claim 12, wherein a social facilitator designates a hot spot, said hot spot comprising an area within at least one said search condition (a) is controlled by said social facilitator.

15. A method as described in claim 10, wherein said search results (d) comprises a communication connection between said user (b) and said related stimuli (a); wherein said communications connection is chosen from a group comprising phone connections, text message connection, e-mail connection, instant message connection, and voice over internal protocol connection; said communication is routed through a data server.

16. A method as described in claim 10, wherein said search results (d) comprises information representing social networks participants (SNP), said information chosen from a group demographic information, and SNP opinion; further comprising the additional steps:
e) storing at least information relating to a plurality of said SNP.
f) compiling said information into a profile, said profile comprising a visual representation of said compilation; wherein said profile is provided for a purpose chosen from a group comprising search results, initiating stimuli, and request coordinate, and wherein said group comprises a plurality of SNP located within a perception area, said perception area chosen from a group comprising; user perception area, stimuli perception area, and a social facilitator defined perception area.

17. A method as described in claim 10, wherein said search results are chosen form a group comprising a digital image, and multimedia content; comprising additional steps:
a) sectioning said result into smaller areas by proper means, said areas designated by location information;
b) selecting at least one said area by proper means, said area containing or comprising a stimuli;
c) identifying said location information associated with said selection, said location information comprising a request coordinate, said request coordinate related to a stimuli coordinate;
d) inputting said request coordinate into a searching unit, said searching unit searching information containing at least one related stimuli coordinate from a database, said database storing information representing said stimuli coordinates correlatively with said search results.

18. A method described in claim 10, wherein said search results comprise the identify of related stimuli; (a), said stimuli comprising multimedia content; further comprising the additional steps:
a) storing multimedia content onto a user device;
b) filtering said search results with information representing said stored multimedia content;
c) providing said filtered results for user utilization, said filtered results comprising multimedia content not stored at storing step (a); wherein said utilization is chosen from a group comprising listening, viewing, mixing, blocking, previewing, downloading, and purchasing.

19. The combination of a wireless communication device with a control device, wherein said apparatus comprises:
First communicating means, said first communicating means communicating with at least one device, said device providing stimuli, said first communication means controlling the selection of said stimuli;
Request coordinate capture means, said capture means capturing information representing at least one request coordinate said request coordinate associated with said chosen stimuli;
Second communicating means, said second communicating means providing communication with an external source; and wherein said first communicating means controls the selection of stimuli, said selection is chosen from a group comprising internal device selection, and external device selection.

20. The apparatus of claim 19, further comprising;
first storage means, said storage means storing information representing stimuli coordinates correlatively with search results, said stimuli coordinate related to said request coordinate;
first receiving means, said receiving means receiving at least one request coordinate from said second communication means; and
searching unit, said searching unit searching said storage means utilizing said request coordinate to output said stimuli coordinate and the corresponding search result thereof;
second searching unit, said second searching unit utilizing said search result output by said first searching unit to search a database.

21. The device of claim 19, wherein said request coordinate capture means obtains in a request coordinate chosen from a group comprising, station identifier, stimuli type, unique identifier, and digital copy of stimuli.

22. The apparatus of claim 19, wherein said request capture means obtains a synchronized broadcast, said synchronized broadcast comprising a digital image; further comprising:
sectioning means, said sectioning means dividing said digital image into sections, said sections designated by a location coordinate, said location coordinate comprising a request coordinate, said request coordinate associated with said stimuli coordinate stored in said storage means;
selection means, said selection means allowing the selection of multi dimensional stimuli represented in said digital image and the related request coordinate thereof.
